(19) United States
(12) Patent Application Publication
(10) Pub. No.: US 2025/0053735 A1
(43) Pub. Date: Feb. 13, 2025

(54) AUTOMATED DIGITAL KNOWLEDGE FORMATION

(71) Applicant: Grammarly, Inc., San Francisco, CA (US)

(72) Inventors: Oleksiy Shevchenko, San Francisco, CA (US); Kashish Hora, New York, NY (US); Stanislav Levental, Brooklyn, NY (US); Ryan Grimm, Pacifica, CA (US)

(21) Appl. No.: 18/800,901

(22) Filed: Aug. 12, 2024

Related U.S. Application Data
(60) Provisional application No. 63/519,120, filed on Aug. 11, 2023.

(51) Int. Cl. G06F 40/186; G06F 40/274; G06F 40/30

(52) U.S. Cl. CPC G06F 40/186; G06F 40/274; G06F 40/30

(57) ABSTRACT

A method of electronic communication assistance involves receiving a partial electronic communication at an AI assistant computing facility from a first electronic identifier linked to a first user. This communication includes content associated with both the first user and a second user. The method extracts the communication context and encodes the partial communication for processing, creating an encoded version. It retrieves the first user's communication profile from a database using their identifier, containing user attributes, and retrieves the second user's profile similarly. The encoded communication is then processed by a processor to generate a compositional change using at least one of the communication context, the first user communication attribute, or the second user communication attribute. Finally, a revised electronic communication is generated from the partial communication and the compositional change.

### BENEFIT CLAIM

This application claims the benefit under 35 U.S.C. § 119 (e) of provisional application 63/519,120, filed Aug. 11, 2023, the entire contents of which are hereby incorporated by reference for all purposes as if fully set forth herein.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright or rights. @ 2023 Grammarly, Inc.

### TECHNICAL FIELD

One technical field of the present disclosure is computer-supported natural language processing, including the automatic composition of natural language text. Another technical field is software engineering as applied to large language models in artificial intelligence systems, particularly techniques for engineering prompts and context to submit during the execution of the inference stage of an LLM. Other fields are computer-implemented digital assistants, methods, and systems using artificial intelligence assistants to increase the effectiveness of communications.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

Current digital writing assistants provide simple aids to sending communications, such as illustrated in FIG. 1, where the text of an electronically composed communication is evaluated by a ‘writing assistant’ to correct content errors, such as spelling or grammatical errors. However, these simple aids are very limited, generally only addressing corrections to content. What is needed is an intelligent digital assistant system that can incorporate knowledge and context surrounding the communication exchanges to make a communication exchange more effective.

Large language models (LLMs), such as GPT-class LLMs, are widely used to generate a text response to a prompt or query. Public LLMs, accessible via application programming interfaces (APIs), like GOOGLE BARD and OPENAI GPT, have been trained on a corpus of data that the user does not access, see, or control. Consequently, in some application areas, the responses that public LLMs provide to prompts are inadequate or incomplete. The responses suffer from the inability of the LLM or its provider to access application-specific training data. One example arises in large business enterprises that have historically created and stored large numbers of internal documents relating to business operations, technology, product plans, and other enterprise-specific domains or topics.

Based on the foregoing, the referenced technical fields have developed an acute need for better ways to efficiently and effectively access the vast knowledge captured in enterprise-specific documents for use in enterprise-specific prompts and responses.

### SUMMARY

The appended claims may serve as a summary of the invention.

### BRIEF DESCRIPTION OF THE DRAWINGS

In the drawings:

FIG. 1 depicts a prior art example of a writing assistant.

FIG. 2 illustrates a functional flow diagram of an artificial intelligence assistant according to exemplary and non-limiting embodiments.

FIG. 3 illustrates aspects of an artificial intelligence assistant according to exemplary and non-limiting embodiments.

FIG. 4 illustrates an overview of a comprehensive communication assistance workflow according to exemplary and non-limiting embodiments.

FIG. 5 illustrates an overview of a composition workflow according to exemplary and non-limiting embodiments.

FIG. 6 illustrates an overview of an editing workflow according to exemplary and non-limiting embodiments.

FIG. 7 illustrates a reaction prediction workflow according to exemplary and non-limiting embodiments.

FIG. 8 illustrates a reaction prediction workflow with ranking according to exemplary and non-limiting embodiments.

FIG. 9 illustrates a reaction capture workflow according to exemplary and non-limiting embodiments.

FIG. 10 illustrates a workflow for optimizing an incoming communication according to exemplary and non-limiting embodiments.

FIG. 11 illustrates a workflow for optimizing an incoming communication and feedback generation according to exemplary and non-limiting embodiments.

FIG. 12 illustrates a receiver interface workflow according to exemplary and non-limiting embodiments.

FIG. 13 illustrates an audio-visual communication workflow according to exemplary and non-limiting embodiments.

FIG. 14, FIG. 15, FIG. 16, FIG. 17, FIG. 18, FIG. 19, and FIG. 20 illustrate user interface views of an artificial intelligence assistant according to exemplary and non-limiting embodiments.

FIG. 21, FIG. 22, FIG. 23, FIG. 24, FIG. 25, FIG. 26, and FIG. 27 illustrate an example augmented reality glasses user interface view of an artificial intelligence assistant according to exemplary and non-limiting embodiments.

FIG. 28 illustrates a distributed computer system showing the context of use and principal functional elements with which one embodiment could be implemented.

FIG. 29 illustrates an example of structural architecture and data flow for the connector administration system of FIG. 28.

FIG. 30 illustrates an example of structural architecture and data flow for the crawler system of FIG. 28.

FIG. 31 illustrates an example of structural architecture and data flow for the search system of FIG. 28.

FIG. 32 illustrates an example of structural architecture and data flow for the storage system of FIG. 28.

FIG. 33 illustrates an example method for generating a prompt and using it with a large language model (LLM) to obtain a response.

FIG. 34A, FIG. 34B, FIG. 34C, and FIG. 34D depict example processes for generating a prompt to be provided to an LLM.

FIG. 35 presents an example diagram demonstrating the incorporation of actions for prompt generation.

FIG. 36 shows an illustrative system designed to facilitate prompt generation.

FIG. 37 provides an illustrative diagram for determining the usefulness of context in providing knowledge to generate an appropriate response from the LLM.

FIG. 38 illustrates a computer system with which one embodiment could be implemented.

### DETAILED DESCRIPTION

In the following description, for the purposes of explanation, numerous specific details are set forth to provide a thorough understanding of the present invention. It will be apparent, however, that the present invention may be practiced without these specific details. In other instances, well-known structures and devices are shown in block diagram form to avoid unnecessarily obscuring the present invention.

The text of this disclosure, in combination with the drawing figures, is intended to state in prose the algorithms that are necessary to program the computer to implement the claimed inventions at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

This disclosure may describe one or more different inventions, with alternative embodiments to illustrate examples. Other embodiments may be utilized, and structural, logical, software, electrical, and other changes may be made without departing from the scope of the invention. Various modifications and alterations are possible and expected. Some features of one or more of the inventions may be described with reference to one or more embodiments or drawing figures, but such features are not limited to usage in the one or more embodiments or figures with reference to which they are described. Thus, the present disclosure is neither a literal description of all embodiments of one or more inventions nor a listing of features of one or more inventions that must be present in all embodiments.

Headings of sections and the title are provided for convenience but are not intended to limit the disclosure in any way or as a basis for interpreting the claims. Devices described as in communication with each other need not be in continuous communication with each other, unless expressly specified otherwise. In addition, devices that communicate with each other may communicate directly or indirectly through one or more intermediaries, logical or physical.

A description of an embodiment with components in communication with one other does not imply that all such components are required. Optional components may be described to illustrate a variety of embodiments and to illustrate one or more aspects of the inventions fully. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of described processes may be performed in any order practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment but need not occur only once. Some steps may be omitted in some embodiments or occurrences, or some steps may be executed more than once in each embodiment or occurrence. When a single device or article is described, more than one device or article may be used in place of a single device or article. Where more than one device or article is described, a single device or article may be used instead of more than one device or article.

The functionality or features of a device may be alternatively embodied by one or more other devices that are not explicitly described as having such functionality or features. Thus, other embodiments of one or more inventions need not include the device itself. Techniques and mechanisms described or referenced herein will sometimes be described in singular form for clarity. However, it should be noted that embodiments include multiple iterations of a technique or manifestations of a mechanism unless noted otherwise. Process descriptions or blocks in figures should be understood as representing modules, segments, or portions of code, including one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

### 1. General Overview

A computer-implemented client process can programmatically call functions of a common application programming interface (CAPI) using a call that conveys a request for a response to a user prompt or user query. In response, the CAPI programmatically calls a search system and provides the user prompt or user query with a request to obtain a list of documents that are relevant to the context of the user prompt or user query. The search system, having previously crawled and indexed a large corpus of documents, and having accessed definitions or other resources relating to terms in the documents, returns a list of documents that are relevant to the context of the user prompt or user query. The CAPI forwards the user interaction context, organizational context, and user prompt or user query to a prompt-based text composition service. The prompt-based text composition service communicates programmatically with prompt-building instructions, for example, by retrieving or reading action templates and decorators for an LLM prompt. The prompt-based text composition service calls a public API of an open large language model (LLM), such as a GPT-type LLM, and sends an engineered prompt, the user query, and context data. In response to receiving a response from the LLM, the prompt-based text composition service formats, filters, and/or returns the response to the CAPI, which can further format or filter the response and transmit a final response to the client process.

In an embodiment, a method of electronic communication assistance may include receiving a partial electronic communication at an artificial intelligence assistant computing facility from a first electronic identifier associated with a first user, the partial electronic communication comprising a communication content and comprising or associated with the first electronic identifier associated with the first user and a second electronic identifier associated with a second user; extracting a communication context from the partial electronic communication; encoding the partial electronic communication for processing creating an encoded partial electronic communication; retrieving from a communication profile database a first communication profile for the first user using the first electronic identifier associated with the first user, wherein the first communication profile comprises a first user communication attribute; retrieving from the communication profile database a second communication profile for the second user using the second electronic identifier associated with the second user, wherein the second communication profile comprises a second user communication attribute; processing the encoded partial electronic communication with a processor to generate a compositional change for the communication content of the partial electronic communication using at least one of the communication context, the first user communication attribute, or the second user communication attribute to generate the compositional change; and generating a changed electronic communication from the partial electronic communication and the compositional change.

In an embodiment, a method of electronic communication assistance may include receiving a partial electronic communication at an artificial intelligence assistant computing facility from a first electronic identifier associated with a first user, the partial electronic communication comprising a communication content and comprising or associated with the first electronic identifier and a second electronic identifier associated with a second user; retrieving a first communication profile, wherein the first communication profile comprises a first user communication attribute; retrieving a second communication profile, wherein the second communication profile comprises a second user communication attribute; processing the partial electronic communication with a processor to generate a compositional change for the communication content of the partial electronic communication using at least one of the first user communication attribute or the second user communication attribute to generate the compositional change; and generating a changed electronic communication from the partial electronic communication and the compositional change.

In an embodiment, the method may further include transmitting the changed electronic communication to the first electronic identifier associated with the first user, and/or transmitting the changed electronic communication to the second electronic identifier associated with the second user. The compositional change may be derived from representations of previous content and context from a plurality of user profiles stored in the communication profile database which are like at least one of the first communication profile or the second communication profile. The processor may be trained on large-scale data mixed with prior communication and effective communications from the plurality of user profiles. The processor may use at least one of a machine learning model, deep learning model, or other statistical learning algorithm for creating the compositional change. The compositional change may be an auto-generated textual completion; the auto-generated textual completion may be a phrasal completion, and the processor may generate the compositional change by optimizing generated language as determined by the processor from the second user communication attribute. The processor may generate the compositional change by replicating a communication style of the first user as determined by the processor from the first user communication attribute. The partial electronic communication may include a communication goal, and the processor may generate the compositional change by optimizing for impact and effectiveness of generated language with respect to the communication goal. The processor may generate the compositional change further using a communication template selected from a plurality of communication templates comprising at least one of prepared text or placeholder locations for defining structural elements for user completion. The processor may select the communication template using at least one of a machine learning model, deep learning model, or statistical learning model to find a most effective communication template based at least in part on the communication content. The plurality of communication templates may include at least one automatically generated template generated by the processor. The processor may select the communication template by using a machine learning model, deep learning model, or statistical learning algorithm to score the plurality of communication templates based at least in part on the communication content, first user communication attribute, or second user communication attribute, or communication context.

In an embodiment, a method of electronic communication assistance may include receiving a partial electronic communication at an artificial intelligence assistant computing facility from an electronic identifier associated with a user, the partial electronic communication comprising a communication content and comprising or associated with the electronic identifier associated with the user; extracting a communication context from the partial electronic communication; encoding the partial electronic communication for processing creating an encoded partial electronic communication; retrieving from a communication profile database a communication profile for the user using the electronic identifier associated with the user, wherein the communication profile comprises a user communication attribute; processing the encoded partial electronic communication with a processor to generate a compositional change for the communication content of the partial electronic communication using at least one of the communication context or the user communication attribute; and generating a changed electronic communication from the partial electronic communication and the compositional change.

In an embodiment, the method may include transmitting the changed electronic communication to the electronic identifier associated with the user or transmitting the changed electronic communication to a second electronic identifier associated with a second user. The compositional change may be derived from representations of previous content and context from a plurality of user profiles stored in the communication profile database which are like the communication. The processor may be trained on large-scale data mixed with prior communication and effective communications from the plurality of user profiles. The processor may use at least one of a machine learning model, deep learning model, or other statistical learning algorithm for creating the compositional change. The compositional change may be an auto-generated textual completion. The auto-generated textual completion may be a phrasal completion. The processor may generate the compositional change by optimizing generated language of a user as determined by the processor from a user communication attribute, may generate the compositional change by replicating a communication style of the user as determined by the processor from the user communication attribute. The partial electronic communication may include a communication goal, and the processor may generate the compositional change by optimizing for impact and effectiveness of generated language with respect to the communication goal. The processor may generate the compositional change further using a communication template selected from a plurality of communication templates comprising at least one of prepared text or placeholder locations for defining structural elements for user completion, the processor may select the communication template using at least one of a machine learning model, deep learning model, or statistical learning model to find a most effective communication template based at least in part on the communication content. The plurality of communication templates may include at least one automatically generated template generated by the processor. The processor may select the communication template by using a machine learning model to score the plurality of communication templates based at least in part on the communication content, communication context, first user communication attribute, or second user communication attribute.

In an embodiment, a method of electronic communication assistance may include receiving a partial electronic communication at an artificial intelligence assistant computing facility from an electronic identifier associated with a user, the partial electronic communication comprising a communication content and comprising or associated with the electronic identifier; retrieving a communication profile, wherein the communication profile comprises a user communication attribute; processing the partial electronic communication with a processor to generate a compositional change for the communication content of the partial electronic communication using the user communication attribute to generate the compositional change; and generating a changed electronic communication from the partial electronic communication and the compositional change.

In an embodiment, the method may include transmitting the changed electronic communication to the electronic identifier associated with the user or transmitting the changed electronic communication to a second electronic identifier associated with a second user. The compositional change may be derived from representations of previous content and context from a plurality of user profiles which are like at least one of the communication profile. The processor may be trained on large-scale data mixed with prior communication and effective communications from the plurality of user profiles, the processor may use at least one of a machine learning model, deep learning model, or other statistical learning algorithm for creating the compositional change. The compositional change may be an auto-generated textual completion. The auto-generated textual completion may be a phrasal completion. The processor may generate the compositional change by optimizing generated language of a user as determined by the processor from a user communication attribute. The processor may generate the compositional change by replicating a communication style of the user as determined by the processor from the user communication attribute. The partial electronic communication may include a communication goal, and the processor may generate the compositional change by optimizing for impact and effectiveness of generated language with respect to the communication goal. The processor may generate the compositional change further using a communication template selected from a plurality of communication templates comprising at least one of prepared text or placeholder locations for defining structural elements for user completion. The processor may select the communication template using at least one of a machine learning model, deep learning model, or statistical learning model to find a most effective communication template based at least in part on the communication content. The plurality of communication templates may include at least one automatically generated template generated by the processor. The processor may select the communication template by using a machine learning model to score the plurality of communication templates based at least in part on the communication content, communication context, first user communication attribute, or second user communication attribute.

In an embodiment, a method of electronic communication assistance may include receiving a partial electronic communication at an artificial intelligence assistant computing facility from an electronic identifier associated with a user, the partial electronic communication comprising a communication content and comprising or associated with the electronic identifier associated with the user and a second electronic identifier associated with a second user; extracting a communication context from the partial electronic communication; encoding the partial electronic communication for processing creating an encoded partial electronic communication; retrieving from a communication profile database a communication profile for the second user using the second electronic identifier associated with the second user, wherein the communication profile comprises a second user communication attribute; processing the encoded partial electronic communication with a processor to generate a compositional change for the communication content of the partial electronic communication using at least one of the communication context or the second user communication attribute to generate the compositional change; and generating a changed electronic communication from the partial electronic communication and the compositional change.

In an embodiment, the method may include transmitting the changed electronic communication to the electronic identifier associated with the user or transmitting the changed electronic communication to a second electronic identifier associated with a second user. The compositional change may be derived from representations of previous content and context from a plurality of user profiles stored in a communication profile database which are like at least one of the communication profiles of the first or second user. The processor may be trained on large-scale data mixed with prior communication and effective communications from the plurality of user profiles. The processor may use at least one of a machine learning model, deep learning model, or other statistical learning algorithm for creating the compositional change. The compositional change may be an auto-generated textual completion. The auto-generated textual completion may be a phrasal completion. The processor may generate the compositional change by optimizing generated language as determined by the processor from the second user communication attribute. The processor may generate the compositional change by replicating a communication style of the user. The partial electronic communication may include a communication goal, and the processor may generate the compositional change by optimizing for impact and effectiveness of generated language with respect to the communication goal. The processor may generate the compositional change further using a communication template selected from a plurality of communication templates comprising at least one of prepared text or placeholder locations for defining structural elements for user completion. The processor may select the communication template using at least one of a machine learning model, deep learning model, or statistical learning model to find a most effective communication template based at least in part on the communication content. The plurality of communication templates may include at least one automatically generated template generated by the processor. The processor may select the communication template by using a machine learning model to score the plurality of communication templates based at least in part on the communication content, communication context, first user communication attribute, or second user communication attribute.

In an embodiment, a method of electronic communication assistance may include: receiving a partial electronic communication at an artificial intelligence assistant computing facility from an electronic identifier associated with a user, the partial electronic communication comprising a communication content and comprising or associated with the electronic identifier and a second electronic identifier associated with a second user; retrieving a second communication profile, wherein the second communication profile comprises a second user communication attribute; processing the partial electronic communication with a processor to generate a compositional change for the communication content of the partial electronic communication using the second user communication attribute to generate the compositional change; and generating a changed electronic communication from the partial electronic communication and the compositional change.

In an embodiment, the method may include transmitting the changed electronic communication to the electronic identifier associated with the user or transmitting the changed electronic communication to a second electronic identifier associated with a second user. The compositional change may be derived from representations of previous content and context from a plurality of user profiles which are like at least one of the communication profiles. The processor may be trained on large-scale data mixed with prior communication and effective communications from the plurality of user profiles. The processor may use at least one of a machine learning model, deep learning model, or other statistical learning algorithm for creating the compositional change. The compositional change may be an auto-generated textual completion. The auto-generated textual completion may be a phrasal completion. The processor may generate the compositional change by optimizing generated language as determined by the processor from the second user communication attribute. The processor may generate the compositional change by replicating a communication style of the user as determined by the processor from the user communication attribute. The partial electronic communication may include a communication goal, and the processor may generate the compositional change by optimizing for impact and effectiveness of generated language with respect to the communication goal. The processor may generate the compositional change further using a communication template selected from a plurality of communication templates comprising at least one of prepared text or placeholder locations for defining structural elements for user completion. The processor may select the communication template using at least one of a machine learning model, deep learning model, or statistical learning model to find the most effective communication template based at least in part on the communication content. The plurality of communication templates may include at least one automatically-generated template generated by the processor. The processor may select the communication template by using a machine learning model to score the plurality of communication templates based at least in part on the communication content, communication context, first-user communication attribute, or second-user communication attribute.

In an embodiment, a system may include a server computer comprising a processor and a computer-readable storage device that stores instructions that, when executed by the processor, cause the processor to perform operations comprising: receiving a partial electronic communication at an artificial intelligence assistant computing facility from a first electronic identifier associated with a first user, the partial electronic communication comprising a communication content and comprising or associated with the first electronic identifier associated with the first user and a second electronic identifier associated with a second user; extracting a communication context from the partial electronic communication; encoding the partial electronic communication for processing creating an encoded partial electronic communication; retrieving from a communication profile database a first communication profile for the first user using the first electronic identifier associated with the first user, wherein the first communication profile comprises a first user communication attribute; retrieving from the communication profile database a second communication profile for the second user using the second electronic identifier associated with the second user, wherein the second communication profile comprises a second user communication attribute; processing the encoded partial electronic communication with a processor to generate a compositional change for the communication content of the partial electronic communication using at least one of the communication context, the first user communication attribute, or the second user communication attribute to generate the compositional change; and generating a changed electronic communication from the partial electronic communication and the compositional change.

In an embodiment, the system computer may be enabled to perform operations, including transmitting the changed electronic communication to the electronic identifier associated with the user and/or transmitting the changed electronic communication to a second electronic identifier associated with a second user. The compositional change may be derived from representations of previous content and context from a plurality of user profiles stored in the communication profile database, which are like at least one of the first communication profiles or the second communication profile. The processor may be trained on large-scale data mixed with prior communication and effective communications from the plurality of user profiles. The processor may use a machine learning model, deep learning model, or other statistical learning algorithm for creating the compositional change. The compositional change may be an auto-generated textual completion. The auto-generated textual completion may be a phrasal completion. The processor may generate the compositional change by optimizing the generated language as determined by the processor from the second user communication attribute. The processor may generate the compositional change by replicating the communication style of the first user as determined by the processor from the first user communication attribute. The partial electronic communication may include a communication goal, and the processor may generate the compositional change by optimizing the impact and effectiveness of the generated language with respect to the communication goal. The processor may generate the compositional change further using a communication template selected from a plurality of communication templates comprising at least one of the prepared text or placeholder locations for defining structural elements for user completion. The processor may select the communication template using at least one of a machine learning model, deep learning model, or statistical learning model to find the most effective communication template based at least in part on the communication content. The plurality of communication templates may include at least one automatically-generated template generated by the processor. The processor may select the communication template by using a machine learning model to score the plurality of communication templates based at least in part on the communication content, communication context, first user communication attribute, or second user communication attribute.

In an embodiment, a system may include: a server computer comprising a processor and a computer-readable storage device that stores instructions that, when executed by the processor, cause the processor to perform operations comprising: receiving a partial electronic communication at an artificial intelligence assistant computing facility from a first electronic identifier associated with a first user, the partial electronic communication comprising a communication content and comprising or associated with the first electronic identifier and a second electronic identifier associated with a second user; retrieving a first communication profile, wherein the first communication profile comprises a first user communication attribute; retrieving a second communication profile, wherein the second communication profile comprises a second user communication attribute; processing the partial electronic communication with a processor to generate a compositional change for the communication content of the partial electronic communication using at least one of the first user communication attribute or the second user communication attribute to generate the compositional change; and generating a changed electronic communication from the partial electronic communication and the compositional change.

In an embodiment, the system computer may be enabled to perform operations, including transmitting the changed electronic communication to the first electronic identifier associated with the first user or transmitting the changed electronic communication to a second electronic identifier associated with a second user. The compositional change may be derived from representations of previous content and context from a plurality of user profiles which are like at least one of the first communication profile or the second communication profile. The processor may be trained on large-scale data mixed with prior communication and effective communications from the plurality of user profiles. The processor may use a machine learning model, deep learning model, or other statistical learning algorithm for creating the compositional change. The compositional change may be an auto-generated textual completion. The auto-generated textual completion may be a phrasal completion. The processor may generate the compositional change by optimizing the generated language as determined by the processor from the second user communication attribute. The processor may generate the compositional change by replicating the communication style of the first user as determined by the processor from the first user communication attribute. The partial electronic communication may include a communication goal, and the processor may generate the compositional change by optimizing for impact and effectiveness of generated language with respect to the communication goal. The processor may generate the compositional change further using a communication template selected from a plurality of communication templates comprising at least one of the prepared text or placeholder locations for defining structural elements for user completion. The processor may select the communication template using at least one of a machine learning model, deep learning model, or statistical learning model to find a most effective communication template based at least in part on the communication content. The plurality of communication templates may include at least one automatically generated template generated by the processor. The processor may select the communication template by using a machine learning model to score the plurality of communication templates based at least in part on the communication content, communication context, first user communication attribute, or second user communication attribute.

In an embodiment, a system may include a server computer comprising a processor and a computer-readable storage device that stores instructions that, when executed by the processor, cause the processor to perform operations comprising: receiving a partial electronic communication at an artificial intelligence assistant computing facility from an electronic identifier associated with a user, the partial electronic communication comprising a communication content and comprising or associated with the electronic identifier associated with the user; extracting a communication context from the partial electronic communication; encoding the partial electronic communication for processing creating an encoded partial electronic communication; retrieving from a communication profile database a communication profile for the user using the electronic identifier associated with the user, wherein the communication profile comprises a user communication attribute; processing the encoded partial electronic communication with a processor to generate a compositional change for the communication content of the partial electronic communication using at least one of the communication context or the user communication attribute; and generating a changed electronic communication from the partial electronic communication and the compositional change.

In an embodiment, the system computer may be enabled to perform operations including transmitting the changed electronic communication to the electronic identifier associated with the user or transmitting the changed electronic communication to a second electronic identifier associated with a second user. The compositional change may be derived from representations of previous content and context from a plurality of user profiles stored in the communication profile database which are like the communication profile. The processor may be trained on large-scale data mixed with prior communication and effective communications from the plurality of user profiles. The processor may use at least one of a machine learning model, deep learning model, or other statistical learning algorithm for creating the compositional change. The compositional change may be an auto-generated textual completion. The auto-generated textual completion may be a phrasal completion. The processor may generate the compositional change by optimizing generated language of a user as determined by the processor from a user communication attribute. The processor may generate the compositional change by replicating a communication style of the user as determined by the processor from the user communication attribute. The partial electronic communication further comprises a communication goal, and the processor may generate the compositional change by optimizing for impact and effectiveness of generated language with respect to the communication goal. The processor may generate the compositional change further using a communication template selected from a plurality of communication templates comprising at least one of prepared text or placeholder locations for defining structural elements for user completion. The processor may select the communication template using at least one of a machine learning model, deep learning model, or statistical learning model to find a most effective communication template based at least in part on the communication content. The plurality of communication templates may include at least one automatically generated template generated by the processor. The processor may select the communication template by using a machine learning model to score the plurality of communication templates based at least in part on the communication content, communication context, first user communication attribute, or second user communication attribute.

In an embodiment, a system may include a server computer comprising a processor and a computer-readable storage device that stores instructions that, when executed by the processor, cause the processor to perform operations comprising: receiving a partial electronic communication at an artificial intelligence assistant computing facility from an electronic identifier associated with a user, the partial electronic communication comprising a communication content and comprising or associated with the electronic identifier; retrieving a communication profile, wherein the communication profile comprises a user communication attribute; processing the partial electronic communication with a processor to generate a compositional change for the communication content of the partial electronic communication using the user communication attribute to generate the compositional change; and generating a changed electronic communication from the partial electronic communication and the compositional change.

In an embodiment, the system computer may be enabled to perform operations including transmitting the changed electronic communication to the electronic identifier associated with the user or transmitting the changed electronic communication to a second electronic identifier associated with a second user. The compositional change may be derived from representations of previous content and context from a plurality of user profiles which are like at least one of the communication profiles. The processor may be trained on large-scale data mixed with prior communication and effective communications from the plurality of user profiles. The processor may use at least one of a machine learning model, deep learning model, or other statistical learning algorithm for creating the compositional change. The compositional change may be an auto-generated textual completion. The auto-generated textual completion may be a phrasal completion. The processor may generate the compositional change by optimizing generated language of a user as determined by the processor from a user communication attribute. The processor may generate the compositional change by replicating a communication style of the user as determined by the processor from the user communication attribute. The partial electronic communication further comprises a communication goal, and the processor may generate the compositional change by optimizing for impact and effectiveness of generated language with respect to the communication goal. The processor may generate the compositional change further using a communication template selected from a plurality of communication templates comprising at least one of prepared text or placeholder locations for defining structural elements for user completion. The processor may select the communication template using at least one of a machine learning model, deep learning model, or statistical learning model to find a most effective communication template based at least in part on the communication content. The plurality of communication templates may include at least one automatically generated template generated by the processor. The processor may select the communication template by using a machine learning model to score the plurality of communication templates based at least in part on the communication content, communication context, first user communication attribute, or second user communication attribute.

In an embodiment, a system may include a server computer comprising a processor and a computer-readable storage device that stores instructions that, when executed by the processor, cause the processor to perform operations comprising: receiving a partial electronic communication at an artificial intelligence assistant computing facility from an electronic identifier associated with a user, the partial electronic communication comprising a communication content and comprising or associated with the electronic identifier associated with the user and a second electronic identifier associated with a second user; extracting a communication context from the partial electronic communication; encoding the partial electronic communication for processing creating an encoded partial electronic communication; retrieving from a communication profile database a second communication profile for the second user using the second electronic identifier associated with the second user, wherein the second communication profile comprises a second user communication attribute; processing the encoded partial electronic communication with a processor to generate a compositional change for the communication content of the partial electronic communication using at least one of the communication context or the second user communication attribute to generate the compositional change; and generating a changed electronic communication from the partial electronic communication and the compositional change.

In an embodiment, the system computer may be enabled to perform operations including transmitting the changed electronic communication to the electronic identifier associated with the user or transmitting the changed electronic communication to a second electronic identifier associated with a second user. The compositional change may be derived from representations of previous content and context from a plurality of user profiles stored in a communication profile database which are like the communication profile. The processor may be trained on large-scale data mixed with prior communication and effective communications from the plurality of user profiles. The processor may use at least one of a machine learning model, deep learning model, or other statistical learning algorithm for creating the compositional change. The compositional change may be an auto-generated textual completion. The auto-generated textual completion may be a phrasal completion. The processor may generate the compositional change by optimizing generated language as determined by the processor from the second user communication attribute. The processor may generate the compositional change by replicating a communication style of the user as determined by the processor from the user communication attribute. The partial electronic communication further comprises a communication goal, and the processor may generate the compositional change by optimizing for impact and effectiveness of generated language with respect to the communication goal. The processor may generate the compositional change further using a communication template selected from a plurality of communication templates comprising at least one of prepared text or placeholder locations for defining structural elements for user completion. The processor may select the communication template using at least one of a machine learning model, deep learning model, or statistical learning model to find a most effective communication template based at least in part on the communication content. The plurality of communication templates may include at least one automatically generated template generated by the processor. The processor may select the communication template by using a machine learning model to score the plurality of communication templates based at least in part on the communication content, communication context, first user communication attribute, or second user communication attribute.

In an embodiment, a system of electronic communication assistance may perform the following: receiving a partial electronic communication at an artificial intelligence assistant computing facility from an electronic identifier associated with a user, the partial electronic communication comprising a communication content and comprising or associated with the electronic identifier and a second electronic identifier associated with a second user; retrieving a second communication profile, wherein the second communication profile comprises a second user communication attribute; processing the partial electronic communication with a processor to generate a compositional change for the communication content of the partial electronic communication using the second user communication attribute to generate the compositional change; and generating a changed electronic communication from the partial electronic communication and the compositional change.

In an embodiment, the system computer may be enabled to perform operations including transmitting the changed electronic communication to the electronic identifier associated with the user or transmitting the changed electronic communication to a second electronic identifier associated with a second user. The compositional change may be derived from representations of previous content and context from a plurality of user profiles which are like at least one of the communication profile or the second communication profile. The processor may be trained on large-scale data mixed with prior communication and effective communications from the plurality of user profiles. The processor may use at least one of a machine learning model, deep learning model, or other statistical learning algorithm for creating the compositional change. The compositional change may be an auto-generated textual completion. The auto-generated textual completion may be a phrasal completion. The processor may generate the compositional change by optimizing generated language as determined by the processor from the second user communication attribute. The processor may generate the compositional change by replicating a communication style of the user as determined by the processor from the user communication attribute. The partial electronic communication further comprises a communication goal, and the processor may generate the compositional change by optimizing for the impact and effectiveness of generated language with respect to the communication goal. The processor may generate the compositional change further using a communication template selected from a plurality of communication templates comprising at least one of prepared text or placeholder locations for defining structural elements for user completion. The processor may select the communication template using at least one of a machine learning model, deep learning model, or statistical learning model to find a most effective communication template based at least in part on the communication content. The plurality of communication templates may include at least one automatically generated template generated by the processor. The processor may select the communication template by using a machine learning model to score the plurality of communication templates based at least in part on the communication content, communication context, first user communication attribute, or second user communication attribute.

In an embodiment, a method of electronic communication assistance may include intercepting an electronic communication from further transmission at an artificial intelligence assistant computing facility, wherein the electronic communication was transmitted from a first electronic identifier associated with a first user to second electronic identifier associated with a second user, the electronic communication comprising a communication content and comprising or associated with the first electronic identifier associated with the first user; extracting a communication context from the electronic communication; encoding the electronic communication for processing creating an encoded electronic communication; retrieving from a communication profile database a first communication profile for the first user using the first user identifier, wherein the first communication profile comprises a first user communication attribute; retrieving from the communication profile database a second communication profile for the second user using the second electronic identifier, wherein the second communication profile comprises a second user communication attribute; processing the encoded electronic communication with a processor to generate a compositional change for the communication content of the electronic communication using at least one of the communication context, the first user communication attribute, or the second user communication attribute to generate the compositional change; and generating a changed electronic communication from the electronic communication and the compositional change, wherein the changed electronic communication comprises annotations to indicate the compositional change to the electronic communication.

In an embodiment, the method may include transmitting the changed electronic communication to the first electronic identifier associated with the first user or transmitting the changed electronic communication to the second electronic identifier associated with the second user. The compositional change may be derived from representations of previous content and context from a plurality of user profiles stored in the communication profile database which are like at least one of the first communication profile or the second communication profile. The processor may be trained on large-scale data mixed with prior communication and effective communications from the plurality of user profiles. The processor may use at least one of a machine learning language model or a statistical algorithm for creating the compositional change. The processor may generate the compositional change by optimizing generated language of the second user as determined by the processor from the second user communication attribute. The processor may generate the compositional change by replicating a communication style of the first user as determined by the processor from the first user communication attribute. The electronic communication further comprises a communication goal, and the processor may generate the compositional change by optimizing for impact and effectiveness of generated language with respect to the communication goal.

In an embodiment, a method of electronic communication assistance may include: intercepting an electronic communication from further transmission at an artificial intelligence assistant computing facility, wherein the electronic communication was transmitted from a first electronic identifier associated with a first user to second electronic identifier associated with a second user, the electronic communication comprising a communication content and comprising or associated with the first electronic identifier associated with the first user; retrieving a first communication profile for the first user using the first user identifier, wherein the first communication profile comprises a first user communication attribute; retrieving a second communication profile for the second user using the second electronic identifier, wherein the second communication profile comprises a second user communication attribute; processing the electronic communication with a processor to generate a compositional change for the communication content of the electronic communication using at least one of the first user communication attribute or the second user communication attribute to generate the compositional change; and generating a changed electronic communication from the electronic communication and the compositional change, wherein the changed electronic communication comprises annotations to indicate the compositional change to the electronic communication.

In an embodiment, a method of electronic communication assistance may include: intercepting an electronic communication from further transmission at an artificial intelligence assistant computing facility, wherein the electronic communication was transmitted from an electronic identifier associated with a user, the electronic communication comprising a communication content and comprising or associated with the electronic identifier associated with the user; extracting a communication context from the electronic communication; encoding the electronic communication for processing creating an encoded electronic communication; retrieving from a communication profile database a communication profile for the user using the user identifier, wherein the communication profile comprises a user communication attribute; processing the encoded electronic communication with a processor to generate a compositional change for the communication content of the electronic communication using at least one of the communication context or the user communication attribute to generate the compositional change; and generating a changed electronic communication from the electronic communication and the compositional change, wherein the changed electronic communication comprises annotations to indicate the compositional change to the electronic communication.

In an embodiment, a method of electronic communication assistance may include: intercepting an electronic communication from further transmission at an artificial intelligence assistant computing facility, wherein the electronic communication was transmitted from an electronic identifier associated with a user, the electronic communication comprising a communication content and comprising or associated with the electronic identifier associated with the user; retrieving a communication profile for the user using the user identifier, wherein the communication profile comprises a user communication attribute; processing the electronic communication with a processor to generate a compositional change for the communication content of the electronic communication using the user communication attribute to generate the compositional change; and generating a changed electronic communication from the electronic communication and the compositional change, wherein the changed electronic communication comprises annotations to indicate the compositional change to the electronic communication.

In an embodiment, a method of electronic communication assistance may include: intercepting an electronic communication from further transmission at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user; extracting a communication context from the electronic communication; encoding the electronic communication for processing creating an encoded electronic communication; retrieving from a communication profile database a communication profile for the second user using the second electronic identifier, wherein the communication profile comprises a second user communication attribute; processing the encoded electronic communication with a processor to generate a compositional change for the communication content of the electronic communication using at least one of the communication context or the second user communication attribute to generate the compositional change; and generating a changed electronic communication from the electronic communication and the compositional change, wherein the changed electronic communication comprises annotations to indicate the compositional change to the electronic communication.

In an embodiment, a method of electronic communication assistance may include: intercepting an electronic communication from further transmission at an artificial intelligence assistant computing facility, wherein the electronic communication was transmitted to a second electronic identifier associated with a second user, the electronic communication comprising a communication content and comprising or associated with the first electronic identifier associated with the first user; retrieving from a communication profile database a communication profile for the second user using the second electronic identifier, wherein the communication profile comprises a second user communication attribute; processing the electronic communication with a processor to generate a compositional change for the communication content of the electronic communication using the second user communication attribute to generate the compositional change; and generating a changed electronic communication from the electronic communication and the compositional change, wherein the changed electronic communication comprises annotations to indicate the compositional change to the electronic communication.

In an embodiment, a system may include a server computer comprising a processor and a computer-readable storage device that stores instructions that, when executed by the processor, cause the processor to perform operations comprising: intercepting an electronic communication from further transmission at an artificial intelligence assistant computing facility, wherein the electronic communication was transmitted from a first electronic identifier associated with a first user to second electronic identifier associated with a second user, the electronic communication comprising a communication content and comprising or associated with the first electronic identifier associated with the first user; extracting a communication context from the electronic communication; encoding the electronic communication for processing creating an encoded electronic communication; retrieving from a communication profile database a first communication profile for the first user using the first user identifier, wherein the first communication profile comprises a first user communication attribute; retrieving from the communication profile database a second communication profile for the second user using the second electronic identifier, wherein the second communication profile comprises a second user communication attribute; processing the encoded electronic communication with a processor to generate a compositional change for the communication content of the electronic communication using at least one of the communication context, the first user communication attribute, or the second user communication attribute to generate the compositional change; and generating a changed electronic communication from the electronic communication and the compositional change, wherein the changed electronic communication comprises annotations to indicate the compositional change to the electronic communication.

In an embodiment, a system may include a server computer comprising a processor and a computer-readable storage device that stores instructions that, when executed by the processor, cause the processor to perform operations comprising: intercepting an electronic communication from further transmission at an artificial intelligence assistant computing facility, wherein the electronic communication was transmitted from a first electronic identifier associated with a first user to second electronic identifier associated with a second user, the electronic communication comprising a communication content and comprising or associated with the first electronic identifier associated with the first user; retrieving a first communication profile for the first user using the first user identifier, wherein the first communication profile comprises a first user communication attribute; retrieving a second communication profile for the second user using the second electronic identifier, wherein the second communication profile comprises a second user communication attribute; processing the electronic communication with a processor to generate a compositional change for the communication content of the electronic communication using at least one of the first user communication attribute or the second user communication attribute to generate the compositional change; and generating a changed electronic communication from the electronic communication and the compositional change, wherein the changed electronic communication comprises annotations to indicate the compositional change to the electronic communication.

In an embodiment, a system may include a server computer comprising a processor and a computer-readable storage device that stores instructions that, when executed by the processor, cause the processor to perform operations comprising: intercepting an electronic communication from further transmission at an artificial intelligence assistant computing facility, wherein the electronic communication was transmitted from an electronic identifier associated with a user, the electronic communication comprising a communication content and comprising or associated with the electronic identifier associated with the user; extracting a communication context from the electronic communication; encoding the electronic communication for processing creating an encoded electronic communication; retrieving from a communication profile database a communication profile for the user using the user identifier, wherein the communication profile comprises a user communication attribute; processing the encoded electronic communication with a processor to generate a compositional change for the communication content of the electronic communication using at least one of the communication context or the user communication attribute to generate the compositional change; and generating a changed electronic communication from the electronic communication and the compositional change, wherein the changed electronic communication comprises annotations to indicate the compositional change to the electronic communication.

In an embodiment, a system may include a server computer comprising a processor and a computer-readable storage device that stores instructions that, when executed by the processor, cause the processor to perform operations comprising: intercepting an electronic communication from further transmission at an artificial intelligence assistant computing facility, wherein the electronic communication was transmitted from an electronic identifier associated with a user, the electronic communication comprising a communication content and comprising or associated with the electronic identifier associated with the user; retrieving a communication profile for the user using the user identifier, wherein the communication profile comprises a user communication attribute; processing the electronic communication with a processor to generate a compositional change for the communication content of the electronic communication using the user communication attribute to generate the compositional change; and generating a changed electronic communication from the electronic communication and the compositional change, wherein the changed electronic communication comprises annotations to indicate the compositional change to the electronic communication.

In an embodiment, a system may include a server computer comprising a processor and a computer-readable storage device that stores instructions that, when executed by the processor, cause the processor to perform operations comprising: intercepting an electronic communication from further transmission at an artificial intelligence assistant computing facility, wherein the electronic communication was transmitted from a first electronic identifier associated with a first user to second electronic identifier associated with a second user, the electronic communication comprising a communication content and comprising or associated with the first electronic identifier associated with the first user; extracting a communication context from the electronic communication; encoding the electronic communication for processing creating an encoded electronic communication; retrieving from a communication profile database a communication profile for the second user using the second electronic identifier, wherein the communication profile comprises a second user communication attribute; processing the encoded electronic communication with a processor to generate a compositional change for the communication content of the electronic communication using at least one of the communication context or the second user communication attribute to generate the compositional change; and generating a changed electronic communication from the electronic communication and the compositional change, wherein the changed electronic communication comprises annotations to indicate the compositional change to the electronic communication.

In an embodiment, a system may include a server computer comprising a processor and a computer-readable storage device that stores instructions that, when executed by the processor, cause the processor to perform operations comprising: intercepting an electronic communication from further transmission at an artificial intelligence assistant computing facility, wherein the electronic communication was transmitted to second electronic identifier associated with a second user, the electronic communication comprising a communication content and comprising or associated with the first electronic identifier associated with the first user; retrieving from a communication profile database a communication profile for the second user using the second electronic identifier, wherein the communication profile comprises a second user communication attribute; processing the electronic communication with a processor to generate a compositional change for the communication content of the electronic communication using the second user communication attribute to generate the compositional change; and generating a changed electronic communication from the electronic communication and the compositional change, wherein the changed electronic communication comprises annotations to indicate the compositional change to the electronic communication.

In an embodiment, a method of electronic communication assistance may include: receiving electronic communication information as an electronic communication is composed at an artificial intelligence assistant computing facility from a first electronic identifier associated with a first user, the electronic communication information comprising a communication content and comprising or associated with the first electronic identifier associated with the first user and a second electronic identifier associated with a second user; extracting a communication context from the electronic communication information; retrieving from a communication profile database a first communication profile for the first user using the first electronic identifier, wherein the first communication profile comprises a first user communication attribute; retrieving from the communication profile database a second communication profile for the second user using the second electronic identifier, wherein the second communication profile comprises a second user communication attribute; processing the electronic communication information with a processor to generate a compositional recommendation for developing a communication content related to the electronic communication information using at least one of the communication context, the first user communication attribute, or the second user communication attribute to generate the compositional recommendation; and transmitting the compositional recommendation to the first electronic identifier.

In an embodiment, the method may further include intercepting an electronic communication from the first electronic identifier, the electronic communication relating to the electronic communication information and the compositional recommendation; encoding the electronic communication to create an encoded electronic communication; processing the encoded electronic communication with the processor to extract an additional communication attribute from the electronic communication; and updating the first communication profile for the first user based on the additional communication attribute. The compositional recommendation may be derived from representations of previous content and context from a plurality of user profiles stored in the communication profile database which are like at least one of the first communication profile or the second communication profile. The processor may calculate weighted scores for predicted reaction outcome and expected reaction outcome, and derives the compositional recommendation based on a comparison of the calculated weighted scores. The processor may use at least one of a machine learning mode, deep learning model, or statistical learning algorithm for creating the compositional recommendation. The processor may generate the compositional recommendation by evaluating a communication style of the first user as determined by the processor from the first user communication attribute. The processor may generate the compositional recommendation further using a communication recommendation template selected from a plurality of communication recommendation templates. The processor may select the communication recommendation template using at least one of a machine learning model, deep learning model, or statistical learning model to find a most effective communication recommendation template based at least in part on the electronic communication information. The plurality of communication recommendation templates may include at least one automatically generated template generated by the processor. The processor may select the communication recommendation template by using a machine learning model to score the plurality of communication recommendation templates based at least in part on the electronic communication information. The electronic communication information may include a communication goal. The communication goal may be used in generating the compositional recommendation.

In an embodiment, a method of electronic communication assistance may include: receiving electronic communication information as an electronic communication is composed at an artificial intelligence assistant computing facility from a first electronic identifier associated with a first user, the electronic communication information comprising a communication content and comprising or associated with the first electronic identifier associated with the first user and a second electronic identifier associated with a second user; retrieving a first communication profile for the first user using the first electronic identifier, wherein the first communication profile comprises a first user communication attribute; retrieving a second communication profile for the second user using the second electronic identifier, wherein the second communication profile comprises a second user communication attribute; processing the electronic communication information with a processor to generate a compositional recommendation for developing a communication content related to the electronic communication information using at least one of the first user communication attribute or the second user communication attribute to generate the compositional recommendation; and transmitting the compositional recommendation to the first electronic identifier.

In an embodiment, a method of electronic communication assistance may include: receiving electronic communication information as an electronic communication is composed at an artificial intelligence assistant computing facility from an electronic identifier associated with a user, the electronic communication information comprising a communication content and comprising or associated with the electronic identifier associated with the user; extracting a communication context from the electronic communication information; retrieving from a communication profile database a communication profile for the user using the electronic identifier, wherein the communication profile comprises a user communication attribute; processing the electronic communication information with a processor to generate a compositional recommendation for developing a communication content related to the electronic communication information using at least one of the communication context or the user communication attribute to generate the compositional recommendation; and transmitting the compositional recommendation to the electronic identifier.

In an embodiment, a method of electronic communication assistance may include: receiving electronic communication information as an electronic communication is composed at an artificial intelligence assistant computing facility from an electronic identifier associated with a user, the electronic communication information comprising a communication content and comprising or associated with the electronic identifier associated with the user; retrieving a communication profile for the user using the electronic identifier, wherein the communication profile comprises a user communication attribute; processing the electronic communication information with a processor to generate a compositional recommendation for developing a communication content related to the electronic communication information using the user communication attribute; and transmitting the compositional recommendation to the electronic identifier.

In an embodiment, a method of electronic communication assistance may include: receiving electronic communication information as an electronic communication is composed at an artificial intelligence assistant computing facility from a first electronic identifier associated with a first user, the electronic communication information comprising a communication content and comprising or associated with the first electronic identifier associated with the first user and a second electronic identifier associated with a second user; extracting a communication context from the electronic communication information; retrieving a communication profile for the second user using the second electronic identifier, wherein the communication profile comprises a second user communication attribute; processing the electronic communication information with a processor to generate a compositional recommendation for developing a communication content related to the electronic communication information using at least one of the communication context or the second user communication attribute to generate the compositional recommendation; and transmitting the compositional recommendation to the first electronic identifier.

In an embodiment, a method of electronic communication assistance may include receiving electronic communication information as an electronic communication is composed at an artificial intelligence assistant computing facility from a first electronic identifier associated with a first user, the electronic communication information comprising a communication content and comprising or associated with the first electronic identifier associated with the first user and a second electronic identifier associated with a second user; retrieving a communication profile for the second user using the second electronic identifier, wherein the communication profile comprises a second user communication attribute; processing the electronic communication information with a processor to generate a compositional recommendation for developing a communication content related to the electronic communication information using the second user communication attribute to generate the compositional recommendation; and transmitting the compositional recommendation to the first electronic identifier.

In an embodiment, a system may include a server computer comprising a processor and a computer-readable storage device that stores instructions that, when executed by the processor, cause the processor to perform operations comprising: receiving electronic communication information as an electronic communication is composed at an artificial intelligence assistant computing facility from a first electronic identifier associated with a first user, the electronic communication information comprising a communication content and comprising or associated with the first electronic identifier associated with the first user and a second electronic identifier associated with a second user; extracting a communication context from the electronic communication information; retrieving from a communication profile database a first communication profile for the first user using the first electronic identifier, wherein the first communication profile comprises a first user communication attribute; retrieving from the communication profile database a second communication profile for the second user using the second electronic identifier, wherein the second communication profile comprises a second user communication attribute; processing the electronic communication information with a processor to generate a compositional recommendation for developing a communication content related to the electronic communication information using at least one of the communication context, the first user communication attribute, or the second user communication attribute to generate the compositional recommendation; and transmitting the compositional recommendation to the first electronic identifier.

In an embodiment, a system may include a server computer comprising a processor and a computer-readable storage device that stores instructions that, when executed by the processor, cause the processor to perform operations comprising: receiving electronic communication information as an electronic communication is composed at an artificial intelligence assistant computing facility from a first electronic identifier associated with a first user, the electronic communication information comprising a communication content and comprising or associated with the first electronic identifier associated with the first user and a second electronic identifier associated with a second user; retrieving a first communication profile for the first user using the first electronic identifier, wherein the first communication profile comprises a first user communication attribute; retrieving a second communication profile for the second user using the second electronic identifier, wherein the second communication profile comprises a second user communication attribute; processing the electronic communication information with a processor to generate a compositional recommendation for developing a communication content related to the electronic communication information using at least one of the first user communication attribute or the second user communication attribute to generate the compositional recommendation; and transmitting the compositional recommendation to the first electronic identifier.

In an embodiment, a system may include a server computer comprising a processor and a computer-readable storage device that stores instructions that, when executed by the processor, cause the processor to perform operations comprising: receiving electronic communication information as an electronic communication is composed at an artificial intelligence assistant computing facility from an electronic identifier associated with a user, the electronic communication information comprising a communication content and comprising or associated with the electronic identifier; extracting a communication context from the electronic communication information; retrieving from a communication profile database a communication profile for the user using the electronic identifier, wherein the communication profile comprises a user communication attribute; processing the electronic communication information with a processor to generate a compositional recommendation for developing a communication content related to the electronic communication information using at least one of the communication context or the user communication attribute to generate the compositional recommendation; and transmitting the compositional recommendation to the electronic identifier.

In an embodiment, a system may include a server computer comprising a processor and a computer-readable storage device that stores instructions that, when executed by the processor, cause the processor to perform operations comprising: receiving electronic communication information as an electronic communication is composed at an artificial intelligence assistant computing facility from an electronic identifier associated with a user, the electronic communication information comprising a communication content and comprising or associated with the electronic identifier associated with the user; retrieving a communication profile for the user using the electronic identifier, wherein the communication profile comprises a user communication attribute; processing the electronic communication information with a processor to generate a compositional recommendation for developing a communication content related to the electronic communication information using the user communication attribute to generate the compositional recommendation; and transmitting the compositional recommendation to the electronic identifier.

In an embodiment, a system may include a server computer comprising a processor and a computer-readable storage device that stores instructions that, when executed by the processor, cause the processor to perform operations comprising: receiving electronic communication information as an electronic communication is composed at an artificial intelligence assistant computing facility from a first electronic identifier associated with a first user, the electronic communication information comprising a communication content and comprising or associated with the first electronic identifier associated with the first user and a second electronic identifier associated with a second user; extracting a communication context from the electronic communication information; retrieving from a communication profile database a communication profile for the second user using the second electronic identifier, wherein the communication profile comprises a second user communication attribute; processing the electronic communication information with a processor to generate a compositional recommendation for developing a communication content related to the electronic communication information using at least one of the communication context or the second user communication attribute to generate the compositional recommendation; and transmitting the compositional recommendation to the first electronic identifier.

In an embodiment, a system may include a server computer comprising a processor and a computer-readable storage device that stores instructions that, when executed by the processor, cause the processor to perform operations comprising: receiving electronic communication information as an electronic communication is composed at an artificial intelligence assistant computing facility from a first electronic identifier associated with a first user, the electronic communication information comprising a communication content and comprising or associated with the first electronic identifier associated with the first user and a second electronic identifier associated with a second user; retrieving a communication profile for the second user using the second electronic identifier, wherein the communication profile comprises a second user communication attribute; processing the electronic communication information with a processor to generate a compositional recommendation for developing a communication content related to the electronic communication information using the second user communication attribute to generate the compositional recommendation; and transmitting the compositional recommendation to the first electronic identifier.

In an embodiment, a method of electronic communication assistance may include: intercepting a electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user and the second electronic identifier associated with the second user; encoding the electronic communication for processing creating an encoded electronic communication; retrieving from a communication profile database a first communication profile for the first user using the first electronic identifier, wherein the first communication profile comprises a first user communication attribute; retrieving from the communication profile database a second communication profile for the second user using the second electronic identifier, wherein the second communication profile comprises a second user communication attribute that identifies a receiving communication preference; processing the encoded electronic communication with a processor to generate a modified electronic communication that is a modified version of the electronic communication, wherein the processor uses at least one of the communication content, the first user communication attribute, or the second user communication attribute to process the encoded electronic communication; and transmitting the modified electronic communication to the second electronic identifier.

In an embodiment, the processor may generate the modified electronic communication by removing or replacing language from the electronic communication based at least in part on the second user communication attribute. The removed or replaced language may be offensive or abusive language. The processor may generate the modified electronic communication by summarizing language from the electronic communication based at least in part on the second user communication attribute. The processor may generate the modified electronic communication by reformatting the electronic communication based at least in part on the second user communication attribute. The processor may generate the modified electronic communication by recomposing language from the electronic communication based at least in part on the second user communication attribute. The processor may generate the modified electronic communication by incorporating explanatory text associated with phases based at least in part on the second user communication attribute. The processor may generate the modified electronic communication derived at least in part from representations of previous electronic communications from a plurality of user profiles stored in the communication profile database that are like at least one of the first communication profile or the second communication profile. The processor may be trained on large-scale data mixed with prior communication and effective communications from the plurality of user profiles. The processor may use at least one of a machine learning model, deep learning model, or statistical learning model for generating the modified electronic communication. The modified electronic communication may be used to generate at least one of an updated first communication profile or an updated second communication profile. Prior to transmitting the modified electronic communication to the second electronic identifier, receiving a request by the second user may be received to provide the modified electronic communication.

In an embodiment, a method of electronic communication assistance may include: intercepting a electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user; retrieving a first communication profile for the first user using the first electronic identifier, wherein the first communication profile comprises a first user communication attribute; retrieving a second communication profile for the second user using the second electronic identifier, wherein the second communication profile comprises a second user communication attribute that identifies a receiving communication preference; processing the electronic communication with a processor to generate a modified electronic communication that is a modified version of the electronic communication, wherein the processor uses at least one of the communication content, the first user communication attribute, or the second user communication attribute to process the electronic communication; and transmitting the modified electronic communication to the second electronic identifier.

In an embodiment, a method of electronic communication assistance may include: intercepting a electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user; encoding the electronic communication for processing creating an encoded electronic communication; retrieving from a communication profile database a first communication profile for the first user using the first electronic identifier, wherein the first communication profile comprises a first user communication attribute; processing the encoded electronic communication with a processor to generate a modified electronic communication that is a modified version of the electronic communication, wherein the processor uses at least one of the communication content or the first user communication attribute to process the encoded electronic communication; and transmitting the modified electronic communication to the second electronic identifier.

In an embodiment, a method of electronic communication assistance may include: intercepting a electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user; retrieving a first communication profile for the first user using the first electronic identifier, wherein the first communication profile comprises a first user communication attribute; processing the electronic communication with a processor to generate a modified electronic communication that is a modified version of the electronic communication, wherein the processor uses at least one of the communication content or the first user communication attribute to process the electronic communication; and transmitting the modified electronic communication to the second electronic identifier.

In an embodiment, a method of electronic communication assistance may include: intercepting a electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user; encoding the electronic communication for processing creating an encoded electronic communication; retrieving from a communication profile database a second communication profile for the second user using the second electronic identifier, wherein the second communication profile comprises a second user communication attribute that identifies a receiving communication preference; processing the encoded electronic communication with a processor to generate a modified electronic communication that is a modified version of the electronic communication, wherein the processor uses at least one of the communication content or the second user communication attribute to process the encoded electronic communication; and transmitting the modified electronic communication to the second electronic identifier.

In an embodiment, a method of electronic communication assistance may include: intercepting a electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user; retrieving a second communication profile for the second user using the second electronic identifier, wherein the second communication profile comprises a second user communication attribute that identifies a receiving communication preference; processing the electronic communication with a processor to generate a modified electronic communication that is a modified version of the electronic communication, wherein the processor uses at least one of the communication content or the second user communication attribute to process the electronic communication; and transmitting the modified electronic communication to the second electronic identifier.

In an embodiment, a system may include a server computer comprising a processor and a computer-readable storage device that stores instructions that, when executed by the processor, cause the processor to perform operations comprising: intercepting a electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user and the second electronic identifier associated with the second user; encoding the electronic communication for processing creating an encoded electronic communication; retrieving from a communication profile database a first communication profile for the first user using the first electronic identifier, wherein the first communication profile comprises a first user communication attribute; retrieving from the communication profile database a second communication profile for the second user using the second electronic identifier, wherein the second communication profile comprises a second user communication attribute that identifies a receiving communication preference; processing the encoded electronic communication with a processor to generate a modified electronic communication that is a modified version of the electronic communication, wherein the processor uses at least one of the communication content, the first user communication attribute, or the second user communication attribute to process the encoded electronic communication; and transmitting the modified electronic communication to the second electronic identifier.

In an embodiment, a system may include a server computer comprising a processor and a computer-readable storage device that stores instructions that, when executed by the processor, cause the processor to perform operations comprising: intercepting a electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user; retrieving a first communication profile for the first user using the first electronic identifier, wherein the first communication profile comprises a first user communication attribute; retrieving a second communication profile for the second user using the second electronic identifier, wherein the second communication profile comprises a second user communication attribute that identifies a receiving communication preference; processing the electronic communication with a processor to generate a modified electronic communication that is a modified version of the electronic communication, wherein the processor uses at least one of the communication content, the first user communication attribute, or the second user communication attribute to process the electronic communication; and transmitting the modified electronic communication to the second electronic identifier.

In an embodiment, a system may include a server computer comprising a processor and a computer-readable storage device that stores instructions that, when executed by the processor, cause the processor to perform operations comprising: intercepting a electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user; encoding the electronic communication for processing creating an encoded electronic communication; retrieving from a communication profile database a first communication profile for the first user using the first electronic identifier, wherein the first communication profile comprises a first user communication attribute; processing the encoded electronic communication with a processor to generate a modified electronic communication that is a modified version of the electronic communication, wherein the processor uses at least one of the communication content or the first user communication attribute to process the encoded electronic communication; and transmitting the modified electronic communication to the second electronic identifier.

In an embodiment, a system may include a server computer comprising a processor and a computer-readable storage device that stores instructions that, when executed by the processor, cause the processor to perform operations comprising: intercepting a electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user; retrieving a first communication profile for the first user using the first electronic identifier, wherein the first communication profile comprises a first user communication attribute; processing the electronic communication with a processor to generate a modified electronic communication that is a modified version of the electronic communication, wherein the processor uses at least one of the communication content or the first user communication attribute to process the electronic communication; and transmitting the modified electronic communication to the second electronic identifier.

In an embodiment, a system may include a server computer comprising a processor and a computer-readable storage device that stores instructions that, when executed by the processor, cause the processor to perform operations comprising: intercepting a electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user; encoding the electronic communication for processing creating an encoded electronic communication; retrieving from a communication profile database a second communication profile for the second user using the second electronic identifier, wherein the second communication profile comprises a second user communication attribute that identifies a receiving communication preference; processing the encoded electronic communication with a processor to generate a modified electronic communication that is a modified version of the electronic communication, wherein the processor uses at least one of the communication content or the second user communication attribute to process the encoded electronic communication; and transmitting the modified electronic communication to the second electronic identifier.

In an embodiment, a system may include a server computer comprising a processor and a computer-readable storage device that stores instructions that, when executed by the processor, cause the processor to perform operations comprising: intercepting a electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user; retrieving a second communication profile for the second user using the second electronic identifier, wherein the second communication profile comprises a second user communication attribute that identifies a receiving communication preference; processing the electronic communication with a processor to generate a modified electronic communication that is a modified version of the electronic communication, wherein the processor uses at least one of the communication content or the second user communication attribute to process the electronic communication; and transmitting the modified electronic communication to the second electronic identifier.

In an embodiment, a method of electronic communication assistance may include: receiving an audio-visual electronic communication at an artificial intelligence assistant computing platform from a first user, the first user identified by a first electronic identifier, the audio-visual electronic communication comprising an audio communication content and a video communication content and comprising or associated with the first electronic identifier associated with the first user and a second electronic identifier associated with a second user, wherein the intended recipient of the audio-visual electronic communication is the second user; encoding the audio communication content for processing creating an encoded audio communication; extracting an audio communication information from the encoded audio communication content; encoding the video communication content for processing creating an encoded video communication; extracting a video communication information from the encoded video communication content; processing the audio-visual electronic communication with a processor to generate an audio-visual compositional change for the communication content of the audio-visual electronic communication using at least one of the audio communication content, the video communication content, audio communication information, video communication information, a sensor input from a wearable user device, a first user communication attribute retrieved from a communication profile for the first user using the first electronic identifier or a second user communication attribute retrieved from a communication profile for the second user using the second electronic identifier to generate the compositional change; generating a changed electronic communication from the audio-visual electronic communication and the compositional change; and providing the changed electronic communication.

In an embodiment, the compositional change may be derived from representations of previous content and context from a plurality of user profiles stored in a communication profile database which are like at least one of the first communication profile or the second communication profile. The processor may be trained on large-scale data mixed with prior communication and effective communications from a plurality of user profiles. The processor may use at least one of a machine learning model, deep learning model, or statistical learning algorithm for creating the compositional change. The processor may generate the compositional change by optimizing generated language of the first user as determined by the processor from the first user communication attribute. The processor may generate the compositional change by replicating a communication style of the first user as determined by the processor from the first user communication attribute. The audio-visual electronic communication may include a communication goal, and the processor generates the compositional change by optimizing in respect of the communication goal. The method may further include providing a textual representation of the audio-visual electronic communication within a graphical user interface on a screen of a computing device worn by the first user and providing the changed electronic communication on the screen.

In an embodiment, a method of electronic communication assistance may include: receiving an audio-visual electronic communication at an artificial intelligence assistant computing platform from a first user, the audio-visual electronic communication comprising an audio communication content and a video communication content, wherein the intended recipient of the audio-visual electronic communication is a second user; extracting an audio communication information from the audio communication content; extracting a video communication information from the video communication content; processing the audio-visual electronic communication with a processor to generate an audio-visual compositional change for the communication content of the audio-visual electronic communication using at least one of the audio communication content, the video communication content, audio communication information, video communication information, a sensor input from a wearable user device, a first user communication attribute retrieved from a communication profile for the first user or a second user communication attribute retrieved from a communication profile for the second user to generate the compositional change; generating a changed electronic communication from the audio-visual electronic communication and the compositional change; and providing the changed electronic communication.

In an embodiment, a system may include a server computer comprising a processor and a computer-readable storage device that stores instructions that, when executed by the processor, cause the processor to perform operations comprising: receiving an audio-visual electronic communication at an artificial intelligence assistant computing platform from a first user, the first user identified by a first electronic identifier, the audio-visual electronic communication comprising an audio communication content and a video communication content and comprising or associated with the first electronic identifier associated with the first user and a second electronic identifier associated with a second user, wherein the intended recipient of the audio-visual electronic communication is the second user; encoding the audio communication content for processing creating an encoded audio communication; extracting an audio communication information from the encoded audio communication content; encoding the video communication content for processing creating an encoded video communication; extracting a video communication information from the encoded video communication content; processing the audio-visual electronic communication with a processor to generate an audio-visual compositional change for the communication content of the audio-visual electronic communication using at least one of the audio communication content, the video communication content, audio communication information, video communication information, a sensor input from a wearable user device, a first user communication attribute retrieved from a communication profile for the first user using the first electronic identifier or a second user communication attribute retrieved from a communication profile for the second user using the second electronic identifier to generate the compositional change; generating a changed electronic communication from the audio-visual electronic communication and the compositional change; and providing the changed electronic communication.

In an embodiment, a system may include a server computer comprising a processor and a computer-readable storage device that stores instructions that, when executed by the processor, cause the processor to perform operations including: receiving an audio-visual electronic communication at an artificial intelligence assistant computing platform from a first user, the audio-visual electronic communication comprising an audio communication content and a video communication content, wherein the intended recipient of the audio-visual electronic communication is a second user; extracting an audio communication information from the audio communication content; extracting a video communication information from the video communication content; processing the audio-visual electronic communication with a processor to generate an audio-visual compositional change for the communication content of the audio-visual electronic communication using at least one of the audio communication content, the video communication content, audio communication information, video communication information, a sensor input from a wearable user device, a first user communication attribute retrieved from a communication profile for the first user or a second user communication attribute retrieved from a communication profile for the second user to generate the compositional change; generating a changed electronic communication from the audio-visual electronic communication and the compositional change; and providing the changed electronic communication.

In an embodiment, a method of electronic communication assistance may include: obtaining a copy of an in-transit audio-visual electronic communication at an artificial intelligence assistant computing platform from a first user, the first user identified by a first electronic identifier, the audio-visual electronic communication comprising an audio communication content and a video communication content and comprising or associated with the first electronic identifier associated with the first user and a second electronic identifier associated with a second user, wherein the intended recipient of the audio-visual electronic communication is the second user; encoding the audio communication content for processing creating an encoded audio communication; extracting an audio communication context from the encoded audio communication content; encoding the video communication content for processing creating an encoded video communication; extracting a video communication context from the encoded video communication content; processing the audio-visual electronic communication with a processor to generate a communication feedback related to the audio-visual electronic communication using at least one of the audio communication content, the video communication content, audio communication context, video communication context, a sensor input from a wearable device, a first user communication attribute retrieved from a communication profile for the first user using the first electronic identifier or a second user communication attribute retrieved from a communication profile for the second user using the second electronic identifier to generate the communication feedback, wherein the communication feedback provides communication information directed to the first user concerning the audio-visual communication; and providing the audio communication content and the communication feedback. In an embodiment, the communication feedback may be derived from representations of previous content and context from a plurality of user profiles stored in a communication profile database which are like at least one of the first communication profile or the second communication profile. The processor may be trained on large-scale data mixed with prior communication and effective communications from a plurality of user profiles. The processor may use at least one of a machine learning model, deep learning model, or statistical learning algorithm for creating the communication feedback. The processor may generate the communication feedback by optimizing generated language of the first user as determined by the processor from the first user communication attribute. The processor may generate the communication feedback by optimizing a next electronic communication with respect to the second user communication attribute. The audio-visual electronic communication may include a communication goal, and the processor may generate the communication feedback by optimizing in respect of the communication goal. The communication feedback may provide communication information directed to the first user concerning the audio-visual communication related to generating a next audio-visual communication. A textual representation of the audio-visual electronic communication may be provided within a graphical user interface on a screen of a wearable computing device worn by the first user and providing the audio communication content and the communication feedback on the screen.

In an embodiment, a method of electronic communication assistance may include: obtaining a copy of an in-transit audio-visual electronic communication at an artificial intelligence assistant computing platform from a first user, the audio-visual electronic communication comprising an audio communication content and a video communication content, wherein the intended recipient of the audio-visual electronic communication is a second user; extracting an audio communication context from the audio communication content; extracting a video communication context from the video communication content; processing the audio-visual electronic communication with a processor to generate a communication feedback related to the audio-visual electronic communication using at least one of the audio communication content, the video communication content, audio communication context, video communication context, a sensor input from a wearable device, a first user communication attribute retrieved from a communication profile for the first user or a second user communication attribute retrieved from a communication profile for the second user to generate the communication feedback, wherein the communication feedback provides communication information directed to the first user concerning the audio-visual communication; and providing the audio communication content and the communication feedback.

In an embodiment, a system may include a server computer comprising a processor and a computer-readable storage device that stores instructions that, when executed by the processor, cause the processor to perform operations including: obtaining a copy of an in-transit audio-visual electronic communication at an artificial intelligence assistant computing platform from a first user, the first user identified by a first electronic identifier, the audio-visual electronic communication comprising an audio communication content and a video communication content and comprising or associated with the first electronic identifier associated with the first user and a second electronic identifier associated with a second user, wherein the intended recipient of the audio-visual electronic communication is the second user; encoding the audio communication content for processing creating an encoded audio communication; extracting an audio communication context from the encoded audio communication content; encoding the video communication content for processing creating an encoded video communication; extracting a video communication context from the encoded video communication content; processing the audio-visual electronic communication with a processor to generate a communication feedback related to the audio-visual electronic communication using at least one of the audio communication content, the video communication content, audio communication context, video communication context, a sensor input from a wearable device, a first user communication attribute retrieved from a communication profile for the first user using the first electronic identifier or a second user communication attribute retrieved from a communication profile for the second user using the second electronic identifier to generate the communication feedback, wherein the communication feedback provides communication information directed to the first user concerning the audio-visual communication; and providing the audio communication content and the communication feedback.

In an embodiment, a system may include a server computer comprising a processor and a computer-readable storage device that stores instructions that, when executed by the processor, cause the processor to perform operations including: obtaining a copy of an in-transit audio-visual electronic communication at an artificial intelligence assistant computing platform from a first user, the audio-visual electronic communication comprising an audio communication content and a video communication content, wherein the intended recipient of the audio-visual electronic communication is a second user; extracting an audio communication context from the audio communication content; extracting a video communication context from the video communication content; processing the audio-visual electronic communication with a processor to generate a communication feedback related to the audio-visual electronic communication using at least one of the audio communication content, the video communication content, audio communication context, video communication context, a sensor input from a wearable device, a first user communication attribute retrieved from a communication profile for the first user or a second user communication attribute retrieved from a communication profile for the second user to generate the communication feedback, wherein the communication feedback provides communication information directed to the first user concerning the audio-visual communication; and providing the audio communication content and the communication feedback.

In an embodiment, a method of electronic communication assistance may include: obtaining a copy of an in-transit electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user and the second electronic identifier associated with the second user; extracting a communication context from the electronic communication; encoding the electronic communication for processing creating an encoded electronic communication; retrieving from a communication profile database a first communication profile for the first user utilizing the first electronic identifier, wherein the first communication profile comprises a first user communication attribute; retrieving from the communication profile database a second communication profile for the second user utilizing the second electronic identifier, wherein the second communication profile comprises a second user communication attribute; receiving electronic reaction data from a second electronic identifier of the second user, wherein the electronic reaction data is generated in response to the second user receiving the electronic communication; encoding the electronic reaction data for processing creating an encoded electronic reaction data; processing the encoded electronic communication and the encoded electronic reaction data to extract a reaction context with a processor to generate a response feedback communication using at least one of the communication content, the extracted communication context, the first user communication attribute, or the second user communication attribute; and sending the response feedback communication to the first electronic identifier.

In an embodiment, the response feedback communication may be derived at least in part from representations of previous electronic communications from a plurality of user profiles stored in the communication profile database which are like at least one of the first communication profile or the second communication profile. The processor may be trained on large-scale data mixed with prior communication and effective communications from the plurality of user profiles. The processor may utilize at least one of a machine learning language model or a statistical algorithm for creating the response feedback communication. The electronic communication may include a communication goal, and the processor generates the response feedback communication at least in part by computing and utilizing a reaction difference attribute derived from determined differences between the communication goal and the electronic reaction data. The electronic reaction data may include at least one of location information for the second user, response time between the second user receiving the electronic communication and reading the electronic communication, or an action taken by the second user. The reaction context may include an emotional state of the second user. The electronic reaction data may be used to generate at least one of an updated first communication profile or an updated second communication profile. At least one of the updated first communication profile or the updated second communication profile may be used to predict a most likely reaction outcome in a second electronic communication. The electronic reaction data may be used to train a machine learning model that is configured to at least one of generate a communication content or modify a communication content.

In an embodiment, a method of electronic communication assistance may include: obtaining a copy of an in-transit electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user; retrieving a first communication profile for the first user utilizing the first electronic identifier, wherein the first communication profile comprises a first user communication attribute; retrieving a second communication profile for the second user utilizing the second electronic identifier, wherein the second communication profile comprises a second user communication attribute; receiving electronic reaction data from a second electronic identifier of the second user, wherein the electronic reaction data is generated in response to the second user receiving the electronic communication; processing the electronic communication and the electronic reaction data to extract a reaction context with a processor to generate a response feedback communication using at least one of the communication content, the first user communication attribute, or the second user communication attribute; and sending the response feedback communication to the first electronic identifier.

In an embodiment, a method of electronic communication assistance may include: obtaining a copy of an in-transit electronic communication at an artificial intelligence assistant computing facility, wherein the electronic communication was transmitted from an electronic identifier associated with a user, the electronic communication comprising a communication content and comprising or associated with the electronic identifier associated with the user; extracting a communication context from the electronic communication; encoding the electronic communication for processing creating an encoded electronic communication; retrieving from a communication profile database a communication profile for the user utilizing the electronic identifier, wherein the communication profile comprises a user communication attribute; receiving electronic reaction data from a second electronic identifier of the second user, wherein the electronic reaction data is generated in response to the second user receiving the electronic communication; encoding the electronic reaction data for processing creating an encoded electronic reaction data; processing the encoded electronic communication and the encoded electronic reaction data to extract a reaction context with a processor to generate a response feedback communication using at least one of the communication content, the extracted communication context, or the user communication attribute; and sending the response feedback communication to the electronic identifier.

In an embodiment, a method of electronic communication assistance may include: obtaining a copy of an in-transit electronic communication at an artificial intelligence assistant computing facility, wherein the electronic communication was transmitted from an electronic identifier associated with a user, the electronic communication comprising a communication content and comprising or associated with the electronic identifier associated with the user; retrieving a communication profile for the user utilizing the electronic identifier, wherein the communication profile comprises a user communication attribute; receiving electronic reaction data from a second electronic identifier of the second user, wherein the electronic reaction data is generated in response to the second user receiving the electronic communication; processing the electronic communication and the electronic reaction data to extract a reaction context with a processor to generate a response feedback communication using at least one of the communication content or the user communication attribute; and sending the response feedback communication to the electronic identifier.

In an embodiment, a method of electronic communication assistance may include: obtaining a copy of an in-transit electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user; extracting a communication context from the electronic communication; encoding the electronic communication for processing creating an encoded electronic communication; retrieving from a communication profile database a communication profile for the second user utilizing the second electronic identifier, wherein the communication profile comprises a second user communication attribute; receiving electronic reaction data from a second electronic identifier of the second user, wherein the electronic reaction data is generated in response to the second user receiving the electronic communication; encoding the electronic reaction data for processing creating an encoded electronic reaction data; processing the encoded electronic communication and the encoded electronic reaction data to extract a reaction context with a processor to generate a response feedback communication using at least one of the communication content, the extracted communication context, or the second user communication attribute; and sending the response feedback communication to the first electronic identifier.

In an embodiment, a method of electronic communication assistance may include: obtaining a copy of an in-transit electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user; retrieving a communication profile for the second user utilizing the second electronic identifier, wherein the communication profile comprises a second user communication attribute; receiving electronic reaction data from a second electronic identifier of the second user, wherein the electronic reaction data is generated in response to the second user receiving the electronic communication; processing the electronic communication and the electronic reaction data to extract a reaction context with a processor to generate a response feedback communication using at least one of the communication content or the second user communication attribute; and sending the response feedback communication to the first electronic identifier.

In an embodiment, a system may include a server computer comprising a processor and a computer-readable storage device that stores instructions that, when executed by the processor, cause the processor to perform operations including: obtaining a copy of an in-transit electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user and the second electronic identifier associated with the second user; extracting a communication context from the electronic communication; encoding the electronic communication for processing creating an encoded electronic communication; retrieving from a communication profile database a first communication profile for the first user utilizing the first electronic identifier, wherein the first communication profile comprises a first user communication attribute; retrieving from the communication profile database a second communication profile for the second user utilizing the second electronic identifier, wherein the second communication profile comprises a second user communication attribute; receiving electronic reaction data from a second electronic identifier of the second user, wherein the electronic reaction data is generated in response to the second user receiving the electronic communication; encoding the electronic reaction data for processing creating an encoded electronic reaction data; processing the encoded electronic communication and the encoded electronic reaction data to extract a reaction context with a processor to generate a response feedback communication using at least one of the communication content, the extracted communication context, the first user communication attribute, or the second user communication attribute; and sending the response feedback communication to the first electronic identifier.

In an embodiment, a system may include a server computer comprising a processor and a computer-readable storage device that stores instructions that, when executed by the processor, cause the processor to perform operations including: obtaining a copy of an in-transit electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user; retrieving a first communication profile for the first user utilizing the first electronic identifier, wherein the first communication profile comprises a first user communication attribute; retrieving a second communication profile for the second user utilizing the second electronic identifier, wherein the second communication profile comprises a second user communication attribute; receiving electronic reaction data from a second electronic identifier of the second user, wherein the electronic reaction data is generated in response to the second user receiving the electronic communication; processing the electronic communication and the electronic reaction data to extract a reaction context with a processor to generate a response feedback communication using at least one of the communication content, the first user communication attribute, or the second user communication attribute; and sending the response feedback communication to the first electronic identifier.

In an embodiment, a system may include a server computer comprising a processor and a computer-readable storage device that stores instructions that, when executed by the processor, cause the processor to perform operations including: obtaining a copy of an in-transit electronic communication at an artificial intelligence assistant computing facility, wherein the electronic communication was transmitted from an electronic identifier associated with a user, the electronic communication comprising a communication content and comprising or associated with the electronic identifier associated with the user; extracting a communication context from the electronic communication; encoding the electronic communication for processing creating an encoded electronic communication; retrieving from a communication profile database a communication profile for the user utilizing the electronic identifier, wherein the communication profile comprises a user communication attribute; receiving electronic reaction data from a second electronic identifier of the second user, wherein the electronic reaction data is generated in response to the second user receiving the electronic communication; encoding the electronic reaction data for processing creating an encoded electronic reaction data; processing the encoded electronic communication and the encoded electronic reaction data to extract a reaction context with a processor to generate a response feedback communication using at least one of the communication content, the extracted communication context or the user communication attribute; and sending the response feedback communication to the electronic identifier.

In an embodiment, a system may include a server computer comprising a processor and a computer-readable storage device that stores instructions that, when executed by the processor, cause the processor to perform operations including: obtaining a copy of an in-transit electronic communication at an artificial intelligence assistant computing facility, wherein the electronic communication was transmitted from an electronic identifier associated with a user, the electronic communication comprising a communication content and comprising or associated with the electronic identifier associated with the user; retrieving from a communication profile database a communication profile for the user utilizing the electronic identifier, wherein the communication profile comprises a user communication attribute; receiving electronic reaction data from a second electronic identifier of the second user, wherein the electronic reaction data is generated in response to the second user receiving the electronic communication; processing the electronic communication and the electronic reaction data to extract a reaction context with a processor to generate a response feedback communication using at least one of the communication content, the extracted communication context or the user communication attribute; and sending the response feedback communication to the electronic identifier.

In an embodiment, a system may include a server computer comprising a processor and a computer-readable storage device that stores instructions that, when executed by the processor, cause the processor to perform operations including: obtaining a copy of an in-transit electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user; extracting a communication context from the electronic communication; encoding the electronic communication for processing creating an encoded electronic communication; retrieving from a communication profile database a communication profile for the second user utilizing the second electronic identifier, wherein the communication profile comprises a second user communication attribute; receiving electronic reaction data from a second electronic identifier of the second user, wherein the electronic reaction data is generated in response to the second user receiving the electronic communication; encoding the electronic reaction data for processing creating an encoded electronic reaction data; processing the encoded electronic communication and the encoded electronic reaction data to extract a reaction context with a processor to generate a response feedback communication using at least one of the communication content, the extracted communication context or the second user communication attribute; and sending the response feedback communication to the first electronic identifier.

In an embodiment, a system may include a server computer comprising a processor and a computer-readable storage device that stores instructions that, when executed by the processor, cause the processor to perform operations including: obtaining a copy of an in-transit electronic communication at an artificial intelligence assistant computing facility, wherein the electronic communication was transmitted from a first electronic identifier associated with a first user to a second electronic identifier associated with a second user, the electronic communication comprising a communication content and comprising or associated with the first electronic identifier associated with the first user; retrieving a communication profile for the second user utilizing the second electronic identifier, wherein the communication profile comprises a second user communication attribute; receiving electronic reaction data from a second electronic identifier of the second user, wherein the electronic reaction data is generated in response to the second user receiving the electronic communication; processing the electronic communication and the electronic reaction data to extract a reaction context with a processor to generate a response feedback communication using at least one of the communication content or the second user communication attribute; and sending the response feedback communication to the first electronic identifier.

In an embodiment, a computer-implemented method for modifying an incoming communication through a graphical user interface may include: intercepting a first electronic communication from further transmission at an artificial intelligence assistant computing facility, wherein the first electronic communication was transmitted from a first electronic identifier associated with a first user to a second electronic identifier associated with a second user, the first electronic communication comprising a communication content and comprising or associated with the first electronic identifier associated with the first user; encoding the first electronic communication for processing creating an encoded first electronic communication; retrieving from a communication profile database a second communication profile for the second user using the second electronic identifier, wherein the second communication profile comprises a second user communication attribute that identifies a receiving communication preference; processing the encoded first electronic communication with a processor; displaying the first electronic communication within a graphical user interface on a screen of a computing device of the second user, wherein the displaying the first electronic communication comprises displaying the communication content and displaying a communication transformation query directed to the second user to determine if the first electronic communication should be transformed; receiving a communication transformation indication from the computing device that directs the processor to transform the first electronic communication to a modified electronic communication that is a modified version of the first electronic communication, wherein the processor uses the communication content and the second user communication attribute to transform the first electronic communication; and displaying the modified electronic communication within the graphical user interface on the screen of the computing device.

In an embodiment, the processor may transform the first electronic communication by removing language from the first electronic communication based at least in part on the second user communication attribute. The removed language may be offensive language. The processor may transform the first electronic communication by summarizing language from the first electronic communication based at least in part on the second user communication attribute. The processor may transform the first electronic communication by reformatting the first electronic communication based at least in part on the second user communication attribute. The processor may transform the first electronic communication by recomposing language from the first electronic communication based at least in part on the second user communication attribute. The processor may transform the first electronic communication by incorporating explanatory text associated with phases based at least in part on the second user communication attribute. The processor may transform the first electronic communication derived at least in part from representations of previous electronic communications from a plurality of user profiles stored in the communication profile database which are like the second communication profile. The processor may be trained on large-scale data mixed with prior communication and effective communications from the plurality of user profiles. The processor may use at least one of a machine learning language model or a statistical algorithm to transform the first electronic communication. The transformed first electronic communication may be used to generate an updated second communication profile. The updated second communication profile may be used to predict a most likely modification outcome in a second electronic communication. Transformation data may be extracted from the transformation to the first electronic communication, wherein the transformation data is used to train a language model used by the processor.

In an embodiment, a computer-implemented method for modifying a transmitted communication through a graphical user interface may include: intercepting a first electronic communication from further transmission at an artificial intelligence assistant computing facility, wherein the first electronic communication was transmitted from a first electronic identifier associated with a first user to a second electronic identifier associated with a second user, the first electronic communication comprising a communication content and comprising or associated with the first electronic identifier associated with the first user; encoding the first electronic communication for processing creating an encoded first electronic communication; retrieving from a communication profile database a second communication profile for the second user using the second electronic identifier, wherein the second communication profile comprises a second user communication attribute that identifies a receiving communication preference; processing the encoded first electronic communication with a processor; displaying the first electronic communication within a graphical user interface on a screen of a computing device of the first user, wherein the displaying the first electronic communication comprises displaying the communication content and displaying a communication transformation query directed to the first user to determine if the first electronic communication should be transformed and resent; receiving a communication transformation indication from the computing device that directs the processor to transform the first electronic communication to a modified electronic communication that is a modified version of the first electronic communication, wherein the processor uses the communication content and the second user communication attribute to transform the first electronic communication; and transmitting the modified electronic communication to the second electronic identifier.

In an embodiment, the processor may transform the first electronic communication derived at least in part from representations of previous electronic communications from a plurality of user profiles stored in the communication profile database which are like the second communication profile. The processor may be trained on large-scale data mixed with prior communication and effective communications from the plurality of user profiles. The processor may use at least one of a machine learning language model or a statistical algorithm to transform the first electronic communication. The transformed first electronic communication may be used to generate an updated second communication profile. The updated second communication profile may be used to predict a most likely modification outcome in a second electronic communication. Transformation data may be extracted from the transformation to the first electronic communication, wherein the transformation data is used to train a language model used by the processor.

In an embodiment, a computer-implemented method for modifying a transmitted communication through a graphical user interface may include: intercepting a first electronic communication from further transmission at an artificial intelligence assistant computing facility wherein, the first electronic communication was transmitted from a first electronic identifier associated with a first user to a second electronic identifier associated with a second user, the electronic communication comprising a communication content and comprising or associated with the first electronic identifier associated with the first user; retrieving a communication profile for a user using the second electronic identifier, wherein the communication profile comprises a second user communication attribute that identifies a receiving communication preference; processing the first electronic communication with a processor; displaying the first electronic communication within a graphical user interface on a screen of a second computing device of the second user; displaying a communication transformation query directed to the second user; receiving a communication transformation indication from a first computing device of the first user that directs the processor to transform the electronic communication to a modified electronic communication; and displaying the modified electronic communication within the graphical user interface on the screen of the second computing device.

In an embodiment, a computer-implemented method for modifying a transmitted communication through a graphical user interface may include: intercepting a first electronic communication from further transmission at an artificial intelligence assistant computing facility, wherein the first electronic communication was transmitted from a first electronic identifier associated with a first user to a second electronic identifier associated with a second user, the first electronic communication comprising a communication content and comprising or associated with the first electronic identifier associated with the first user; retrieving a communication profile for the second user using the second electronic identifier, wherein the communication profile comprises a second user communication attribute that identifies a receiving communication preference; processing the first electronic communication with a processor; displaying the first electronic communication within a graphical user interface on a screen of a computing device of the first user; displaying a communication transformation query directed to the first user to determine if the first electronic communication should be transformed and resent; receiving a communication transformation indication from the computing device that directs the processor to transform the first electronic communication to a modified electronic communication; and transmitting the modified electronic communication to the second electronic identifier.

In an embodiment, a system may include a server computer comprising a processor and a computer-readable storage device that stores instructions that, when executed by the processor, cause the processor to perform operations including: intercepting a first electronic communication from further transmission at an artificial intelligence assistant computing facility, wherein the first electronic communication was transmitted from a first electronic identifier associated with a first user to a second electronic identifier associated with a second user, the first electronic communication comprising a communication content and comprising or associated with the first electronic identifier associated with the first user; encoding the first electronic communication for processing creating an encoded first electronic communication; retrieving from a communication profile database a second communication profile for the second user using the second electronic identifier, wherein the second communication profile comprises a second user communication attribute that identifies a receiving communication preference; processing the encoded first electronic communication with a processor; displaying the first electronic communication within a graphical user interface on a screen of a computing device of the second user, wherein the displaying the first electronic communication comprises displaying the communication content and displaying a communication transformation query directed to the second user to determine if the first electronic communication should be transformed; receiving a communication transformation indication from the computing device that directs the processor to transform the first electronic communication to a modified electronic communication that is a modified version of the first electronic communication, wherein the processor uses the communication content and the second user communication attribute to transform the first electronic communication; and displaying the modified electronic communication within the graphical user interface on the screen of the computing device.

In an embodiment, a system may include a server computer comprising a processor and a computer-readable storage device that stores instructions that, when executed by the processor, cause the processor to perform operations including: intercepting a first electronic communication from further transmission at an artificial intelligence assistant computing facility, wherein the first electronic communication was transmitted from a first electronic identifier associated with a first user to a second electronic identifier associated with a second user, the first electronic communication comprising a communication content and comprising or associated with the first electronic identifier associated with the first user; encoding the first electronic communication for processing creating an encoded first electronic communication; retrieving from a communication profile database a second communication profile for the second user using the second electronic identifier, wherein the second communication profile comprises a second user communication attribute that identifies a receiving communication preference; processing the encoded first electronic communication with a processor; displaying the first electronic communication within a graphical user interface on a screen of a computing device of the first user, wherein the displaying the first electronic communication comprises displaying the communication content and displaying a communication transformation query directed to the first user to determine if the first electronic communication should be transformed and resent; receiving a communication transformation indication from the computing device that directs the processor to transform the first electronic communication to a modified electronic communication that is a modified version of the first electronic communication, wherein the processor uses the communication content and the second user communication attribute to transform the first electronic communication; and transmitting the modified electronic communication to the second electronic identifier.

In an embodiment, a system may include a server computer comprising a processor and a computer-readable storage device that stores instructions that, when executed by the processor, cause the processor to perform operations including: intercepting a first electronic communication from further transmission at an artificial intelligence assistant computing facility, wherein the first electronic communication was transmitted from a first electronic identifier associated with a first user to a second electronic identifier associated with a second user, the first electronic communication comprising a communication content and comprising or associated with the first electronic identifier associated with the first user; retrieving from a communication profile database a communication profile for the second user using the second electronic identifier, wherein the communication profile comprises a second user communication attribute that identifies a receiving communication preference; processing the first electronic communication with a processor; displaying the first electronic communication within a graphical user interface on a screen of a second computing device of the second user; displaying a communication transformation query directed to the second user; receiving a communication transformation indication from a first computing device of the first user that directs the processor to transform the first electronic communication to a modified electronic communication; and displaying the modified electronic communication within the graphical user interface on the screen of the second computing device.

In an embodiment, a system may include a server computer comprising a processor and a computer-readable storage device that stores instructions that, when executed by the processor, cause the processor to perform operations including: intercepting a first electronic communication from further transmission at an artificial intelligence assistant computing facility, wherein the first electronic communication was transmitted from a first electronic identifier associated with a first user to a second electronic identifier associated with a second user, the first electronic communication comprising a communication content and comprising or associated with the first electronic identifier associated with the first user; retrieving a communication profile for the second user using the second electronic identifier, wherein the communication profile comprises a second user communication attribute that identifies a receiving communication preference; processing the first electronic communication with a processor; displaying the first electronic communication within a graphical user interface on a screen of a computing device of the first user; displaying a communication transformation query directed to the first user to determine if the first electronic communication should be transformed and resent; receiving a communication transformation indication from the computing device that directs the processor to transform the first electronic communication to a modified electronic communication; and transmitting the modified electronic communication to the second electronic identifier.

In an embodiment, a computer-implemented method for modifying an incoming communication through a graphical user interface may include: receiving a first electronic communication at an artificial intelligence assistant computing facility, wherein the first electronic communication is associated with a first electronic identifier associated with a first user and directed to a second electronic identifier associated with a second user, the first electronic communication comprising a communication content and comprising or associated with the first electronic identifier associated with the first user; encoding the first electronic communication for processing creating an encoded first electronic communication; retrieving from a communication profile database a second communication profile for the second user using the second electronic identifier, wherein the second communication profile comprises a second user communication attribute that identifies a receiving communication preference; processing the encoded first electronic communication with a processor; presenting the first electronic communication through an electronic communication link within a graphical user interface on a screen of a computing device of the second user, wherein the first electronic communication comprises displaying the communication content and displaying a communication transformation query directed to the second user to determine if the first electronic communication should be transformed; receiving a communication transformation indication from the computing device that directs the processor to transform the first electronic communication to a modified electronic communication that is a modified version of the first electronic communication, wherein the processor uses the communication content and the second user communication attribute to transform the first electronic communication; and presenting the modified electronic communication through the electronic communication link within the graphical user interface on the screen of the computing device of the second user.

In an embodiment, a computer-implemented method for modifying an incoming communication through a graphical user interface may include: receiving a first electronic communication at an artificial intelligence assistant computing facility, wherein the first electronic communication is associated with a first electronic identifier associated with a first user to a second electronic identifier associated with a second user, the first electronic communication comprising a communication content and comprising or associated with the first electronic identifier associated with the first user; encoding the first electronic communication for processing creating an encoded first electronic communication; retrieving from a communication profile database a second communication profile for the second user using the second electronic identifier, wherein the second communication profile comprises a second user communication attribute that identifies a receiving communication preference; processing the encoded first electronic communication with a processor; presenting the first electronic communication through an electronic communication link within a graphical user interface on a screen of a computing device of the first user, wherein the first electronic communication comprises displaying the communication content and displaying a communication transformation query directed to the first user to determine if the first electronic communication should be transformed and resent; receiving a communication transformation indication from the computing device of the first user that directs the processor to transform the first electronic communication to a modified electronic communication that is a modified version of the first electronic communication, wherein the processor uses at least one of input from the first user, the communication content, or the second user communication attribute to transform the first electronic communication; and presenting the modified electronic communication through the electronic communication link to the second electronic identifier.

In an embodiment, a computer-implemented method for modifying an incoming communication through a graphical user interface may include: receiving a first electronic communication at an artificial intelligence assistant computing facility, wherein the first electronic communication is associated with a first electronic identifier associated with a first user and directed to a second electronic identifier associated with a second user, the first electronic communication comprising a communication content and comprising or associated with the first electronic identifier associated with the first user; encoding the first electronic communication for processing creating an encoded first electronic communication; retrieving from a communication profile database a second communication profile for the second user using the second electronic identifier; processing the encoded first electronic communication with a processor; presenting the first electronic communication through an electronic communication link within a graphical user interface on a screen of a computing device of the second user; receiving a communication transformation indication from the computing device that directs the processor to transform the first electronic communication to a modified electronic communication that is a modified version of the first electronic communication; and presenting the modified electronic communication through the electronic communication link within the graphical user interface on the screen of the computing device of the second user.

In an embodiment, a computer-implemented method for modifying an incoming communication through a graphical user interface may include: receiving a first electronic communication at an artificial intelligence assistant computing facility, wherein the first electronic communication is associated with a first electronic identifier associated with a first user to a second electronic identifier associated with a second user, the first electronic communication comprising a communication content and comprising or associated with the first electronic identifier associated with the first user; retrieving a second communication profile for the second user using the second electronic identifier, wherein the second communication profile comprises a second user communication attribute that identifies a receiving communication preference; processing the first electronic communication with a processor; presenting the first electronic communication through an electronic communication link within a graphical user interface on a screen of a computing device of the first user; receiving a communication transformation indication from the computing device of the first user that directs the processor to transform the first electronic communication to a modified electronic communication that is a modified version of the first electronic communication; and presenting the modified electronic communication through the electronic communication link to the second electronic identifier.

In an embodiment, a system may include a server computer comprising a processor and a computer-readable storage device that stores instructions that, when executed by the processor, cause the processor to perform operations including: receiving a first electronic communication at an artificial intelligence assistant computing facility, wherein the first electronic communication is associated with a first electronic identifier associated with a first user and directed to a second electronic identifier associated with a second user, the first electronic communication comprising a communication content and comprising or associated with the first electronic identifier associated with the first user; encoding the first electronic communication for processing creating an encoded first electronic communication; retrieving from a communication profile database a second communication profile for the second user using the second electronic identifier, wherein the second communication profile comprises a second user communication attribute that identifies a receiving communication preference; processing the encoded first electronic communication with a processor; presenting the first electronic communication through an electronic communication link within a graphical user interface on a screen of a computing device of the second user, wherein the first electronic communication comprises displaying the communication content and displaying a communication transformation query directed to the second user to determine if the first electronic communication should be transformed; receiving a communication transformation indication from the computing device that directs the processor to transform the first electronic communication to a modified electronic communication that is a modified version of the first electronic communication, wherein the processor uses the communication content and the second user communication attribute to transform the first electronic communication; and presenting the modified electronic communication through the electronic communication link within the graphical user interface on the screen of the computing device of the second user.

In an embodiment, a system may include a server computer comprising a processor and a computer-readable storage device that stores instructions that, when executed by the processor, cause the processor to perform operations including: receiving a first electronic communication at an artificial intelligence assistant computing facility, wherein the first electronic communication is associated with a first electronic identifier associated with a first user to a second electronic identifier associated with a second user, the first electronic communication comprising a communication content and comprising or associated with the first electronic identifier associated with the first user; encoding the first electronic communication for processing creating an encoded first electronic communication; retrieving from a communication profile database a second communication profile for the second user using the second electronic identifier, wherein the second communication profile comprises a second user communication attribute that identifies a receiving communication preference; processing the encoded first electronic communication with a processor; presenting the first electronic communication through an electronic communication link within a graphical user interface on a screen of a computing device of the first user, wherein the first electronic communication comprises displaying the communication content and displaying a communication transformation query directed to the first user to determine if the first electronic communication should be transformed and resent; receiving a communication transformation indication from the computing device of the first user that directs the processor to transform the first electronic communication to a modified electronic communication that is a modified version of the first electronic communication, wherein the processor uses at least one of input from the first user, the communication content, or the second user communication attribute to transform the first electronic communication; and presenting the modified electronic communication through the electronic communication link to the second electronic identifier.

In an embodiment, a system may include a server computer comprising a processor and a computer-readable storage device that stores instructions that, when executed by the processor, cause the processor to perform operations including: receiving a first electronic communication at an artificial intelligence assistant computing facility, wherein the first electronic communication is associated with a first electronic identifier associated with a first user and directed to a second electronic identifier associated with a second user, the first electronic communication comprising a communication content and comprising or associated with the first electronic identifier associated with the first user; encoding the first electronic communication for processing creating an encoded first electronic communication; retrieving from a communication profile database a second communication profile for the second user using the second electronic identifier; processing the encoded first electronic communication with a processor; presenting the first electronic communication through an electronic communication link within a graphical user interface on a screen of a computing device of the second user; receiving a communication transformation indication from the computing device that directs the processor to transform the first electronic communication to a modified electronic communication that is a modified version of the first electronic communication; and presenting the modified electronic communication through the electronic communication link within the graphical user interface on the screen of the computing device of the second user.

In an embodiment, a system may include a server computer comprising a processor and a computer-readable storage device that stores instructions that, when executed by the processor, cause the processor to perform operations including: receiving a first electronic communication at an artificial intelligence assistant computing facility, wherein the first electronic communication is associated with a first electronic identifier associated with a first user to a second electronic identifier associated with a second user, the first electronic communication comprising a communication content and comprising or associated with the first electronic identifier associated with the first user; retrieving a second communication profile for the second user using the second electronic identifier, wherein the second communication profile comprises a second user communication attribute that identifies a receiving communication preference; processing the first electronic communication with a processor; presenting the first electronic communication through an electronic communication link within a graphical user interface on a screen of a computing device of the first user; receiving a communication transformation indication from the computing device of the first user that directs the processor to transform the first electronic communication to a modified electronic communication that is a modified version of the first electronic communication; and presenting the modified electronic communication through the electronic communication link to the second electronic identifier.

Further, various embodiments discussed herein encompass the subject matter of the following numbered clauses:

1. A computer-implemented method includes: determining embeddings for tokens of request data using a machine learning model (MML); accessing text embeddings associated with texts of digital documents, the text embeddings generated by the MML; using K-nearest neighbor method (KNN) performing a search over the text embeddings by comparing the text embeddings with the embeddings for the tokens to identify target text embeddings; obtaining request-related documents corresponding to the target text embedding; generating a prompt comprising the request data and prompt-associated context obtained from the request-related documents; communicating programmatically the prompt to a large language model (LLM); and receiving an output from the LLM.

2. The computer-implemented method of clause 1, further comprising formatting the received output from the LLM based on a template.

3. The computer-implemented method of clause 1, further comprising: parsing the request data into the tokens; identifying a knowledge-shared term corresponding to at least one of the tokens by comparing the tokens with a list of knowledge shared terms; and retrieving from a data storage at least one of documents corresponding to the knowledge-shared term.

4. The computer-implemented method of clause 1, wherein the request data comprises: a query from a client device; and a request-related context, the request-related context comprising at least one of: data from an email thread, text data, or session information.

5. The computer-implemented method of clause 4, wherein the request-related context is included as a part of the prompt-associated context.

6. The computer-implemented method of clause 4, further comprising: receiving an action to perform based on information available in the prompt; in response to receiving the action generating a new context; and merging the prompt-associated context and the new context to obtain a new prompt, the new prompt comprising the request data and new prompt-associated context.

7. The computer-implemented method of clause 6, wherein the action comprises summarizing a text within the prompt-associated context.

8. The computer-implemented method of clause 6, wherein the LLM comprises a first LLM, the action comprises: transmitting a request to a second LLM to rewrite text data from the prompt-associated context based on a decorator, and wherein the generating the new context includes receiving an output from the second LLM.

9. The computer-implemented method of clause 8, wherein the decorator comprises elements or structures added to the prompt to enhance, modify, or contextualize the prompt.

10. The computer-implemented method of clause 9, wherein the decorator is an adjective describing a tone or a style of a text.

11. The computer-implemented method of clause 6, wherein the action comprises requesting to provide examples for a set of features described in the prompt.

12. The computer-implemented method of clause 1, further comprising: generating a report based on the prompt-associated context; receiving an action, in response to the generated report; and retrieving new request-related documents based on the received action.

13. The computer-implemented method of clause 12, wherein the received action comprises a click onto a link presented within the generated report.

14. The computer-implemented method of clause 1, wherein the text embeddings are generated from table of contents of the digital documents.

15. The computer-implemented method of clause 1, further comprising: parsing the request data into the tokens; and performing a keyword-based search to identify the digital documents.

16. The computer-implemented method of clause 1, wherein the prompt-associated context obtained from the request-related documents comprises entire texts from the request-related documents.

17. The computer-implemented method of clause 1, wherein obtaining the prompt-associated context comprises for a document of the request-related documents: using the KNN method performing a search within document's text embeddings by comparing the document's text embeddings with the embeddings for the tokens to identify target document's text embeddings; obtaining sections of the document corresponding to associated target document's text embeddings; and appending the obtained sections to the prompt-associated context.

18. The computer-implemented method of clause 1, further comprising: determining a measure of relevance of a document from the request-related documents to the request data; and preventing generation of the prompt-associated context for the document when the measure of relevance is below a target threshold.

19. The computer-implemented method of clause 18, wherein the measure of relevance for the document is determined based on a KNN distance between a first vector representing embeddings for the tokens and a second vector representing text embeddings for that document.

20. The computer-implemented method of clause 1, further comprising: receiving a template prompt having at least one placeholder; and replacing the at least one placeholder with at least one of the request data or the prompt-associated context.

21. The computer-implemented method of clause 20, wherein the template prompt comprises a plurality of placeholders, wherein one of the plurality of placeholders is replaced with a query associated with the request data, and another one of the plurality of placeholders is replaced with the prompt-associated context.

22. The computer-implemented method of clause 1, further comprising: providing an interface for receiving actions related to one or more terms; and receiving an action via the interface causing the search over the text embeddings related to the one or more terms to not be performed.

23. The computer-implemented method of clause 22, wherein the interface comprises graphical user interface, and wherein the action includes at least clicking on the one or more terms.

24. The computer-implemented method of clause 23 wherein the interface is configured to display: a list of request related documents; and the output from the LLM.

25. The computer-implemented method of clause 1, wherein the determining embeddings for a token of the request data corresponding to a knowledge shared term comprises: accessing embeddings for tokens associated with at least one of documents related to the knowledge sharing term; and determining an aggregated embedding for the accessed embeddings.

26. The computer-implemented method of clause 25, wherein the determining the aggregated embedding for the accessed embeddings comprises averaging the accessed embeddings.

In any system or method embodiments described herein, the system or method may further include any of the described features, such as, but not limited to, transmitting the changed electronic communication to the first electronic identifier associated with the first user, and/or transmitting the changed electronic communication to the second electronic identifier associated with the second user. The compositional change may be derived from representations of previous content and context from a plurality of user profiles stored in the communication profile database which are like at least one of the first communication profile or the second communication profile. The processor may be trained on large-scale data mixed with prior communication and effective communications from the plurality of user profiles. The processor may use at least one of a machine learning model, deep learning model, or other statistical learning algorithm for creating the compositional change. The compositional change may be an auto-generated textual completion; the auto-generated textual completion may be a phrasal completion, and the processor may generate the compositional change by optimizing generated language as determined by the processor from the second user communication attribute. The processor may generate the compositional change by replicating a communication style of the first user as determined by the processor from the first user communication attribute. The partial electronic communication may include a communication goal, and the processor may generate the compositional change by optimizing for impact and effectiveness of generated language with respect to the communication goal. The processor may generate the compositional change further using a communication template selected from a plurality of communication templates comprising at least one of prepared text or placeholder locations for defining structural elements for user completion. The processor may select the communication template using at least one of a machine learning model, deep learning model, or statistical learning model to find a most effective communication template based at least in part on the communication content. The plurality of communication templates may include at least one automatically generated template generated by the processor. The processor may select the communication template by using a machine learning model, deep learning model, or statistical learning algorithm to score the plurality of communication templates based at least in part on the communication content, communication context, first user communication attribute, or second user communication attribute, communication context, first user communication attribute, or second user communication attribute.

### 2. Structural & Functional Overview

### 2.1 Artificial Intelligence Assistant

Effective communication requires much more than corrections to spelling and grammar. It requires attention to the audience of the communication as well as to context surrounding the conversation. Therefore, to increase the effectiveness of communications, a writing assistant needs to incorporate an intelligent facility. The present disclosure describes an artificial intelligence assistant (AIA), which can utilize information about the participants and the surrounding context and other environments to generate more effective communications. The AIA thus provides a valuable facility to users in communication amongst a diverse population.

A communication may be understood to be a communicative act between entities, such as between a user as a sender and a user as a receiver, where there is content and context associated with the communication. Although embodiments herein describe communications between two users, such as from a user as a sender and a second user as a receiver, communications described herein should also be understood to encompass embodiments where communications are sent from a user or group or audience, published from a user to a group or audience (for example, where something is not sent directly but published or posted online, such as including when it may visible to anybody but is intended and/or optimized for a specific audience), between a group of user senders (for example, sharing the creation of a communication) and a user receiver, and between multiple users and a group or audience. Users may also be administrators or other individuals that provide services for another user (for example, administrating or aiding in communications of individuals, helping to create and maintain user profiles, and the like). Users may also be a computing entity, such as computing platform, a software agent, a bot, an online page, a webpage, and the like. Users have certain goals, intentions and meaning that they try to convey through content. A user's ability to express those in content accurately and in a way that a specific receiver or audience would understand is limited, and receivers perceive the content with distortions and can react to it in different ways (for example, actions, inactions, responses, emotions, conclusions, and the like). Receivers' ability to recover the meaning intended by the user is limited. Content can be classified into communication types and can take different formats and forms. A larger context may include the use case, user intents and goals, the environment (for example, communication channel, platform, conditions, and the like), the current state of the parties (for example, availability, emotional state, or physical state, such as whether they're a hurry, in commute, on vacation, under stress, tired, happy, upset, and the like), implicit or unconscious signals (for example, tone, pauses, and the like), prior communication history (for example, previous communications in the same thread, previous threads involving the same users, and the like), knowledge of the parties (for example, who they are, their schedules, and the like), general world knowledge (for example, recent news, public facts, and the like), and the like.

The AIA may have access to user information through a user communication profile (for example, knowledge of the user), receiver communication profile (for example knowledge of the receiver(s), group profiles, and/or target audience profiles, where profiles may include information pertaining to professional vs. informal communication styles, communication preferences, native language, emotional characteristics, and the like), goals (for example, knowledge of what the user wants to accomplish, and the like), communication history (for example, prior communication (for example, email thread, conversation, and the like), shared documents, current state of user (for example, emotions, focused or distracted, and the like), relationship between them, environment (for example, home, office, or commute, and the like), past communications, shared context (for example, current news, pop culture, and the like), individual context (for example, vocabulary, emotions, and the like), modes of communication (for example, email history, digital history, or chats), survey information, and the like), reactions to previous or similar communications, world knowledge (for example, concepts and relations, logic, facts, current news and events, pop culture, and the like), modality (for example, communications channels available, such as email, texting, voice, video, augmented reality, virtual reality, and the like), may be utilized to modify a user's communication, either directly (for example, making or providing explicit options for changes to a communication) or indirectly (for example, prompting the user for ways to improve the communication). Although the present disclosure applies the AIA to improvements of a user's communication, the AIA may similarly be applied to improving a receiver's communications, such as re-writing incoming communications for them in a way that they prefer or understand.

The AIA may help to optimize a communication for a specific receiver or group of receivers, assist in a real-time conversation, support multiple modalities of language and communication, be adaptive to individual users, learn over time based on how participants communicate, and the like. The AIA may be continuously updated, have access and insights about individuals and groups that a user has never communicated with, and can perform in real-time. The AIA, with access to a wide range of continuously updated data and modeled communication behavior, may be enabled with an automated means of determining the perception and predicting the reaction of a receiver, where the system can learn the patterns it observes in the interactions between participants to predict how a specific communication will be perceived and reacted to. In an embodiment, prediction of the perception and reaction of a receiver may be enabled through models of language effectiveness and/or impact, as described herein, including general, group-domain specific, and receiver-specific modeling, such as trained on a corpus of previously observed communications and reactions.

The AIA may suggest changes related to communication structure, language, style, and the like, that relate to a specific receiver, group of receivers, or broad audience. The AIA may suggest recomposing or rewriting a communication based on a goal, context, communication style of a user, prior communication that achieved similar goals and effects, and the like, such as stored in a user communication profile. The AIA may assist during a real-time dialog, such as on a display of a computing device while a conversation is ongoing (for example, displaying feedback to the user during a texting exchange, providing audio prompting (for example, via a speaker in the user's ear), providing haptic feedback during a conversation on a smartphone or augmented reality glasses, and the like). In an embodiment, the AIA may be able to provide iterative real-time feedback that is visible to the user as a sender but not to the receiver, taking the reaction to the previous communication as additional input.

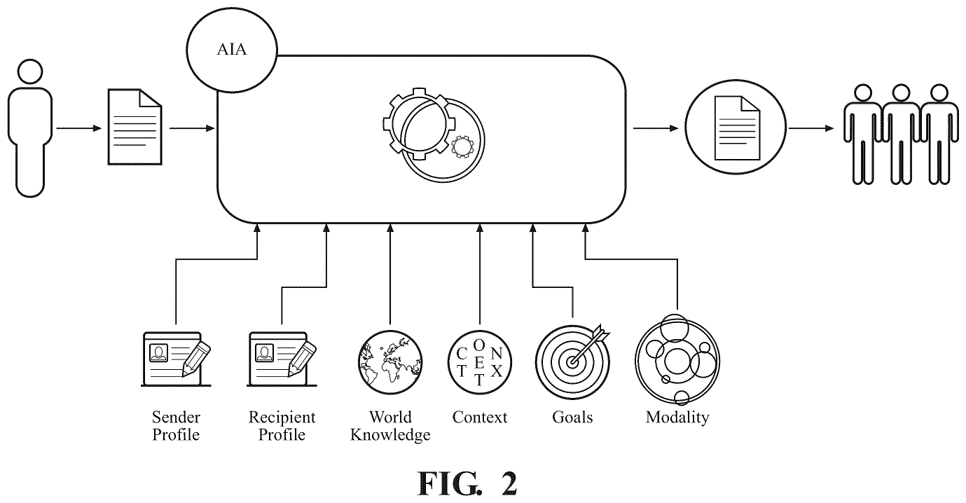

FIG. 2 illustrates an AIA communication system model, where a user generates a communication as an input to the AIA, such as a written electronic text (for example, email, text message, document, and the like), voice communication (for example, voice input to a telecommunications system), and the like. The AIA receives and processes the communication input with respect to a user communication profile, receiver communication profile, goals, context, world knowledge, and modality, and generates an output in the form of a modified communication or feedback to the user that is directed at optimizing the effectiveness, clarity, and correctness of the communication. Input and training data to the system may also consider the current communication (for example, a draft communication), revisions of communications, targets for a communication (for example, goal, intended impact, audience, desired style, and the like), ‘lookalike’ communications (for example, similar communications between similar parties in the past that are predictive to the current communication, and the like), context (for example, domain, topic, type of communication, prior communication history, user emotional state, and the like), user's communication profile (for example, user's preferred style, user's vocabulary, user's proficiency, and the like), receiver's communication profile, relationship between users, communication constraints (for example, time, length, medium, and the like), world knowledge, domain knowledge, shared documents between users, reaction to previous communication (for example, textual response, verbal response, video recorded body language (for example, posture), and the like), geography with respect to language (for example, different spellings, different idioms, and the like) and usage combined with geography to determine a language variation (for example, U.S. vs. Australia or dialect (for example, different regions within a country)), geography with respect to context (for example, service representative providing feedback to a customer with respect to geography to incorporate ‘relatedness’ into a communication), information from wearable devices (for example, biosensors, cameras, microphones, and the like), and the like.

The AIA may utilize user communication profiles in the process of optimizing a communication, where communication profiles contain properties and communication preferences of users. A communication profile may be described as a set of characteristics, traits, features, and the like that can be used to characterize and represent an individual either independently or to cluster them as part of a larger cohort. Communication profiles may be records consisting of at least one property expressing characteristics related to communication, such as language proficiency, vocabulary, style, topics, preferences, reactions, behavior, and the like. Communication profiles may change over time (for example, with respect to vocabulary, language proficiency, triggers, interaction preferences, and the like). A communication profile of a person can be learned and updated by analyzing their outgoing communication and reactions to incoming communication, asking them questions, having them fill in some of the profile properties, using communication profiles of similar users as an approximation, and the like. Communication profiles of groups of users or larger audiences can be formed by aggregating individual profiles or getting statistics on communication with a certain group/audience.

Profiles may be associated with certain communication parties (for example, entities that can be senders or receivers). These may be individuals, clusters of individuals with similar socio-demographic or psychological properties, clusters of individuals with similar communication profile properties (for example, similar vocabulary, topics, style, communication preferences, behavior, and the like), groups of connected individuals (for example, coworkers within one team sharing a certain context), larger populations (for example, children audience, non-native English speakers, clusters of individuals with similar socio-demographic or psychological properties, clusters of individuals with similar communication profiles, groups of connected individuals (for example, teams), audiences/audience types, and the like). Communication profiles may contain records. Records of communication parties may include their socio-demographic and psychological properties, descriptions and properties that define or unify a group, and the like. Individuals may belong to multiple clusters, groups, and audiences, such as native English speakers, IT professionals, teenagers, certain geographies, and the like. Individuals may be connected as a graph with links denoting familiarity level and types of relationships. Familiarity may be initiated and updated based on the frequency of observed communication and its tone, among other signals. Relationship may be specified by users or inferred by the AIA from observed communication between them.

Profiles may include properties such as language proficiency level, native language, characteristics of the party's communication such as vocabulary (for example, word lists with frequencies) and frequently used phrases (for example, word and phrase frequency counters updated on each communication session processed by the system by extracting most frequent collocations and language patterns), other characteristics of writing/speech, such as style, structure (for example, including vector representation of a sample of writing, individual language models, frequency counters on different aspects of style, structure, tone, and the like), topics (for example, list of topics with frequency counters updated on each communication session processed and/or classified by the system), negative and positive triggers (for example, specified by the user or inferred from observed reactions), communication behaviors and preferences (for example, activity hours, time to respond, communication channels, low-context vs. high-context, verbose vs. concise, emotions vs. facts, format (for example, plain-rich, short-long, bullets-prose, and the like), and the like. Triggers may be communication elements or characteristics (for example, words, phrases, errors, topics, formatting, and the like) that an individual or members of a group consistently like or dislike. Triggers may cause strong emotions. Negative triggers carry the risk of tension or conflicts in communication.

The AIA may learn communication properties directly from a user (for example, through surveys, prompts to fill in properties, or state preferences), by observing and analyzing their communication, and by analyzing/processing their reactions to incoming communications. For instance, communication parties may inherit the properties of groups or audiences to which they belong. Properties of more granular parties may override the equivalent properties of (for example, larger) groups or audiences. Communication profiles may include reaction data, such as in a corpus of communications and documents (for example, original or vector representations) and the corresponding reactions from different communication parties (for example, used to train AIA to predict reactions of a receiver). Profiles may be initialized with user input through surveys, iterative questions, analyzing records of prior communication, and the like. In an embodiment, communication profiles of the receivers who do not have an existing communication profile in the system (for example, not a registered user of AIA) may have a communication profile generated in runtime and not stored persistently or stored in de-identified clusters.

Data sources for communication profiles may include results of researching characteristics of certain populations, user surveys, explicitly stated user preference (for example, filled-in part of the profile), observed outgoing communication (for example, sampling aggregated representation, data extracted through analysis/inference, observed communication behavior (for example, schedule, channels, and the like), observed reactions to incoming communications (for example, responses, actions/inactions, and the like), data from biometric sensors (for example, to track the current state, emotional reactions to various communication, and the like), integrations with other systems holding relevant data, and the like.

Communication profiles may be taken from public and private sources, such as databases, academic datasets, demographic information (which can be inferred by joining the different DBs), psychological profiles, author profiling, usage guidelines, relevant data sets (for example, psychological profiles, demographic data, social media status updates), and the like. Communication profile collections and usage may utilize various methods such as authorship attribution (for example, word distribution from social media), clustering, deep learning (for example, language modeling, author vectors, comparison, and the like), text classification (for example, with respect to gender), authorship score calculation, author profiling, user profiles (for example, from e-commerce, social media, articles, and the like), user embeddings (for example, factor adaption, user content, user type embeddings, and the like), personalized natural language processing, personality assessment, linguistic homophily, linguistic style, and the like.

Communication profiles may include information about the user of communications, such as their age, gender, race and ethnicity, professional concentration, occupation, past employment, current employment, workplace hierarchy and dynamics, residential geographic location, professional/work geographic location, current geographic location, geographic location of origin (for example, home country, city, nationhood), primary and secondary communication languages, religious heritage, religious views, political views, personal preferences, social hierarchy dynamics, personal psychological type (for example, neuroticism, extraversion, openness, agreeableness, conscientiousness, and the like), personal human values (for example, self-transcendence, self-enhancement, conservation, openness-to-change, hedonism, and the like), Meyers-Briggs Type Indicator (MBTI), cognitive style(s), contextual emotional states (for example, under what conditions the individual experiences general positive emotions, optimism, general negative emotions, depression, anxiety, anger, and the like), and the like.

Communication profiles may include an individual's lexical writing features, such as lexical features at the character-level (for example, character n-grams (for example, labeled char-n-grams), percent of characters per document (for example, ratios between upper case characters, emoticons, periods, ellipses, return characters, commas, parentheses, exclamations, colons, digits, semicolons, hyphens and quotation marks and the total number of characters in a communication, and the like), at the character-level (for example, number of words, mean number of characters per word, mean number of characters per word, and the like), at the sentence-level (for example, mean number of words per sentence, standard deviation of words per sentence, difference between the maximum and minimum number of words per sentence), emoticons (for example, number of emoticons, number of emotions per word, sentence, document, and the like), special characters (for example, ‘$’, ‘%’, ‘@’, and the like), vocabulary richness (for example, percentage of distinct words, type-token ratio, hapax legomena, Yule's K, dis legomena, and the like), readability (for example, metrics (for example, Flesch-Kincaid metric), word length distribution (for example, word-lengths per sentence, email selection, document, and the like), sentence length distribution (for example, sentence-length per email selection, or document)), and the like.

Communication profiles may include an individual's syntactic features, such as parts of speech (POS) features (for example, POS n-grams (for example, fine-grained and coarse-grained), relative frequency of comparative and superlative adjectives and adverbs, relative frequency of the present and past tenses, phrase structure of general grammatical categories (for example, noun-phrase, verb-phrase, and the like)), dependency features (for example, frequency of each individual dependency relation per sentence, percent of modifier relations used per tree, frequency of adverbial dependencies (for example, providing information on manner, direction, purpose, and the like), ratio of modal verbs with respect to the total number of verbs, percent of verbs that appear in complex tenses referred to as “verb chains” (VCs)), tree features (for example, tree width, tree depth, branching factor (for example, mean number of children per level)), function words, filler words, stop-words, punctuation, formality, and the like.

Communication profiles may include an individual's discourse features. For instance, to obtain a discourse structure, the system may use a discourse parser, which receives as input a raw text, divides it into elementary discourse units (EDUs) and links them via discourse relations that follow a rhetorical structure. The system may then compute the frequency of each discourse relation per EDU (for example, dividing the number of occurrences of each discourse relation by the number of EDUs per text). The system may also determine the shape of the discourse trees (for example, with respect to depth, width, branching factor, and the like), ratios of discourse markers, interjections, abbreviations, curse words, polar words (for example, positive and negative words in polarity dictionaries with respect to the total number of words in a text), and the like.

Communication profiles may include an individual's idiosyncratic features, such as spelling errors, syntactically classified punctuation (for example, end-of-sentence period, comma separating main and dependent clauses, comma in list, and the like), grammatical errors (for example, sentence fragments, run-on sentences, subject-verb mismatch, repeated words, missing word errors, all-caps words, abbreviated words, letter inversions, only one of doubled letters, repeated letters, missing hyphen, wrong singular/plural, wrong tense, wrong verb form, wrong article, wrong preposition, repeated non-letter/non-numeric characters (for example, ???, or !!!), and the like.

Communication profiles may include an individual's communicative structural features, such as at the communication-level (for example, has greeting, signature, URL, quoted content, body length, subject length, and the like), paragraph-level (for example, mean number of paragraphs per email, paragraph lengths, mean number of sentences per paragraph, mean number of words per paragraph, and the like), in technical structure (for example, attachments, fonts, use of images, and the like), and the like.

Communication profiles may include information about what a user may write, such as the results of statistical analysis of the user's content (for example, word n-grams, word and document embeddings, term frequency-inverse document frequency (tf-idf), acronyms, first-person pronouns, slangs, leetspeak (for example, 133t, pwn3d, and the like), emoji, dictionaries, use of stock phrases (for example, idiomatic expressions, metaphors, support verb constructions, names of persons, locations, and other entities, dates, domain-based technical terms (for example, academic, legal, medical, scientific, administrative, and the like).

Communication profiles may be constantly updated, such as with respect to communications between participants, documents that the user generates or edits, writing style, errors encountered, previously stated goals, business associations, preferences, and the like. User communication profiles may then be used by the AIA to help modify new communications based on the latest information available for the user(s).

Communication profiles may include representations of typical reactions and interactions extracted from communications, such as information extracted from previous responses (for example, using sentiment analysis and other natural language tools), extracted non-verbal reactions from speech and/or video (for example, tone, facial expressions, posture, and the like), received interactions with other systems (for example, views, clicks, reaction time, and the like), inputs explicitly reported by a user (for example, in the setup or update of a communication profile, through a survey, use of emoji, and the like), inputs reported by a user (for example, through a product survey), lookalike communications, and the like.

Communication profile data may be used in training data for transformation processes. In addition to data associated with the content of communications, other factors may be considered. For example, a video stream of a receiver may be evaluated for body language during a video-call, capturing the gesture and posture of the receiver. For instance, this data may be correlated to geographic location to account for different body language for different countries/cultures, where the information about geography is mapped to the posture in a reaction (for example, posture mapping to anger or acknowledgment).

In an embodiment, when a communication is addressed to a plurality of receivers, the communication profiles for those targeted receivers may be used individually to generate unique communications by the AIA for each receiver, to generate a single audience targeted communication, or a combination of individual and group targeted communications. In an embodiment, the user may be able to specify how a plurality of individuals in a targeted audience population is to be communicated with, such as individually or as a group. For instance, the user may generate a single communication, but intends it to be transmitted to an audience of ten individuals, where three may be targeted for individual communications and the rest targeted for a group communication. The individual communications may utilize the receiver's individual communication profiles to process the user's communication into unique communications, and the rest of the communication profiles may be used to generate some ‘average’ response (for example, a weighted averaging of receiver characteristics from the group's communication profiles) from the user's communication. The AIA may enable the user to generate a single communication that is customized per the target audience.

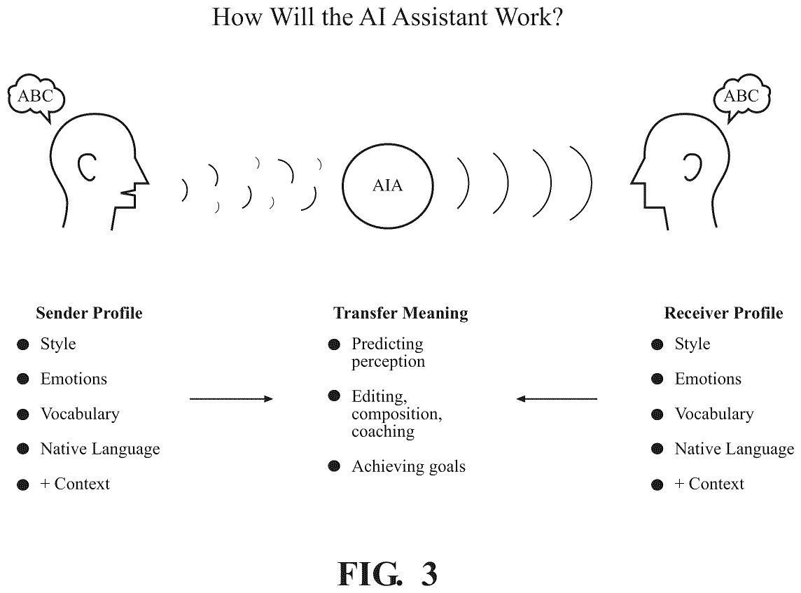

The AIA may utilize communication profiles to transfer meaning to a user communication. As illustrated in FIG. 3, a user, generating a communication, may interact with the AIA, and the AIA may in turn access the user's communication profile in addition to the receiver's communication profile. Communication profiles may comprise characteristics such as writing style, speaking style, communicative emotions employed in past communications, vocabulary usage, the user's native language, contextual information, and the like. This information from users may then be used by the AIA to predict perception related to how the communication could be received; provide editing suggestions, composition suggestions, and coaching; assess how goals may be met; how lookalike communications (for example, templates) may be used to compose a new communication; and the like. The AIA may assist the user in composing communications that transfer meaning to the receiver as intended. The process may begin with the AIA processing and determining the user's goals, communication draft and key points, processing and incorporating the user's communication profiles, structuring a communication to achieve a goal, determining the best structure and tone to meet the goals, and the like. For instance, the AIA may add a clarifying point to a communication based on email history and context of the receiver, use language and style that relates with the receiver, change the tone of an emotionally charged communication so it's less likely to offend the receiver, use a different word the receiver will understand, make the text written by a non-native speaker less idiomatic, and the like.

In an embodiment, the AIA may operate on a plurality of computer-based platforms, such as on laptop/desktop computers (for example, native applications, editor integrations, and the like), Web (for example, standalone, browser extension, and the like), mobile computing devices (for example, smart phone, tablet, and the like), augmented or virtual reality glasses, home and office interactive assistant augmentation, video conferencing, voice assistance, wearables, and the like. The AIA's ability to imbibe information, context, and global knowledge into a communication may be applied to a great diversity of applications, including personal and professional communications (for example adapting to different genres, styles, formalities, and the like), individual and group communications (for example, targeting individuals, groups, or a combination of individuals and groups, and the like), real-time conversational assistance (for example, aiding a user during a live conversation), interactive communication generation (for example, aiding the user in drafting an email or text prior to sending), entertainment (for example, applying a humor filter to a communication), business services (for example, modifying a communication with a client), and the like. For example, the AIA may help a user generate a communication through an interactive exchange, where the AIA interjects feedback associated with different target audience characteristics (for example, composing an email to your mother, versus to a friend or professional associate). In another example, the AIA may aid a user during a conversation, such as during a voice conversation or a text exchange (for example, where the AIA provides feedback during the conversation on a smart phone through a displayed dialog box, on a pair of augmented reality glasses, and the like). The AIA may also be applied to entertainment. For example, a user may want to add a personal anecdote (for example, to lighten the tone of the communication) or turn a benign communication into a funny one (for example, applying a humor filter, such as in a similar fashion as people applying a humor filter to a photo).

The AIA may be applied to a plurality of use-cases, such as for grammar and fluency correction, clarity, and effectiveness in combination with context and communication profiles, improving human-computer interaction effectiveness, augmenting outgoing voice and video messages, augmenting conversations, augmenting incoming communications, providing communication analytics and coaching, providing conversational agent modality, and the like.

The AIA may be able to predict the reaction of a receiver, such as alerting the user if a communication doesn't match the target receiver's preferences and suggest revisions. Given a communication and a goal or desired reaction (for example, where the goal is to entertain, where the target reaction is to produce a smile or a laugh, and the like) the system may predict whether the communication is likely to cause this reaction, based on the corresponding component of the receiver's communication profile (for example, what he or she tends to find entertaining). Then the AIA may generate revisions that make the communication more likely to spark the desired reaction. For example, the AIA can be programmed to generate revisions that make the communication more like other communications that the system has seen that triggered a similar reaction from this specific receiver or group. Once the communication has been sent and a response has been received, the AIA may help the user understand a particular reaction, such as detecting tone and other non-verbal signals in the incoming communication, generate advice on how to reinforce desirable reaction and mitigate an undesirable reaction, and the like. The AIA may utilize or generate a communication template given the goal and context of a communication, such as based on patterns learned from other communications with the same goal and similar context that the system has seen or suggest a communication format and modality based on the goals, context, and communication profile of the receiver, such as converting the communication into a different modality, picking a delivery channel, and the like.

In an embodiment, the AIA may improve human-computer interaction effectiveness, such as with an API for a third-party system that allows rewriting an automatically generated communication to look more like it was drafted by a human or appealing to a given target audience or receiver, and effective for a given goal. AIA may customize the communication for each receiver based on their communication profiles and select an appropriate delivery channel, such as based on an automatically generated communication with context, goals, a list of receivers and the like.

In an embodiment, the AIA may provide communication analytics and coaching. For instance, the AIA may provide coaching based on observed communication, where the system generates personalized advice on what the user could do to improve communication and be more effective or productive (for example, develop active listening or non-violent communication skills, expand vocabulary, brush up on grammar, be more concise, improve pronunciation, speak slower, use questions instead of directives, limit social media use, and the like), avoid common mistakes the user typically makes (for example, to gradually reduce repetitive errors or behavior), and the like. The AIA may capture not only outgoing communication or conversations but also consumed information, such as using a camera or microphone feed from a wearable device, such as on smart glasses, analyze the receiver's reactions to various content and conversations using data from sensors, such as wearable and biosensors (for example, temporal data, and the like), and use this to build or augment the receiver's communication profile and for communication coaching. Coaching may be provided in real-time, as feedback, provided off-line, and the like. In an embodiment, this information may also be used as training data for communication models.

In an embodiment, the AIA may provide a facility for conversational agent modality, where the AIA may vary the type of interaction system utilized. For instance, a “highlight and suggest” interaction may be utilized, or the AIA may rewrite a sentence or passage given different constraints (for example, goals, proofing, clarity, effectiveness, and the like), or in a ‘more forward thinking’ mode, where the system chats with the user to work with them interactively to improve their communication, such as a friend or tutor would. For example, a user may generate a message, and receive an interactive dialog, such as “Hi! I've read your communication and have some tips! Your grammar is fine, but I am concerned about organization. Can we start?” Once the user agrees, the AIA may provide guidance and dialog, such as “I've highlighted what I believe is the thesis statement of your message. I think this would make more sense moved up. Let me show you.”

The AIA may provide a host of messaging improvement facilities, where any number of them may be utilized and combined. For example, a user may utilize the AIA to write an email for applying for a job. The person may write a first pass email and then the AIA chooses the best modality to give them feedback. Maybe the user is a proficient writer and can look at comments made on the side, maybe the user is embarking on their first job search and the AIA may select a “conversational agent” mode and walk the user through why certain things should be changed and what is good, and why. With a modality selected, such as for “automatic rewrite”, AIA may review the draft, use language modules to check for grammatical errors, recognize that the goal of the email is to impress the receiver (for example, a hiring manager), and elect to transform the text into a more formal style. The AIA may access receiver communication profiles and determine that the receiver likes a certain pop culture reference and likes attachments in PDFs, so a subtle reference to a popular movie is slipped into the cover letter and the cover letter is converted from a word processing format into a PDF format. In addition, given the goal, the AIA may make sure to open the email with some ebullience to show that the user is really interested in the job and pulls content from their cover letter that would back up their enthusiasm for the job. For example, if they were applying for a job in a particular company, the system may pull out an internship at that company from last summer and use that as an example. The system may also check for missing information, such as a signature at the bottom of the email and phone number where they can be reached. In this interchange, the AIA may utilize a number of communication improvement facilities in combination, such as modality selection, proofreading, effectiveness, style transformation (for example, includes vocabulary shifting), goal detection and optimization, receiver communication profile scanning (for example, inclusion of pop culture reference, affinity for a certain file format, and the like), effectiveness (for example, some parts are made more persuasive to show interest), argumentation (for example, supported by pulling facts from different sources automatically), check for missing information (for example, system has an idea of what a good letter looks like for this task), and the like.

In an embodiment, the AIA may be utilized in an educational environment, such as where a user is a student that is provided suggestions with respect to writing structure and style, with prompts to inappropriate tone, with additional context associated with new concepts, and the like. For instance, a student may be writing a paper on the civil war, and the AIA not only suggests modifications to the text with respect to improving the student's quality of writing, but also suggests context to aid in the support for a student's theme or bring related current events to the student's attention.

In an embodiment, the AIA may be used for grammar and fluency correction. For instance, the AIA may utilize context to improve grammar and fluency, such as applying a different dictionary and grammar based on a user's location, the specified audience (for example, use Australian English spelling and grammar norms by default if the users are (mostly) Australian), and the like. The AIA may utilize communication profiles to improve grammar and fluency, such as applying a different grammatical error correction model depending on the user's native language (for example, applying a model trained on text with errors typical for Chinese learners of English to improve the accuracy of correction), adjusting spelling and grammar correction according to a receiver's sensitivity or opinion on certain writing issues. For example, based on an observed communication profile of the receiver, the system may know that he or she gets annoyed by lowercasing in short text messages or by sentences ending with prepositions, and enable the corresponding checks and applications of corrections if a user is writing to this person.

In an embodiment, the AIA may be used to improve clarity and effectiveness, such as through context and communication profiles. For instance, an alert of readability or vocabulary mismatch may be provided to a user based on the target audience (for example, too many idioms in a text for non-native speakers or inclusion of complex language in a text for children), a suggestion for an improvement to or automatic rewrite of the text may be provided to adjust readability and vocabulary, a rewrite of an email may be provided to maximize a positive outcome, and the like. For a given email, the AIA may suggest or apply the structure and revisions that increase the chance of a positive response or rewrite the text to make it more effective (for example, targeting specific sentences or generating a new email from scratch). A communication profile, prior communication, documents, calendar information, and the like, may be considered, such as were shared in the thread or elsewhere. For example, a sales email may be rewritten using a model trained on a corpus of similar sales emails with response and/or click data. In another example, improvements or a rewrite may be suggested to a support email so that a specific customer (receiver) is satisfied, such as using a model that is trained on a corpus of similar support emails tagged with satisfaction ratings and possibly also the receiver's communication profile.

The AIA may have the capability to modify a communication to appeal to a specific receiver, such as generating revisions or rewriting the communication using the vocabulary that the receiver would understand or using the structure and language that the receiver tends to use or reacts positively to (for example, based on his or her communication profile). Adding or removing content may be suggested, such as depending on the user's goals and receiver's background, such as using individual and shared context available to the system or adding references and content from documents (for example, previous interactions with the receiver), pop culture, current news, or other kind of world knowledge.

The AIA may have the capability to detect biased or inflammatory language and suggest more balanced rewrites when possible, such as warning the user if a specific receiver can be annoyed by certain forms of language (for example, structure, tone, certain terms, and the like), based on his or her communication profile. The AIA may detect a user's emotional or physiological state to correlate with their current writing style, such as through biometric data from the user (for example, from a wearable device), visual indicators (for example, from facial indicators analyzed from a user-facing camera, such as mounted on a user's laptop or smartphone), changes in writing style with respect past messaging and responses, and the like. For instance, a user may be wearing a smartwatch that monitors the temperature, heart rate, galvanic skin response, voice data (for example, vocal inflections, volume, speech patterns, and the like), and blood sugar, where changes in these levels are matched to emotional profile data, such as stored on the user's communication profile, as determined from similar measurements in a population, and the like. The AIA may then be able to determine if these indicators are adversely affecting the user's communications, such as when a spike in body temperature, heart rate, and low blood sugar is detected, making a person more likely to communicate in a frustrated or angry manner. The AIA may then prompt the user to be aware of such potential influences, offer communication suggestions related to the same, or revise a communication. The AIA may also correlate detected emotions with the content and/or communication the user deals with and use this as training data for modules that predict reactions and for updating communication profiles.

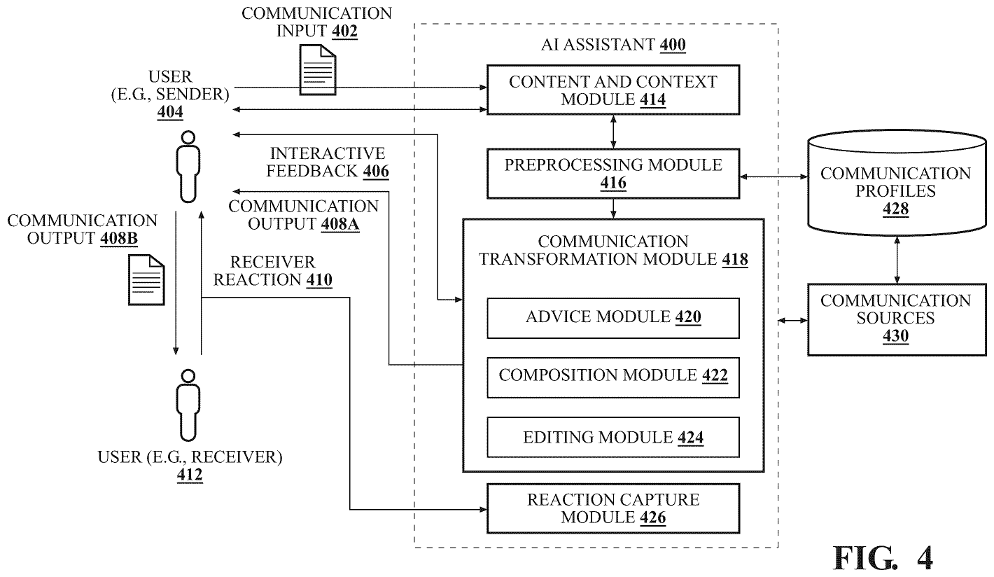

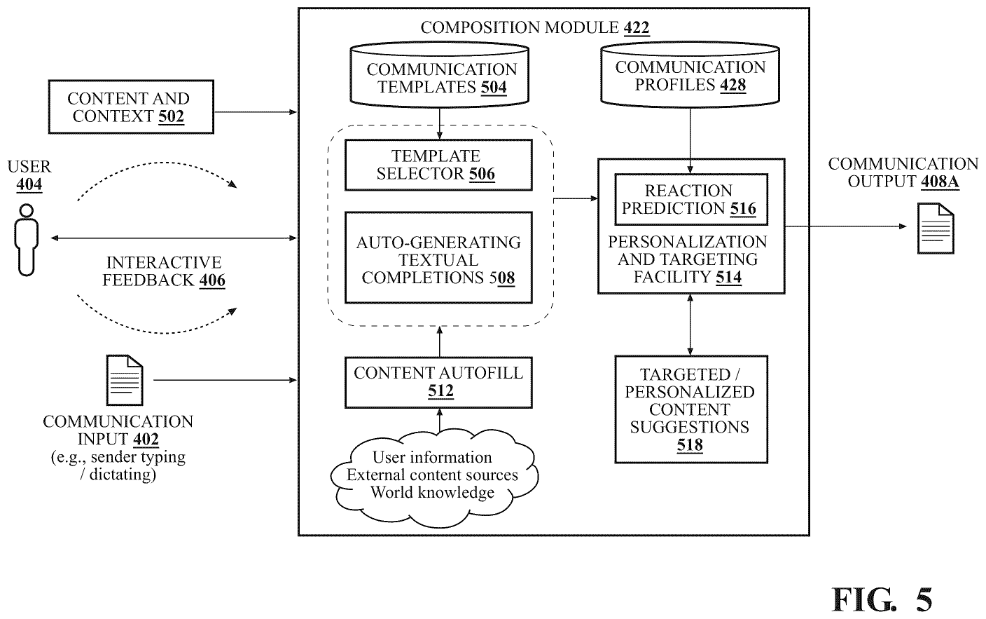

In an embodiment, communication profiles and available context may be utilized to compose and/or edit user content (for example, an electronic communication) in a way that maximizes the probability of the receiver(s) perceiving the received content as intended by the user and reacting positively. FIG. 4 depicts a workflow of asynchronous communication, including general advice to a user generating a communication and compositional and editing assistance to the user for the communication. The workflow begins with the user 404 (for example, a user sender) providing a communication input 402 to the AIA 400, where the AIA 400 receives the communication input 402 with a content and context module 414. The user 404 may provide an initial communication input 402 (for example, draft a message, upload a document, or just start typing or dictating). The user 404 may provide context by specifying the use case, goals, intent, desired reaction, and the like. The user 404 may provide prior communication history by opening a thread and/or granting the AIA 400 access to their inbox. The AIA 400 may infer more context from the communication environment, integrated systems, and recent user activity (for example, channel, schedule, user's current state, and the like). The AIA 400 may classify the communication type and use case based on initial content and/or prior history. Techniques for classification may include rule-based, machine learning, deep learning, statistical models, and the like. The AIA 400 may present (at least in part) inferred context to the user 404 via communication output 408A to confirm or override. The AIA 400 may apply default context values (for example, default goals for a certain use case) if they are not provided by user 404 and cannot be reliably inferred.

The user 404 may specify a second user 412 (for example, a user receiver), such as by selecting from a contact list or picking applicable audience types, as described herein. The AIA 400 may identify the use case through interaction with the user 404, such as the goals of communication and desired/undesired reactions. The AIA 400 may begin the session as pre-configured or be launched with a certain use case parameter, infer the use case from the environment or prior communication, prompt the user 404 to specify the use case (for example, “feedback”, “personal request”, “confirmation”, “greeting”, “formal application”, “report”, and the like). Based on the use case, the AIA 400 may infer the goals and communication objectives and prompt the user 404 to confirm or modify them (for example, “convince,” “impress,” “entertain,” “inform,” “express gratitude,” and the like). Based on the use case and goals, the AIA 400 may identify or prompt user 404 to specify desired and undesired reactions of user 412 (for example, emotions, actions, and the like). For instance, a default desired reaction could be “a (positive) response”. A default undesired reaction could be “no response,” “negative response,” “anger,” “frustration,” and the like. The AIA 400 may provide for a default set of messaging goals, such as that a communication should be accurate (for example, error-free), not ambiguous (for example, clear), not harmful or offensive, doesn't cause or escalate conflict, minimizes the risk of misunderstanding, and the like. In an embodiment, the goals of communication and desired/undesired reactions may be updated at any time throughout the interaction with the user, as described herein, based on updated inputs (for example, as the user 404 enters the subject for the communication or proceeds to type or dictate the communication).

The AIA 400 may identify other communication contexts, such as a communication channel, platform, or medium (for example, web, mobile, specific communication clients and collaborative editors, chat, text/voice, and the like), a communication type, form, genre (for example, email thread, short/instant message, shared document, social media post/comment, voice message, and the like), prior communications between the user 404 and user 412, location and time of day/week for the user(s), and the like. The AIA 400 may identify that the channel, time, or form of the communication are not optimal given the receiver and the use case/goals and suggest alternatives, such as based on the preferences explicitly provided by the user 412 or derived from receiver's previous communication patterns observed and learned by the AIA, such as statistics of the receiver's use of channels for different use cases, availability or schedule (for example, extracted from receiver's calendar), typical time they're checking and responding to incoming communication, communication forms they tend to respond to better, and the like. This recommendation may be updated as the user 404 works on the communication (for example, suggest an email or document form instead of an instant message if it exceeds certain size, suggest a short video recording if the communication is more informal). Extracted content and context obtained by the content and context module 414 is then passed to the preprocessing module 416, which encodes it into a common representation (for example, as a vector or matrix) to be used as an input into machine-learning models, deep-learning models, other statistical modes, and the like, within the communication transformation module 418.

The preprocessing module 416 prepares content and context, such as in association with accessed communication profiles 428 (for example, users and/or group profiles), for use by the communication transformation module 418. In an embodiment, the AIA 400 may interface with third-party communication platforms (or may be integrated with the third-party communication platform) to retrieve information about the user 412, such as a receiver ID (for example, email address) derived through extraction from the receiver field, from the thread or conversation (if it's a response), and the like, from the user's communication input 402. For example, accessing the receiver field through a Gmail API or browser extension. Alternatively, the AIA 400 may prompt the user 404 to specify the receiver/audience, such as by entering an email, selecting a contact from the list, selecting the audience or group from the list (for example, team X, family members, industry group Y), selecting the receiver or audience type from the list (for example, a close friend, a boss, expert audience, children audience, or native/non-native speakers), and the like. The AIA 400 may infer the receiver type or target group or audience based on the environment or context of the communication input 402, such as the communication client, user account, prior content of the thread or conversation, communication content, and the like, where for instance, the automatically identified receiver type or audience is presented to the user 404. The user 404 may be presented this information, and be provided an option to override, specify, narrow down, and the like, the selection. If the user 412 is known to the AIA, the preprocessing module 416 pulls the corresponding communication profile 428. If not, it may create a new one. The preprocessing module 416 may also associate the user 412 with relevant group communication profiles 428. In an embodiment, communication profile creation and visibility may be restricted to members of a certain group (for example, members of a corporate email domain, contacts specified by the user, and the like).

The preprocessing module 416 passes the encoded content and context, and the information accessed in communication profiles 428, to the communication transformation module 418 for optional processing, including general advice to the user through the advice module 420, communication composition assistance through the composition module 422, and editing of communication versions through the editing module 424, such as in conjunction with communication sources 430 as described herein. For instance, as part of providing general advice through the advice module, once the communication profile 428 is identified, AIA 400 may display general characteristics of the receiver or audience and provide recommendations on how to communicate with them. Characteristics may include receiver's occupation or role, location, knowledge and interest areas, receiver's language proficiency (for example, native or non-native English speaker), expected or average response time, availability, personality type or traits, and the like. Characteristics may be explicitly provided to AIA 400 by the receiver (for example, as part of filling in AIA 400 user profile), learned through surveys (for example, personality type or traits can be learned through a personality survey delivered to the receiver by AIA), which may be in-product surveys, obtained from external systems accessible to AIA (for example, receiver's occupation may be extracted from a public personal information directory, professional contact network, web search and the like; receiver's availability may be obtained from a calendar) or extracted by AIA 400 from receiver's observed communication (for example, receiver's knowledge and interests can be learned by analyzing the receiver's communication through topic classification or keyword extraction algorithms and identifying the most frequent topics or keywords; receiver's language proficiency can be identified by analyzing receiver's vocabulary or running receiver's communication through a statistical learning algorithm classifying input communication as native or non-native (produced by a native or a non-native speaker); expected response time may be based on historic data on receiver's typical response time in the same or similar communication scenarios). Recommendations may include preferences and other information explicitly provided by the receiver such as preferred communication channels (such as email, instant messages, voice messages, specific communication platforms or applications), preferred communication format and style (such as formal or informal, brief or detailed, plain or rich text, logical or emotional, and the like), preferred communication time (for example, separately for different communication use cases, such as personal and business) and the like. Recommendations may also be derived by AIA 400 through analyzing a receiver's communication patterns (for example, AIA 400 may recommend formats and styles that the receiver responds to most positively and consistently (based on the sentiment analysis of responses and the distribution of time to respond); alternatively, AIA 400 may recommend formats and styles that match/mimic the receiver's prevalent communication styles and format).

As a part of general advice, the AIA 400 may suggest a different time to send a communication output 408B, such as if the receiver is determined to be occupied (for example, based on a retrieved schedule if the AIA 400 has access to it), if the receiver is more likely to provide sufficient attention at the current time where the receiver may better respond to an incoming communication sent at a different time (for example, based on their stated preferences or past behavior recorded in their communication profile, such as when the receiver most frequently checks and responds to incoming communication). Suggested time may be different for different communication use cases, such as personal and business (for example, if receiver's explicit preferences or observed behavior differ in these use cases). The AIA 400 may suggest a different channel to send a communication (for example, email, instant messages, voice messages, specific communication platforms or applications), such as if the receiver is likely to see it and respond faster through a different channel (based on their stated preferences or past behavior recorded in their communication profile, such as the frequency of use of different channels for different communication use cases (among the channels AIA 400 integrates with or has access to)), if the topic, structure, or length of the communication are a better fit for a different communication channel (for example, sensitive topics may better be discussed over phone or longer communications may better be sent over email rather than IM), and the like.

As part of general advice, given a message produced by the user, the AIA 400 may inform the user of the predicted receiver's reaction to such message. AIA 400 may alert the user in case the predicted reaction differs significantly from a desired/expected reaction. The desired/expected reaction may be derived from the user's intent or pre-defined in the AIA 400 for certain communication use cases (for example, if the user's intent is “persuade,” AIA 400 may consider “response with a confirmation” as desired/expected reaction; if the use case is a social media post, AIA 400 may have likes, shares, and comments pre-defined as desired/expected reactions).

In an embodiment, the AIA 400 may provide advice to a user who has sent a communication with feedback from the receiver of the communication, such as described herein. For instance, a user may be provided with reaction feedback, where the AIA 400 provides advice on how to follow up with a second communication to the receiver, such as changing the tone of the communication, adding more information, providing less information, making the communication less formal, removing language identified as undesirable, abusive, or offensive by the feedback, and the like. The feedback may also be included in an update to the user and/or the receiver's profile so that any preferences or issues raised in the feedback can be incorporated into future communications.

The communication transformation module 418 may provide interactive feedback 406, such as prompting the user to specify a user/audience and the context that AIA 400 cannot get or infer from the environment, prior user input, user settings, available communication draft, and history, and the like. The AIA 400 may prompt the user via communication output 408A to confirm or override the receiver/audience and the context the AIA 400 has identified. The user may update the content, context, and receivers at any time during the session. The AIA 400 may detect changes, re-process inputs and adjust its feedback; present general recommendations that the user can react to (for example, acknowledge, dismiss, mark as helpful or incorrect, and the like); use user feedback on the general recommendations to improve them in the future; present template and/or textual completion options (for example, the user may preview and select one or none of them); offer completions and continuously update completion suggestions as the user is entering text (for example, typing or dictating); and the like. In more structured communication use cases, the AIA 400 may guide the user via the communication output 408A through a single template/outline and have the user answer questions/fill in certain blocks of content. The AIA 400 may generate the edits for the text the user has entered and automatically re-check it and update the edits when the user modifies the text, rewrites the content highlights changes, and allows the user to review and revert individual ones, and the like. The user may interact with and provide feedback on AIA's individual suggestions (for example, general recommendations, templates, completions, edits, and the like). The AIA 400 may use the data from user interactions (for example, accepted or dismissed suggestions) and feedback (for example, incorrect or irrelevant suggestion reports) to improve future suggestions (for example, by using this data to re-train/tune the corresponding machine, deep, or statistical learning models).

As further depicted in FIG. 5, the composition module 422 helps the user 404 compose communications with less effort and with greater speed, such as by generating (at least a portion of) communication content (for example, text/language) from a limited communication input 402, guiding the user by suggesting structure and/or placeholders to fill in content, and the like. It may also ensure the quality and effectiveness of communication by optimizing the generated language and structure for specific contexts and communication receivers. The composition module 422 may implement predictive language generation based on initial communication input 402 and available content and context 502, use case, and the like. It may suggest communication templates and generate textual completions, such as predicting the next word, phrase, sentence, paragraph, or an entire message/document/communication. It may present options for the user to confirm or select from. It may optimize generated language to a specific receiver(s)/audience and/or personalize it to mimic the user's communication style. The composition module 422 may use communication templates 504 for various communication scenarios, statistical algorithms for generating textual predictions (for example, machine learning, deep learning, language models, and the like), and other (prospective) forms of natural language generation. Language generation by the composition module 422 may optimize compositional suggestions to the user for utility and impact (effectiveness). Utility optimization can be achieved by maximizing the probability of the user 404 accepting the system-generated text (or one of the suggestions if multiple options are presented) and penalizing compositional selections for inapplicable, irrelevant, or too general suggestions (for example, penalizing templates with higher percent of placeholders vs. actual text, penalizing suggestions that apply to a broad range of use cases vs. the actual use case, and the like). Impact and effectiveness optimization with respect to the user's communication goals can be achieved by maximizing the probability of a positive outcome or reaction by the receiver, given the context, use case, and the like, for the communication. The probability of a positive (desired) reaction may be estimated by a machine, deep, or other statistical learning model trained on a large set of reaction data (records of past communication content with meta-data such as context, senders, receivers/audience, and the actual reactions). Variations of the content generated by the composition module may be run through the reaction prediction model and filtered or ranked based on the predicted probability of the desired reaction before being presented to the user.

The system may accumulate a great amount of content (for example, messages, documents, and the like) with meta-data: context (for example, a resume for an engineering position at a startup or a marketing email in China) and senders/recipients (for example, identifiers, emails, or references to communication profiles). Receivers may be an audience (for example, IT recruiters and consumers in China). This data may be one general-purpose data set mixing everything or multiple specialized datasets, such as use case-specific (for example, only marketing emails) or receiver-specific (for example, email history of a specific user). Meta-data may also include the actual reactions (for example, the number of interview invitations for each resume, the number of clicks or product purchases triggered by each marketing email, the sentiment of a response to each user email, and the like). The system may train machine learning, deep learning, or other statistical models on this data and use these models in the reaction prediction/optimization module of the AIA. The system may have a model that predicts the reactions to a given user's message, context, and the receiver or audience (for example, returns the probability of different reactions. The system may also have a model that rewrites a given user's message to optimize for a desired reaction. It may take a draft of the message, context (including the desired reaction), and the receiver as input and produce a rewrite that maximizes the probability of the desired reaction. These models may be general-purpose (for example, trained on general-purpose data sets) or specialized (trained on specialized datasets). Afterward, the AIA 400 may capture the actual reaction to the user's communication, construct a reaction data record, and feed it into the model(s) to update/retrain them (for example, online learning).

Communication templates 504 may be especially applicable in frequent or repeated communication scenarios, such as short requests or replies, common communication types (for example, introductions, greetings, invitations, resumes, applications, or reports), and the like. Communication templates 504 may not be as applicable for creative writing, describing personal experience, communications containing complex ideas or argumentation, and the like. The composition module 422 may select communication templates 504 from clusters of semantically close or equivalent templates for different communication use cases. Communication templates 504 may consist of text and placeholders or a combination thereof. Some may be ready for immediate use (for example, short requests and replies), and some may be a sequence of placeholders or an outline defining structural and logical blocks that the user would have to flesh out. Communication templates may include short communications (for example, requests, replies, greetings, and the like), use-case specific templates (for example, separate for different channels, communication types, and other context categories/conditions; clusters of variations catering to different communication profiles, and the like). User-specific or group-specific communication templates may be frequently used by the user or by a group that the user belongs to or is targeting (for example, team- or company-specific templates). Communication templates 504 may contain a mix of manually created and automatically generated templates. Templates may be manually created either by the users (for example, administrators providing organization-specific templates for all users in the organization) or by AIA developers/maintainers (for example, a database of professionally edited templates for various common communication scenarios/use cases). Some communication templates 504 may be generated automatically by processing a large body of documents and messages, normalizing and canonicalizing them using different kinds of parsing, chunking or text similarity techniques, and then clustering equivalent ones (for example, with semi-supervised machine learning). In an embodiment, a hybrid approach to template curation may also be utilized, where people manually verify/edit automatically generated templates before making them available.

In an embodiment, selection of communication templates 504 may be implemented as a machine, deep, or other statistical learning model/technique that finds the most likely templates given the initial content, such as previous communications in the communication thread, and known context, such as a user's intent. The template selector module 506 identifies a subset of communication templates to consider, such as based on available context, (for example, communication type, receivers, for example, team or organization) and applies a machine learning model to score these templates and find the highest scoring one(s). As a post-processing step, the template selector may discard or penalize communication templates 504 that are too general and ensure diversity in a resulting set of communication template candidates, such as for further personalization and targeting and also to provide the user 404 a choice.

In an embodiment, automatically generating textual completions 508 may be implemented using machine, deep, or other statistical learning models conditioned on the prefix word sequence (for example, current communication draft), n previous communication(s) in the thread/conversation, additional context, and the like. They may generate the next word, phrase, sentence, paragraph, or an entire message or document. In an embodiment, representations of the previous content and context are fed into a natural language generation model that is trained on large-scale communication data that may be mixed with users' prior communication and/or effective communications of other people like the user (for example, with respect to industry group, and the like), and/or effective examples of communication in the same or similar scenario (for example, with respect to communication type, use case, and the like) such as giving a higher weight to the mixed-in data. The outputs of the model are ranked based on the receiver's communication profile and other contextual information. Output candidates can be ranked by the probability of them triggering desired reaction or outcome or based on their similarity to the user's communication style. The highest-ranking outputs are suggested for the user to confirm/select. The user may confirm/select a completion to use as-is or modify.

The composition module 422 may utilize an automatic content fill function 512 in association with the appropriate placeholders utilizing the language generation facility, such as with filling in personal user data (for example, full name, contact details, addresses, and other data that the user may frequently share in communication), public facts or world knowledge (for example, filling in the full date when only a day of week is mentioned, filling in the public addresses of meeting places mentioned), and the like. It may also prompt the user to fill in certain placeholders in communication templates suggested by AIA.

The personalization and targeting facility 514, such as in conjunction with targeted and personalized content suggestions 518, may be able to provide personalization and targeting of new content, and filter generated language options (for example, select variations from a cluster of templates or textual completion candidates) based on the user's communication profile (for example, to match their communication style) or based on the receiver's communication profile (pick the ones that may appeal more to the receiver to increase the likelihood of a positive reaction). The personalization and targeting facility 514 may provide for reaction prediction 516, such as in conjunction with reaction data stored in communication profiles 428. The personalization and targeting facility 514 may also dynamically modify selected templates, such as by adjusting vocabulary and/or style to mimic the user's communication and/or optimize for a specific receiver or audience. The personalization and targeting facility may use a style transfer module implemented with a machine, deep, or other statistical learning model or models, such as a sequence-to-sequence model or models that translate generated language variations from generic style into the user's authentic communication style. The personalization and targeting facility may use a reaction prediction module implemented with a machine, deep, or other statistical learning model trained on reaction data (communication records enriched with meta-data including reactions of specific receivers) to estimate the probability of a positive reaction and filter or rank generated language variations based on that. Language generation models may also be trained on reaction-enriched data to generate variations that maximize the probability of positive reaction in the first place.

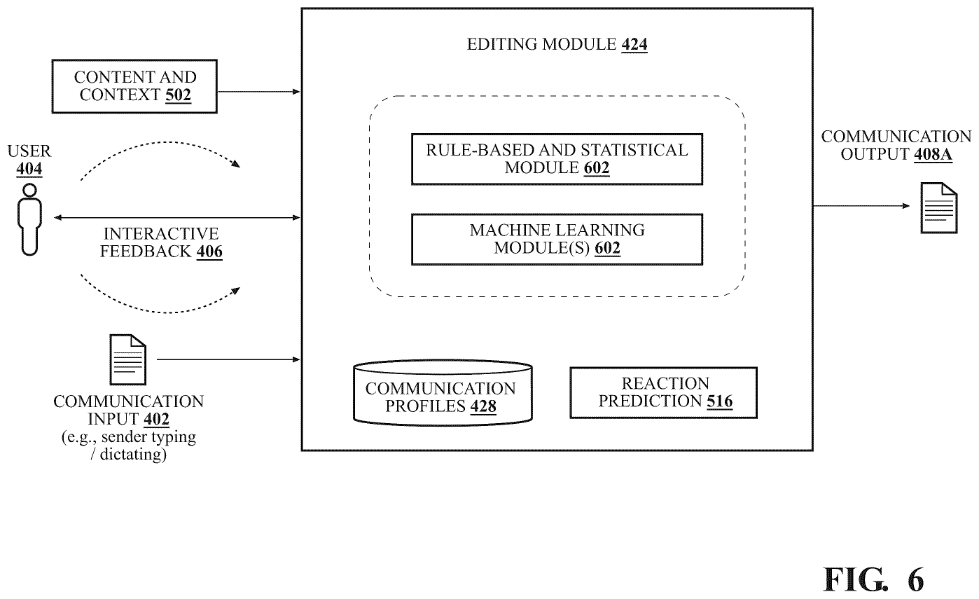

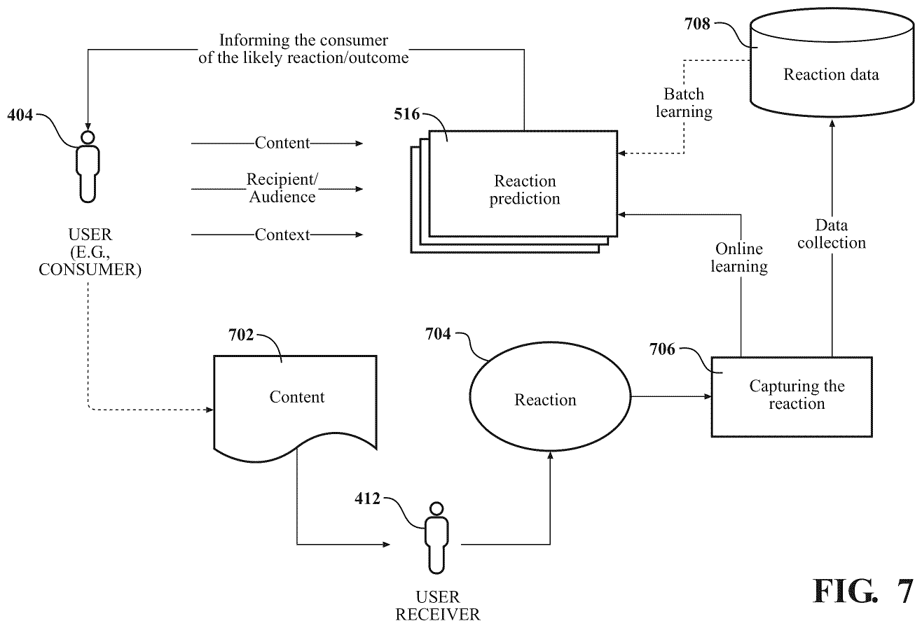

As further depicted if FIG. 6, the editing module 424 analyzes and modifies an existing fragment or the entire communication to optimize it for a specific receiver(s) or audience and use case. The editing module 424 helps the user 404 ensure the quality of their communication by analyzing existing language and generating changes that improve its accuracy, clarity, and effectiveness with respect to communication context and communication profiles. The editing module 424 may include features (checks) that analyze and improve different aspects of communication quality. At least some of these checks may be context- and communication party-dependent. Checks may utilize a rule-based and statistical module 602, a machine learning model(s) 602, deep learning-based models, and the like, or hybrid of different processing module functionality. The editing module 424 may generate modifications and present them to the user 404 to review and confirm or reject individually. It may also modify existing language and present (mark or notify of) the changes it has made- and the user may be able to revert individual changes.

The editing module 424 may provide for context- and profile-dependent checks, such as with respect to accuracy, clarity, effectiveness, and the like. Accuracy checks may include spelling and grammar correction by applying the norms of a specific language dialect, such based on the receiver's dialect, spelling, and grammar correction applied to different parameters or models. Accuracy checks may depend on the user's communication profile (for example, depending on the user's first language and/or language proficiency), and adjust a model's parameters, such as using a model trained on a corpus of texts by the people with same first language/proficiency, resulting in an optimized check for a specific error distribution and frequency. Clarity and effectiveness may include preparing the communication in a way the receiver can listen to (for example, without shutting down, and building trust), such as by optimizing trigger words (for example, removing or replacing negative trigger words, adding more positive trigger words, and the like, such as described herein), prompting the user to add positive feedback that the receiver would appreciate (depending on the use case), replacing non-inclusive language that may make the receiver feel excluded, flagging aggressive language (for example, suggesting the user to wait for a later time to send the communication), applying the style preferred by the receiver, for example, formal vs. informal, brief vs. detailed, and the like. Clarity and effectiveness may include preparing the communication in a way the receiver can understand (for example, building clarity), such as by improving the communication for readability/clarity (for example, adjusting readability (sentence and word complexity) and vocabulary to the receiver's language proficiency level (including native/non-native status), adjusting for formatting based on receiver's preferences, predicting reaction of the receiver (for example, in the case of direct communication) or audience (in case of a broadcast communication), warning the user when a negative or undesired reaction is likely (for example, highlighting content language that can cause negative emotions for a specific receiver or group, highlighting content that may not engage the receiver (for example, too long, irrelevant, and the like), warning when it's not a good time to contact the receiver (for example, they are unavailable, busy, sick, stressed, such as based on the recent communication history, calendar integration, explicit receiver settings, observed receiver state, and the like), modifying communication to increase the likelihood of a positive reaction (for example, through recommendations, suggesting changes, or a complete rewrite)), and the like. The AIA 400 may use reaction prediction like the one provided in the composition module 422 to rank and filter to generate edits. For instance, if predicted reactions do not match desired reactions and/or match undesired reactions, the AIA 400 may warn the user and suggest modifications to the draft, for example to highlight suboptimal fragments (for example, identified by the reaction prediction model), offer vocabulary suggestions (for example, word replacements) that maximize the likelihood of a desired reaction, offer structural changes (for example, size, outline, transitions, paragraph splitting, and the like) that maximize the probability of desired reaction, offer a complete rewrite of the draft, and the like. In an embodiment, the AIA 400 may make corrections to the communication automatically, without user intervention.

The AIA 400 may provide for a reaction capture module 426 to capture the receiver's reaction 410 to improve the effectiveness of generated or modified communications using reaction data, such as through updating communication profiles, collecting reaction data for training (in batch or online mode) the models that predict reactions and optimize communication for certain reactions, and the like. The AIA's reaction capture module 426 may capture reactions 410 through a communication platform (for example, responses, time to respond, sentiment of responses, and the like) or integrations with other systems (for example, link clicks, or other receiver actions triggered by the communication). Reaction capture module 426 may capture reactions 410 directly from the receiver (for example, if the receiver is also an AIA 400 user), ask the user 404 to report the receiver reaction 410 as the outcome of a certain communication, and the like. Receiver reaction data may also be obtained and processed in a batch outside of the AIA 400 workflow (for example, extracted through an integration or an API from an external system, from an archive of prior communication, and the like).

The AIA 400 may include a reaction prediction and optimization facility that may utilize reaction data, such as consisting of records of communication acts (cnt, p, cxt, ro), where ent is content (for example, message, document, text, audio, video, in raw form or included meta data such as for formatting, markup, annotations, tags, and the like), p=(s, r) are references/identifiers of communication parties, where s is a user sender and r is a user receiver/audience (for example, r may be an individual or a group or a category of receivers, s may be a human or a computational system capable of generating natural language, s, r may include properties and characteristics of the parties or link to communication profiles of the parties, r may include the type of relationship between the recipient(s) and the sender, cxt is context (for example, may include the use case, user goals, references to communication history (such as previous communications in a thread) or related documents, current psycho-emotional state of communication parties, their availability, location, and the like), ro is a reaction or outcome that the content ent triggered with the receiver(s) r. Reaction/outcome ro may be a response or no response, time to response, number of subsequent communications in the thread (for example, before the goal of communication was achieved), sentiment or type of the response (positive/negative, confirmation/rejection), receiver emotions, use case-specific response (for example, containing certain elements/words), receiver actions (for example, clicks on the link in the communication, signups), additions or deletions of participants in a thread or conversation, and the like. In case r is plural (a group/audience), ro may be an aggregate, such as the total number of receiver actions, positive and negative responses, clicks, and the like. Response data may be one or multiple data sets (for example, use case or receiver-specific). Reaction data may be used to train a machine, deep, or other statistic learning model that would predict the most likely reaction-outcome ro for a given (cnt, p, cxt).

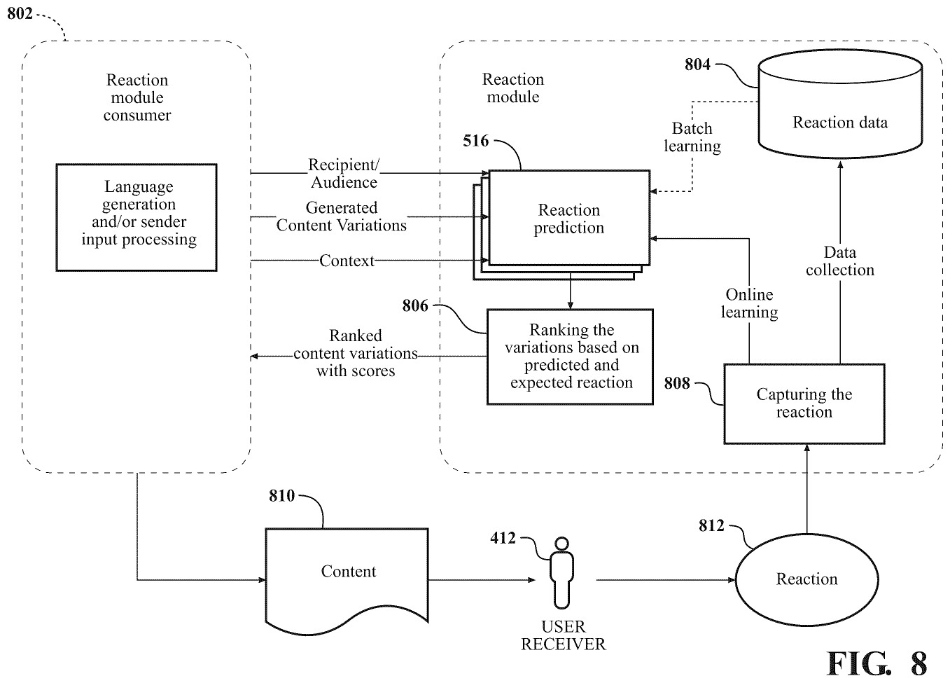

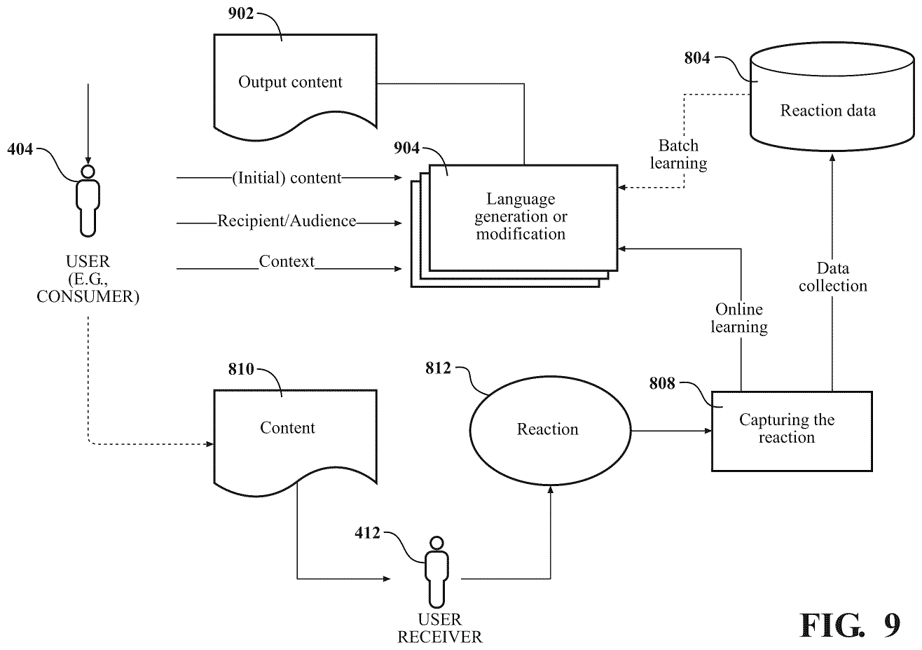

Referring to FIG. 7, this reaction prediction 516 may be used to inform the user sender 404 of the likely reaction-outcome, such as from the user sender 404 send content 702 to a user receiver 412. The user receiver 412 then produces a reaction 704 which is then captured 706. The captured reaction 706 may produce reaction data 708 to be stored, as well as being provided for reaction prediction 516. Referring to FIG. 8, the reaction prediction may be used to rank different variations of content 810 using a ranking module 806 given a desirable/acceptable set of reactions/outcomes, and the like. In an embodiment, the reaction prediction 516 may interact with a reaction module consumer 802, such as for language generation and/or sender output processing.

FIG. 8 shows the reaction module consumer 802, which is responsible for language generation and sender input processing. Reaction module consumer 802 is configured to create content variations and send these variations, along with the context and recipient/audience information, to the reaction prediction 516 within a reaction module. The reaction prediction 516 is configured to evaluate the generated content variations, predicting the likely reactions based on data about the recipient/audience and context. Following this, the content variations are ranked by the ranking module 806 based on the predicted and expected reactions. These ranked content variations, accompanied by their scores, are then returned to the reaction module consumer 802 for further processing.

Simultaneously, the actual reactions 812 from the user receiver 412 are captured by the capturing the reaction module 808. Reactions 812 are stored as reaction data 804, which serves multiple purposes. This data is utilized for batch learning, where large datasets are used to train models offline, and for online learning, where new reaction data continuously updates and improves the predictive models such as reaction prediction 516.

The reaction prediction 516 can then inform the user sender 404 of the likely reaction outcomes, optimizing the content for maximum effectiveness. The reaction data 804 can be used in training models that generate or modify content to achieve desired reactions. These models can be general-purpose or tailored to specific contexts or receivers, ensuring the communication is contextually appropriate and receiver specific. Content 810, refined and optimized based on the reaction data, is then delivered to the user receiver 412. This optimized content aims to achieve the desired reactions, and the cycle continues with the capture of new reactions, creating a feedback loop that perpetually enhances communication effectiveness.

Thus, FIG. 8 shows an interconnected system where the reaction module consumer 802 generates and processes content, the reaction prediction 516 predicts and ranks reactions, and the capturing module 808 gathers real-time reaction data. This data is stored and utilized by the reaction data 804 for continuous model training and content optimization.

Referring to FIG. 9, reaction data may also be used to train a machine learning model such as language generation or modification model 904 that generates output content 902 or modifies content in a way that maximizes the probability of a certain (set of) ro. For instance, given the communication parties p, context cxt, target reaction(s) ro, and the space of possible content variations CNT, the model could find:

$${cnt}^{*} = arg max P ( {cnt}_{i} \vert p , cxt , ro ) , {cnt}_{i} ∈ CNT$$

The models may be either general-purpose or context-, receiver- or reaction-specific. For example, context-specific models may be trained on reaction data sets consisting of records of communication acts in a certain use case. Receiver-specific models may be trained on communication addressed to a specific receiver or audience and representing their reactions. The models may be used in AI-assisted composition, editing, or communication analysis applications. The models may be trained offline (for example, batch learning using large reaction data sets) or online (AIA's reaction capture module may feed new reaction data records into existing models to improve their accuracy). The models may run on the server side (for example, in the cloud) or may be embedded on communication devices.

In an embodiment, the AIA 400 may provide a receiver with a modified version of a received communication, such as based on the communication profile of the user and the preferences of the receiver, such as described herein. The receiver may benefit from such modification if the user has characteristics and behaviors that causes the communication to be non-optimal in some way, such as because the user tends to communicate in an emotional manner, the user has a language characteristic that makes understanding difficult (for example, the user is a non-native speaker, uses idioms that are unfamiliar to the receiver, uses slang that is offensive to the receiver), and the like. The AIA 400 may monitor communications being received, and flag those that may need modification, where, such as based on a user's preferences, the communication may be modified before it is presented to the receiver. In an embodiment, the AIA 400 may indicate that the communication has been modified, indicate what portions of the communication has been modified, show the modifications in an annotated version of the original communication, present both a clean modified version and an annotated version of the original communication, and the like. Based on past communications from a user, and past reactions and preferences by the receiver, the AIA 400 may implement modifications to a communication without first notifying the receiver. Alternately, the receiver may be notified that a modified version is available, where the receiver may be offered options for reading or listening to the communication. In an embodiment, the AIA 400 may implement modifications based primarily on the receiver's communication profile, such as regardless of the user/source of the communication (for example, modify/augment anything the receiver reads/hears, including incoming communication, online or printed content, and the like). Based on the receiver's language proficiency, the AIA 400 may adjust readability (for example, simplify vocabulary, rephrase idioms, and the like). Based on the receiver's environment, preferences, available time, and the like, the AIA 400 may condense/summarize content. If the AIA 400 knows the receiver is sensitive to specific content (for example, based on his/her communication profile), the AIA 400 may alert the receiver or mask this content. In the process, the AIA 400 may observe and collect receiver reactions to various types of content as training data, learn from their feedback and interactions with its functionality that augments the content receivers consume, and the like.

In an embodiment, the AIA 400 may augment an incoming communication to a receiver, such as through a user interface, for transforming incoming communications (for example, emails, instant message, and the like), shared documents, or other content that receivers consume, into a more digestible form. Transformations of incoming communications may include removing wordy or redundant language that does not carry meaning so that reading takes less time and effort; such transformations can take the form of classification machine or deep learning algorithms to strike out words or phrases or sequence to sequence algorithms which automatically convert one text to another (for example, neural machine translation or paraphrase). Data employed ranges may be transformed from manually or automatically curated lists of commonly overused phrases (either generally, by domain or by communication party) to parallel data sets which consist of original wordy sentences or documents and their less wordy rewrites.

Transformations may provide summarizing longer messages or documents for quick preview. Possible applications include, and are not limited to, providing a summary or set of key points for long emails, messages, or documents, or automatically generating more concise versions of long passages to make it easier for the reader to understand, and the like. Methods may include machine and deep learning techniques which can leverage parallel corpora of long sentences or passages with their summarized rewrites, as well as leveraging vast amounts of unlabeled data.

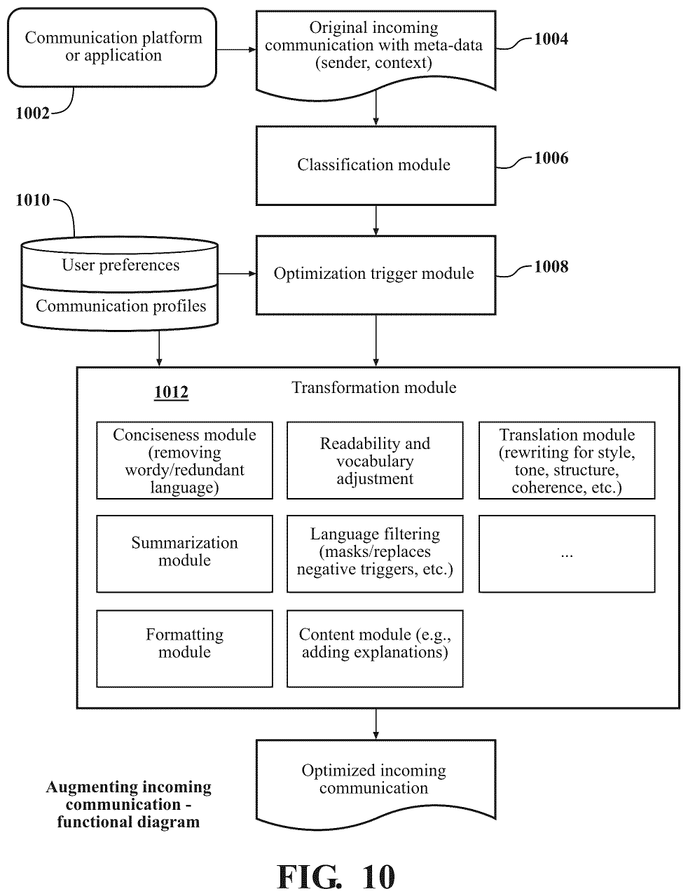

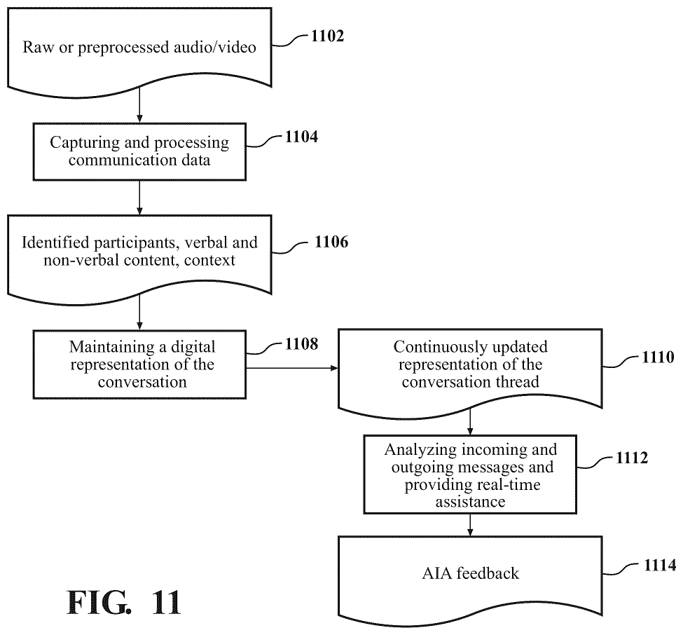

In an example embodiment, and referring to FIG. 10, a communication platform or application 1002 may receive an original incoming communication with meta-data 1004, which may be classified with a classification module 1006 and evaluated for triggers with an optimization trigger module 1008, which my take input data from stored user preferences and communication profiles 1010. A transform module 1012 may provide a plurality of transformations, as described herein, to produce an optimized incoming communication.

Transformations may include formatting texts and adding structure, such as highlighting key phrases, splitting long paragraphs, converting lists into bullet points. Techniques may include using machine learning or deep learning or other statistical techniques and treating the problem as a classification or sequence labeling task.

Transformations may include rewriting messages or documents using vocabulary and readability (for example, splitting long sentences; replacing long or rare words with shorter, more common synonyms; replacing idioms with literal/universally understandable equivalent phrases, and the like) to a level that the user would understand, depending on their language proficiency level and background. Methods may include using manually and/or automatically curated dictionaries and reference sources as part of rule or statistical approaches. Methods may leverage a user's profile, user and conversation context and knowledge, and the like, of both conversation parties to automatically identify (for example, using techniques such as machine or deep learning) types of language, and then employ rule or statistical techniques to generate the appropriate the context.

Transformations may include rewriting messages or documents using style, tone, argumentation, coherence, and structure, and the like, that the user would understand and react positively to, such as depending on the context, goals, and recipient background. Methods may include machine and deep learning techniques which can leverage parallel corpora of long sentences or passages with their summarized rewrites, as well as leveraging vast amounts of unlabeled data.

Transformations may include masking or rephrasing the language that the user would not like to see (for example, offensive language, negative triggers, clichés, and the like) of certain words based on user's stated preferences or previously observed reactions. Such transformations may take the form of classification machine or deep learning algorithms to strike out words or phrases or sequence to sequence algorithms which automatically convert one text to another, such as neural machine translation or paraphrase. Data employed ranges from manually or automatically curated lists of commonly overused phrases may be employed (either generally, by domain, by communication party, and the like) to parallel data sets which consists of phrases, sentences, or documents with the target language and their corrections.

Transformations may include adding missing context, such as explaining terms, abbreviations, slang, idioms, and the like, that can be unfamiliar to the user. Methods may include using manually and automatically curated dictionaries and reference sources as part of rule or statistical approaches. Methods may leverage the user's profile, user and conversation context and knowledge of both conversation parties to automatically identify (for example, using techniques such as machine or deep learning) parts of communication which need more context, and then employ rule or statistical techniques to generate the appropriate the context.

Transforming incoming communications may methods include, but are not limited to, rule-based, machine learning, deep learning, or other statistical supervised, semi-supervised and unsupervised techniques. Readers may choose message or document types that they would like to be automatically modified. Alternatively, users may request the system to modify specific messages or documents on demand, such as by applying specific filters or transformations. Users may be able to view the original version even if the message/document was automatically modified.

In an embodiment, and with reference to FIG. 11, the AIA provides feedback for communication interactions, including audio and/or video communications. The process begins with receiving raw or preprocessed audio/video data at step 1102 and capturing and processing it at step 1104. At step 1106, participants, verbal and non-verbal content, and context are identified. Following this, at step 1108, the AIA maintains a digital representation of the conversation, which is continuously updated at step 1110 to reflect the conversation thread. The AIA then analyzes incoming and outgoing messages at step 1112, providing real-time assistance and generating feedback at step 1114 to improve communication effectiveness.

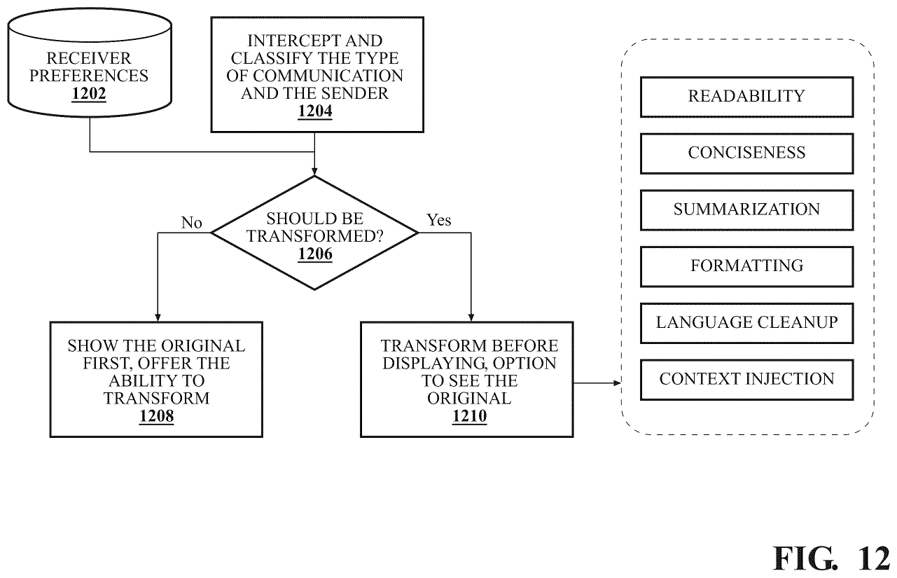

In an embodiment, the user may be able to specify whether they want to transform incoming communications automatically or manually, showing the original before or after transformation, and the like. In a non-limiting example, and referring to FIG. 12, based on receiver preferences 1202, at first process step 1204, the user interface may intercept an incoming communication to a receiver and classify the communication, such as by a type of communication, who the user is, and the like. In a second process step 1206, the user interface may decide whether to transform the communication, such as automatically based on user preferences or decided by the receiver based on an interaction between the receiver and the user interface. In a third process step 1208, the user interface determines that the incoming communication should not be immediately transformed, showing the receiver the original communication, and offering the ability to transform. In a fourth process step 1210, the user interface determines that the incoming communication should be immediately transformed before displaying the communication to the receiver and offering to also show the receiver the original communication. This is meant to be merely a non-limiting example of how the AIA 400 may be configured to transform an incoming communication, illustrating some basic features that may be provided to the user. Transformation types, such as described herein, may also be selectable by the user through a user interface, such as improvements in readability, creating greater conciseness, providing summarization, formatting the communication, providing language cleanup, injecting context into the communication, and the like.

Augmenting incoming communications to a user may be provided through a user interface, such as providing the ability for the user to modify the communication after it's sent, ability for the receiver to interact with and provide feedback on or react to any part of the communication, ability for the receiver to transform incoming communications, collecting user preferences in the context of incoming communication, such as through iterative questions and tracking reactions, and the like. The user interface may send the content of the communications as a link reference to an object stored on a server (for example, in the cloud) that renders on the client side in an interactive form allowing: 1) a user receiving a communication to interact with and provide feedback on the communication or any part of the communication and 2) a user sending a communication to modify the communication at any point after it was sent (for example, if the user thinks of something else, finds a mistake, calms down and wishes they wouldn't have set the communication, and the like). This would enable users to control their content over time, even when sent through third-party applications (for example, email applications), where users could change and/or delete their content at any point in the future and provide a receiver with an option to modify communications they receive, such as based on their preferences.

In an embodiment, a sender portion of the user interface may provide specific feedback to help users compose communications and to increase effectiveness by targeting communications to the receiver specific profiles and preferences, such as with respect to vocabulary, style, context, accuracy, the best time to send the communication, and the like.

In an embodiment, a receiver portion of the user interface may display communications in an interactive format (for example, embedded or a pop-up web page object) allowing receivers to interact with and provide feedback on the communication even if they are not using the AIA 400 client application, which may also provide users a chance to modify the communication after it's sent. For instance, receivers may react to incoming communications by highlighting any fragment and selecting an emoji or writing a comment to it that would be immediately available to the user (for example, the user would get notified and be able to see the emoji and/or comment by opening the communication). If nothing is highlighted, the reaction may be applied to the entire communication. If the communication was sent to multiple people or shared with a group, the receiver may choose to share the reaction only with the user, with all receivers, (for example, everyone on the thread), with a subset of receivers, or keep it private but visible to AIA. AIA 400 may process the reactions and use them to improve the rules and models optimizing incoming communication for the receiver and assisting the user(s) in communication with the receiver.

The user interface may enable the receiver to transform incoming messages, providing reader (receiver) with the ability to modify communications they receive, such as with the transformations described herein. Each transformation type, such as described herein, may be provided with a separate filter that can be turned on or off. Additionally, the receiver may specify the types of incoming communication they would like the filters to be applied to automatically, while other communications are modified on demand by applying specific filters. Alternatively, users may request the system to modify specific incoming communications (for example, messages, documents, and the like, as described herein) on demand, such as by applying specific filters and/or transformations. Users may be able to view the original version of an incoming message even if the communication was automatically modified. In the process, user preferences may be collected in the context of incoming communications through iterative questions and tracking of reactions.

In an embodiment, the system may send a message (for example, content) over a network, sending a link to the message that is stored on AIA 400 servers or cloud. If the receivers have the AIA 400 installed (for example, as a browser or communication application extension), they will see the actual message instead of the link (for example, AIA 400 will display the actual message instead of the link). The receivers that don't have the AIA 400 installed, may only see the link but will be able to follow this link to view the message and interact with it (for example, in the browser). The sender may modify the message at any time, and all the receivers may be enabled to immediately see the updated version. If some receiver has an optimized version of the message open (for example, a feature of the AIA 400 augmenting incoming communication), this optimized version may automatically re-generate when the sender modifies the original message. Receivers may interact with the message and provide instant feedback (for example, by selecting a portion of the message and reacting with an emoticon or a comment). Receivers may control who sees the feedback, such as only the sender, everybody on the thread, or just the receiver and AIA (for example, so that AIA 400 could better optimize future messages for the receiver). Additionally, the users may have all the AIA 400 features for optimizing outgoing communication and augmenting incoming communication.

In an embodiment, the user interface may deliver iterative questions to a user with respect to the receiver's communication preferences and/or feedback on specific communications to hone the AIA's understanding of each receiver's preferences. These preferences may be used by the system to modify incoming communications to the receiver and/or to help the sending user(s) optimize their communication with the receiver. Receivers may be motivated to provide feedback so that the AIA 400 could better transform communications to their liking. Receivers may choose to share their feedback on incoming communications with users to provide receivers with improved versions of the modified communications of some communications they receive based on the shared feedback and preferences provided.

In transforming an incoming communication, the AIA 400 may record preferences, it may intercept incoming communication, classify it, and decide whether it should be transformed before being displayed to the reader and what transformations should be applied, as based on the receiver's preferences. Then filters can then be run based on preferences (for example, may be a combination of rule-based and machine-learning-based filter implementations). The AIA 400 can then present the transformed version to the reader based on the preferences. In an embodiment, user preferences may enable the selection of other functions, such as the receiver being able to switch between the transformed and the original versions (for example, by clicking a link or tab), be able to highlight fragments and react with an emoji or provide a comment, request to modify a specific communication that AIA 400 did not automatically modify, and the like. In an embodiment, AIA 400 may learn to modify communications of a certain type based on what the receiver requests to modify most frequently. In that case, AIA 400 may ask whether the receiver wants to always (or never) modify similar communications, or communication from certain users.

In an embodiment, the user interface and user experience may be implemented through integration with third-party platforms and communication channels (for example, as an extension or a plug-in), as a feature of a communication platform or client (for example, built into a messenger, email app, and the like), through a mobile platform (for example, communication may be composed in a dedicated mobile app), stored in the cloud, and the like. Implementation may utilize a link sent through a communication channel (for example, text message), where when the receiver clicks the link, it may launch a dedicated app or open the communication in a web browser. If the receiver is not on the platform or doesn't have the extension/app, they could get a link that would open the communication in a web browser, such as with interactive features.

If the sender modifies a communication that has already been sent, it may be updated on all clients that have it open. Synchronization between the server-side copy and the ones displayed to the sender and the receivers may be implemented using technology such as operational transformation, differential synchronization or conflict-free replicated data types. Transformed receiver-side versions may also be re-generated.

In an embodiment, the user interface may capture receiver preferences, such as for contributing to their profiles, through asking a set of questions/presenting settings during user onboarding (for example, how they would like the texts to be modified, what they would not want to see, which kind of communication they would like to always or never modify, and the like), through prompting the user to provide more answers and settings later, through tracking their communication and reactions and suggesting settings that match their communication style/behavior and reactions, and the like.

The user interface may also provide for tracking communication and content consumption habits and preferences for a receiver, providing insights and recommendations for better productivity and communication impact.

In an embodiment, the AIA 400 may augment outgoing voice and video messages. For instance, the AIA 400 may intercept a voice or a video message, check it for correctness, clarity, and effectiveness in the background, and alert the user in case any significant issues are found, and suggest improvements (for example, via text or voice output). In the process, the system may ask the user for additional details to get more context and identify a receiver if necessary for targeted or more effective suggestions. The AIA 400 may augment conversations, such as to help the user understand the reactions of the receiver(s), interpret hidden and non-verbal signals, suggest what to say next to mitigate or prevent possible tension or misunderstanding, suggest adjusting vocabulary or talking speed based on the receiver's language proficiency, and the like. The AIA 400 may augment incoming communication, such as transforming incoming communications or other content the receiver consumes into a more digestible form. For instance, the AIA 400 may summarize longer texts and messages so that processing them takes less time, rewrite texts and messages using vocabulary and readability level that the receiver would understand (for example, depending on his or her language proficiency level and background), rewrite texts and messages with respect to communication structure (for example, prose vs. bullet listings), and the like.

In an embodiment, the AIA 400 may provide the ability to augment real-time conversations being carried out through augmented reality (AR) or virtual reality (VR) platforms through an AIA AR/VR communication facility, which provides communication assistance (augmented communication) to users (senders as well as receivers). The AR/VR communication facility may be implemented through an application or application extension for a third-party AR/VR platform or a feature of an AR/VR platform, and support both asynchronous communication (improving communications that are outgoing, recorded, dictated, and the like) and real-time conversations. Although the AR/VR communication facility is described primarily with respect to AR and VR technology platforms, and the sender's point of view, the AR/VR communication facility may work with any wearable device including a microphone to capture dictated or recorded communication(s), a privacy output display capability to provide assistance and suggestions to the user (for example, an AR or VR display, smart eyeglasses, heads-up display, smart contact lenses, head-worn virtual retina display, and the like), and an in-ear speaker. Optionally, other functional resources may be utilized by the AR/VR communication facility, such as a camera to read body signals in a conversation, identify or recognize specific people in a conversation, recognize speech (from mouth movements), recognize eye movements, recognize written text, intercept video communications, and the like. Body sensors (implantable or not) may be used to capture emotions, level of stress, and the like, that may be associated with communication. A brain-computer interface may be used to capture reactions, intentions, thoughts, and the like. In an embodiment, the AR/VR communication facility may be implemented with a smart speaker to intercept voice communications, analyze them, and either translate them into better-formed text and then read back or display them in a target application for confirmation or iterations. The AR/VR communication facility may provide feedback/suggestions via voice or a companion application display (for example, smartphone, smart-glasses, and the like) before finalizing and sending a recorded communication. The AR/VR communication facility may be implemented with a VR platform to augment conversations between people as avatars in virtual reality through capturing and improving recorded communication and assisting in real-time conversations. In an embodiment, observed communication can be tracked and analyzed to generate insights and provide feedback to the user over time, such as processed on the device, processed offline, processed in a hybrid client-server system (for example, partially processed on the device), and the like, such as with offline or embedded models.

In an embodiment, the AR/VR communication facility may augment outgoing recorded or asynchronous voice or video communication. For instance, the AR/VR communication facility may intercept a voice or a video communication the user has recorded through a smart speaker or a smart device camera (for example, the ability to connect to a network via different wireless protocols can operate to some extent interactively and autonomously, such as by interacting with its user through processing voice commands/input and exchanging the data with other smart devices remotely), extract the content (for example, text and non-verbal signals from the voice tone, pauses, body language, and the like), analyze correctness, clarity, and effectiveness, alert the user in case of any significant issues, and suggest improvements. In the process, the AR/VR communication facility may ask the user for additional details to get more context and identify a receiver if necessary for targeted or more effective suggestions. For instance, a user may send an audio or video communication through an appropriately equipped headset. The AR/VR communication facility may intercept the audio or video (for example, through an integration with a message recording application, as a feature of a communication platform that supports devices with built-in cameras or microphones, and the like). The AR/VR communication facility may then process the captured audio or video and extract verbal content. With audio, the verbal content may utilize audio speech-to-text conversion, and with video, the extraction may utilize video speech-to-text conversion (for example, possibly in combination with audio speech recognition). The system may then extract non-verbal signals, such as with audio, identifying psycho-emotional state (for example, emotions, mood, stress level, and the like) and implicit intents of the user based on the tone and pitch of the voice, speech patterns (for example, pauses, interjections and other sounds, and the like, or with video, identifying psycho-emotional state (for example, emotions, mood, stress level, and the like) and implicit intents of the user (for example, based on facial expressions, posture, gestures, and the like) for identifying culture-specific body language. This may provide an accounting for possible multiple meanings and misinterpretations of non-verbal signals by the receivers. The AR/VR communication facility may then capture the context of the communication (for example, level of background noise, visual background, time of day and the like); identify the receiver, such as by obtaining an identifier from the communication platform (or by asking the user); and analyze verbal and non-verbal content for correctness, clarity, and effectiveness, given the receiver and the context of the communication. The AR/VR communication facility may then provide general feedback on the communication, such as suggesting modifications or rewrites to the communication (or parts of the communication). In the case of an asynchronous communication (for example, not yet interactive with the receiver, the user has more time and available focus, so the AR/VR communication facility may be able to rewrite longer phrases or the entire communication and present them to the user for review with a slight delay without significant disruption to the communication flow. At this point the user may decide to re-record the communication or discard the feedback/suggestions. For instance, if the user discards the feedback (such as repeatedly), the AR/VR communication facility may ask whether the user would like to mute AIA 400 for this type of communication or this receiver and update the preferences accordingly. If the user re-records the communication, the AR/VR communication facility may intercept the new recording, re-analyze, compare to the previous communication, and provide feedback on the new version (for example, providing encouragement in case of positive changes).

In an embodiment, the AR/VR communication facility may augment real-time conversations, such as to help users understand each the reactions, interpret non-verbal signals, suggest what to say next to mitigate or prevent possible misunderstanding or tension, suggest adjusting vocabulary, articulation, or talking speed based on a receiver's language proficiency, and the like. For instance, for the AR/VR communication facility operating in conjunction with a wearable AR device with built-in microphone and camera, the AR/VR communication facility may capture audio and video communication data using the wearable device. The AR/VR communication facility may process the audio and video, separating audio and video signals from individual communication parties (for example, recognizing faces and bodies in the video, extracting voices from the audio signal), matching audio and video from each communication party (for example, tracking sound direction and/or lip moves to match individuals' video and audio streams), and filtering voices and video of individuals and objects that don't participate in the conversation. The AR/VR communication facility may apply face and body tracking to the video of communication parties, such as to be able to recognize facial expressions, posture, and gestures, identify the voice of the user, identify other communication parties (for example, one or more individuals the user is communicating with) using facial or voice recognition or data/identifiers sent by their devices. The AR/VR communication facility may extract verbal content from the captured voice or lip/mouth movements (for example, using audio speech to text and/or video speech to text conversion), extract non-verbal signals from the captured voice and face/body tracking (for example, identifying psycho-emotional state of the parties, such as emotions, mood, stress level, and the like) based on the tone/pitch of the voice, speech patterns (for example, pauses, interjections and other sounds, and the like) based on facial expressions, posture, and gestures, identify culture-specific body language, identify implicit intents of the parties based on their tone, face and body language, and the like. The AR/VR communication facility may recognize other context, such as current characteristics and changes in the environment (for example, background noise, relative spatial positions of communication parties, location, geography, and the like), identify the characteristics of the users from communication profiles or audio/video (for example, native/non-native, based on the accent), and process body sensor data.

In another instance, the AR/VR communication facility may operate in conjunction with a wearable VR device, where in this example it is assumed that the conversation happens between avatars capable of speech and body language mimicking human users, controlled by human users, or generated by AI agents. In this instance, the process would begin with capturing data from a VR platform. This may be raw audio and video as in the case of AR, separate speech and visual signals from each participant, parsed data (for example, textual messages, emotion/intent signals, and the like), and/or meta-data (for example, as identifiers and characteristics of the avatars or the parties represented as avatars). The AR/VR communication facility may extract identities and characteristics of the parties, verbal content, non-verbal signals, and conversation context from available data. The AR/VR communication facility may maintain a digital representation of the conversation, splitting the verbal content from each communication party into individual communications, maintaining a digital representation of the conversation thread (for example, updating it in real time) by tracking the sequence and relations between the communications (for example, who each communication originates from, is addressed to, and which previous communications it references/answers or expands on), and associating captured non-verbal signals with individual communications (for example, tagging communications with non-verbal clues). The AR/VR communication facility may analyze incoming and outgoing communications and provide real-time assistance. For instance, the AR/VR communication facility may give the user an option to view text transcriptions of others' communications as subtitles via an VR display, such as smart eyeglasses, HUD, contact lenses, virtual retina display, or the like. This may help the user understand the communications in cases of unfamiliar accents, limited listening proficiency (for example, a user listening in a language that is not a user's native language), or inability to hear well (for example, due to background noise, hearing impairment, and the like). The AR/VR communication facility may also translate the speech from one or more languages into a language the user can understand and display the translations in a similar way. The AR/VR communication facility may augment what the user sees and/or hears with a representation of non-verbal signals from other communication parties (and possibly the user themselves for a self-check). The AR/VR communication facility may overlay the image of communication parties on a VR display with a label, an emoticon, or an ideogram indicating their psycho-emotional state (for example, emotion, mood, stress level, and the like), explaining a recent gesture (for example, a sign of a welcome, gratitude, and the like, such as in the party's culture) or possible implicit intent (for example, a desire for intimacy, a lack of interest, increase/decrease in domination, and the like), such as based on different kinds of recognized body language.

The AR/VR communication facility may warn the user when there is an increased risk of miscommunication, conflict, or ineffectiveness in the conversation, such as when the user talks too fast to someone who is a non-native speaker, the AR/VR communication facility may suggest lowering the pace or increasing articulation, or when the user uses an idiom that the other party in the conversation may not understand, the AR/VR communication facility may suggest a simpler phrasing or just display the idiom in question and recommend rephrasing it. The AR/VR communication facility may analyze the user's pronunciation and issue a warning in case of incorrectly pronounced words that may lead to a misunderstanding, and suggest the correct pronunciation (for example, with generated voice or text notation); identify a grammatical error in the user's speech and issue a warning when it may lead to miscommunication or bad perception, and display a corrected version of the phrase so that the user could repeat and correct themselves; detect inappropriate vocabulary or style choices in the user's speech and issue a warning when the other party may not perceive them well (for example, based on their communication profile), and suggest dynamically adjusting the style or language and/or call out words and phrases to avoid; detect inflammatory language or non-constructive non-verbal signals in the user's speech or body language (for example, voice tone, proximity change, and the like), and alert the user and suggest taking a pause; detect negative signals from the other party (for example, mood change, increased stress level, loss of attention/interest, and the like) and alert the user to be aware or attentive, and consider changing the course of the conversation; suggest phrases that would be appropriate at a particular point in the conversation, such as saying thank you; detect unanswered questions from the previous communication(s) and prompt the user to address them; detect when the user (for example, repeatedly) interrupts the other party and displays a warning when that happens; and the like. The warnings may be a visual or an audio alert with a short communication from AIA. The user may be able to mute/unmute the alerts and adjust the sensitivity. AIA 400 may also adjust sensitivity automatically based on the communication parties involved, the relationship between them, and the type/tone of the conversation (for example, it may mute all but most critical alerts during a casual chat between good friends and increase the threshold during a business meeting with unfamiliar participants). In an embodiment, the AR/VR communication facility may provide feedback and analytics after the conversation, analytics/statistics to the user based on the recent conversation(s), actionable feedback to the user based on how the recent conversation(s) went, and the like.

The AR/VR communication facility may detect a user's emotional or physiological state to correlate with their current communication style and reactions to previous communications, such as through biometric data from the user (for example, from a wearable device), voice indicators (for example, tone captured with a built-in microphone), visual indicators (for example, from facial expressions or body language captured with a built-in camera), and the like. For instance, a user may be wearing a wearable device or multiple devices that monitor temperature, heart rate, galvanic skin response, and blood sugar; voice signals (for example, vocal inflections, tone/pitch, volume, speech patterns, and the like), facial expressions, and body language. Measurements and changes in this data may be compared to an emotional profile, such as stored in the user's communication profile, and measurements in a population. The AR/VR communication facility may then be able to determine if these indicators are adversely affecting the user's communications, such as when a spike in body temperature, heart rate, and low blood sugar are detected, making a person more likely to communicate in a frustrated or angry manner. The AR/VR communication facility may then prompt the user to be aware of such potential influences, and offer communication adjustment suggestions (for example, taking a pause, a breath, changing the tone/language, and the like). The AR/VR communication facility may also correlate detected emotions with the content and/or context of the user and use this as training data for modules that predict reactions and also for updating the user's communication profile.

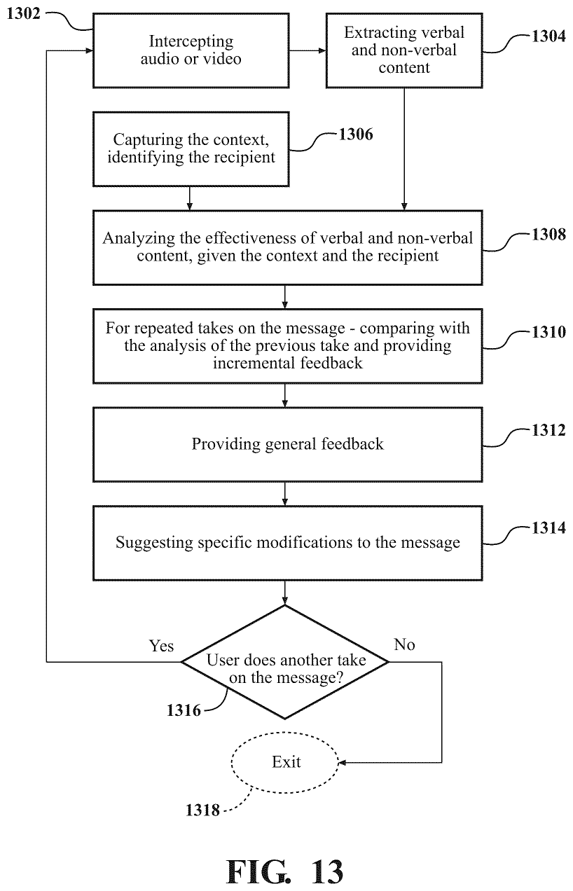

In an example embodiment, and referring to FIG. 13, the AR/VR communication facility may intercept an audio and/or video communication 1302 and extract verbal and non-verbal content 1304, which may be analyzed for effectiveness of verbal and non-verbal content 1308, given the context and the recipient, and capturing the content identifying the recipient 1306. For repeated takes on the message, the system may compare the analysis of the previous take and providing incremental feedback 1310, providing general feedback 1312, and suggesting specific modifications to the message 1314. The user may then decide 1316 whether to take on another message or not, and if yes, run through the process again, and if no exit the routine 1318.

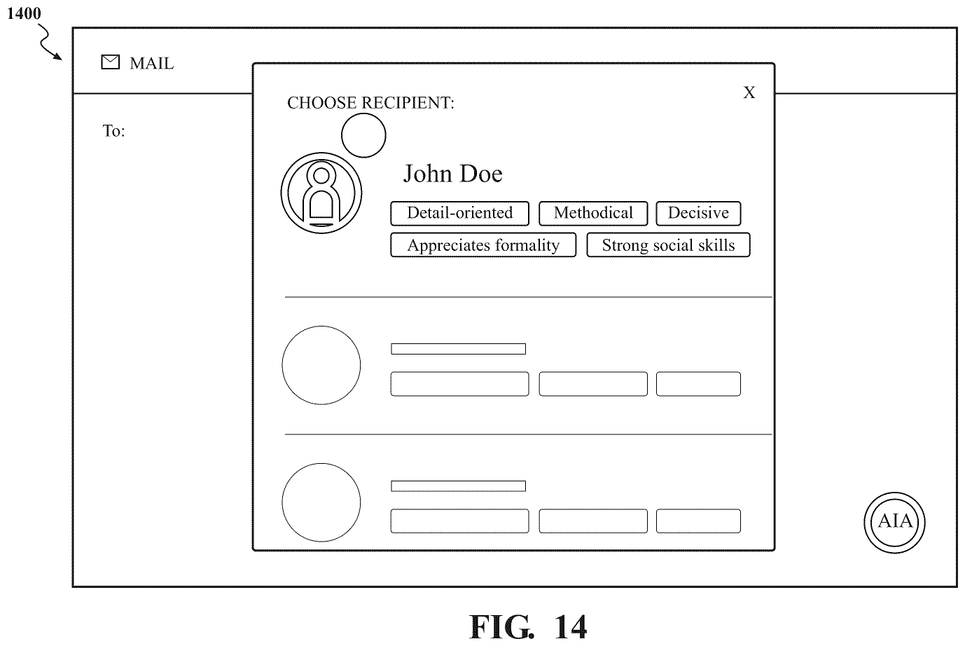

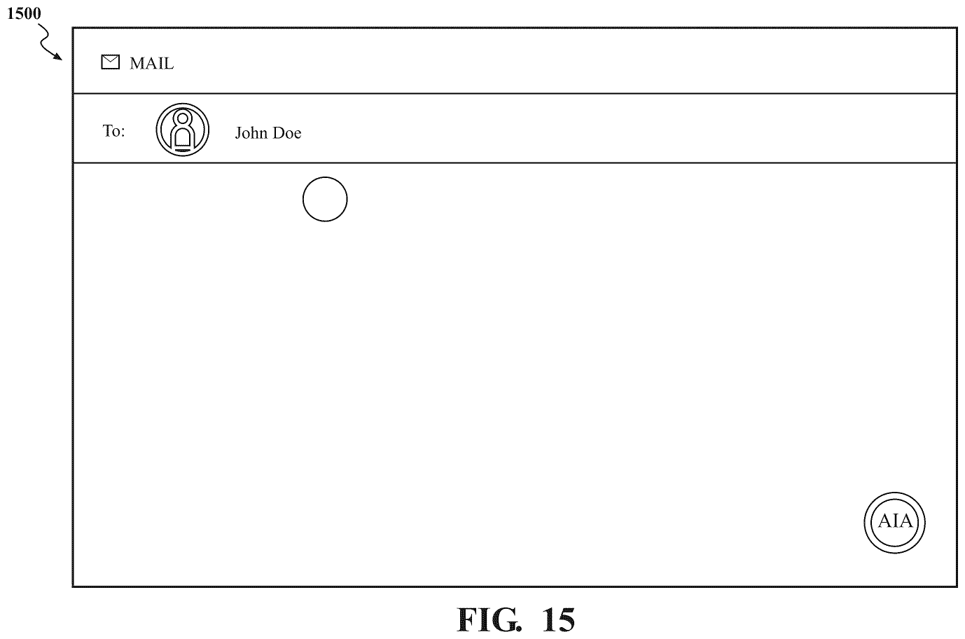

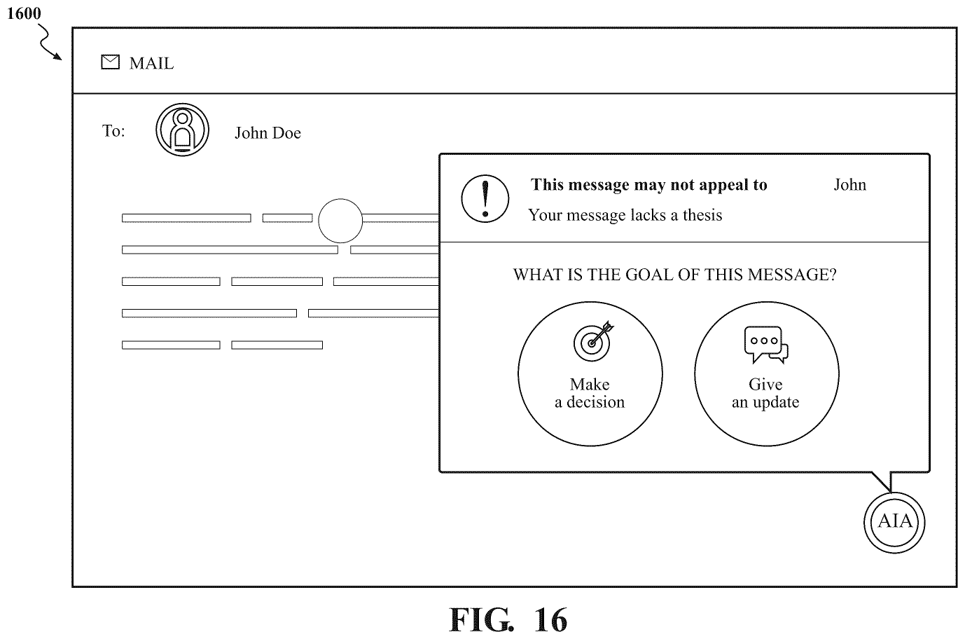

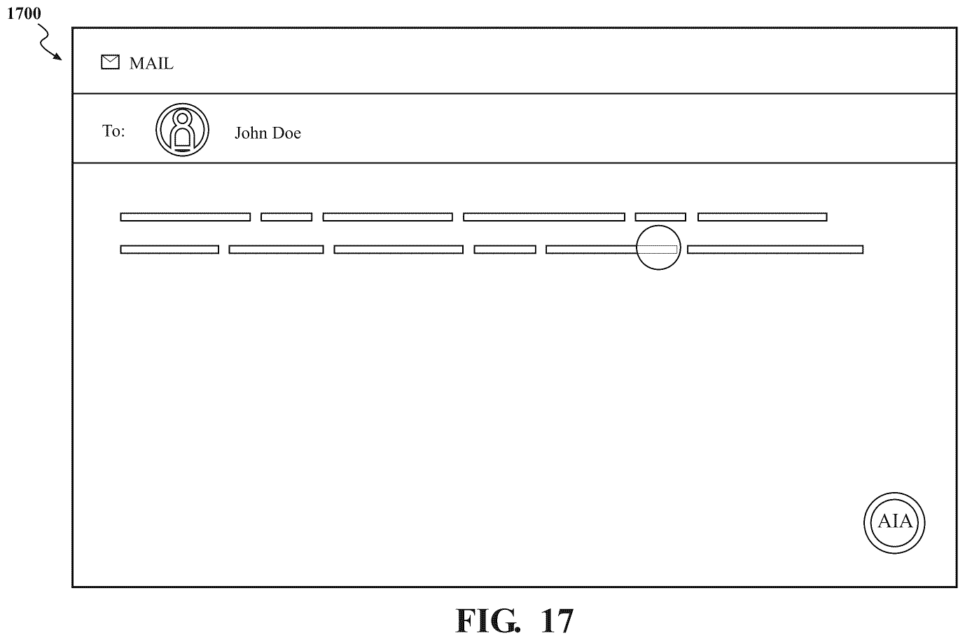

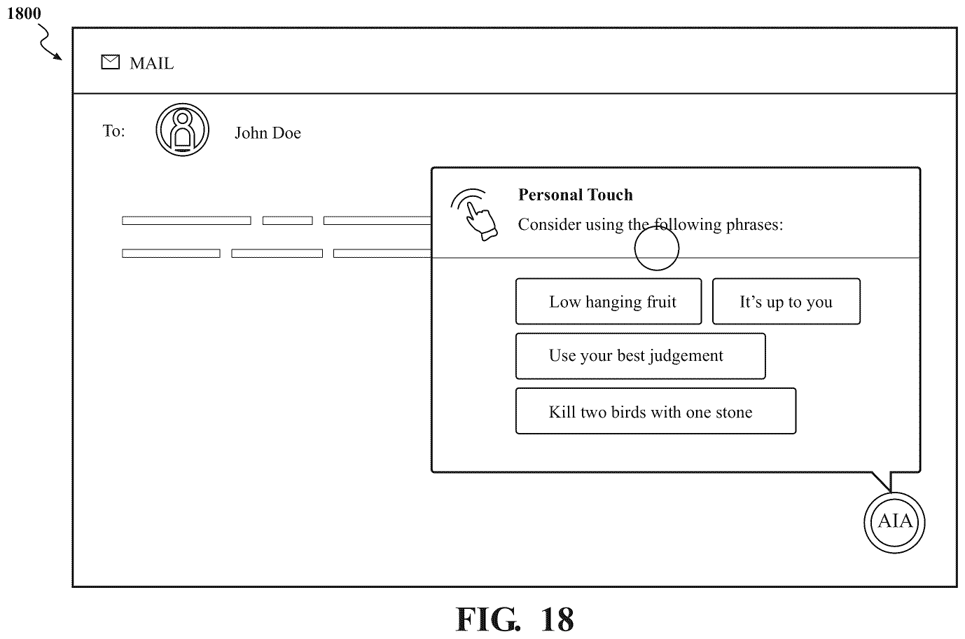

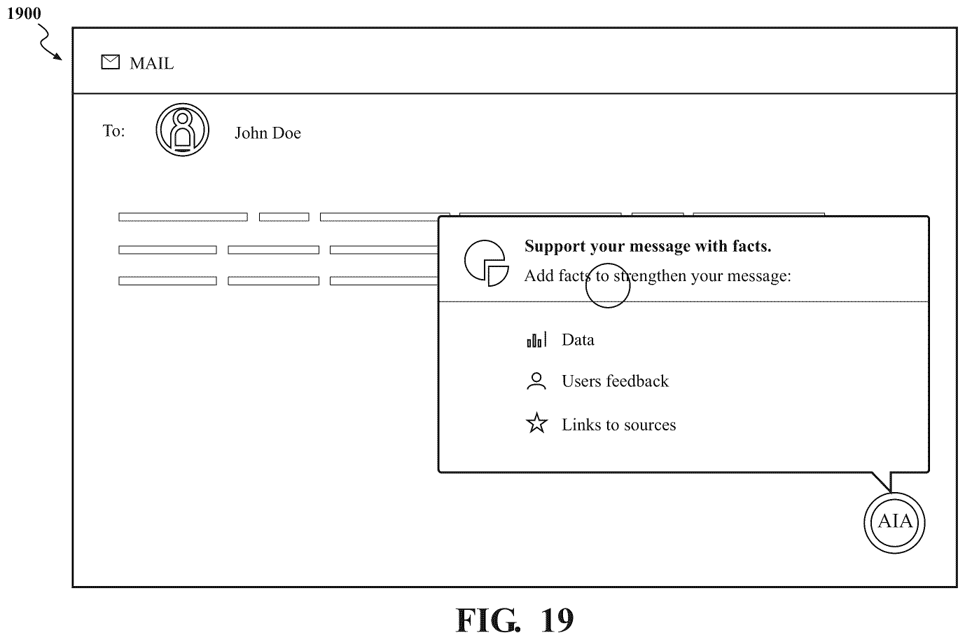

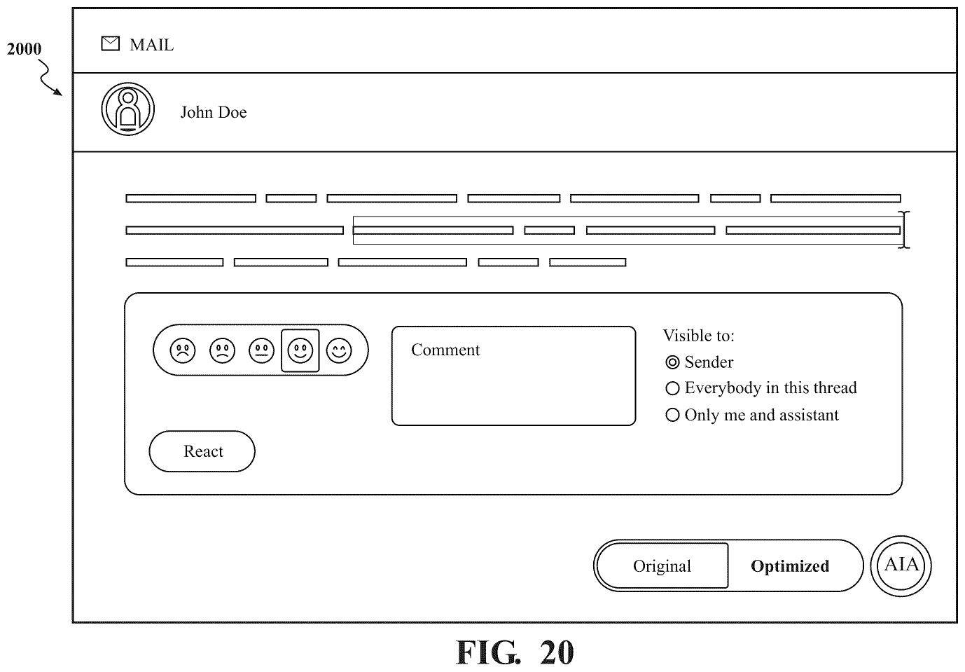

FIG. 14, FIG. 15, FIG. 16, FIG. 17, FIG. 18, FIG. 19, and FIG. 20 illustrate a non-limiting example of an interaction with a user who is generating a textual message targeted to a receiver ‘John Doe’, where the AIA 400 is assisting the user based on the receiver's communication profile. In an embodiment, the AIA 400 may also be assisting the user through access to the user and/or receiver's communication profile (for example, how does the user know John Doe), contextual information available from past interactions between the user and John Doe (for example, how well have interactions gone before), current events (for example, making a passing comment about an important item in the news where the AIA 400 has determined a level of relevancy between the event and the message), and the like. At a first computer user interface screen view 1400, the user can view aspects of John Doe's communication profile, such as including the attributes of being detail-oriented, methodical, decisive, appreciates formality, has strong social skills, and the like. This enables the user to orient themselves before beginning the process of writing the textual message to John.

At a second computer user interface screen view 1500, the user begins to draft the message. At a third computer user interface screen view 1600, the user is well along in the drafting of the message, perhaps even at the end of a first draft. The AIA 400 may automatically evaluate the text, such as continuously as the user types, at periodic points during drafting, when the user pauses, and the like. The user may also have the option of requesting the AIA 400 to evaluate the text at any point in time. In this instance, the AIA 400 provides feedback to the user that indicates “this message may not appeal to John”, and offers some indications as to why, including a note that “your message lacks a thesis.” The AIA 400 additionally prompts the user to improve the message by asking “what is the goal of this message?”, with options, including “make a decision” and “give an update”. This feedback is meant to be illustrative, and not limiting in any way, but used as one example of how the AIA 400 might attempt to aid the user in generating a more effective message. In an embodiment, the “make a decision” and “give an update” may be buttons to be selected by the user, which would lead the AIA 400 to provide further refined suggestions, such as specific suggestions as to how the message could be improved with a goal in mind. Although this illustrative example shows visual indications and suggestions, feedback to the user could be audible, or be provided as a combination of visual and audible. For instance, the AIA 400 could audibly ask the user about the goal of the message and offer suggestions. In turn, the user could audibly select a choice, such as saying “make a decision.”

In a fourth computer user interface screen view 1700, the user may view and approve a change in the message due to interaction with the AIA, continue typing, receive additional indications of text content that could potentially improve the effectiveness of the message, and the like. In a fifth computer user interface screen view 1800, the user may receive an additional suggestion from the AIA, where in this case the AIA suggests adding a “personal touch” and for the user to “consider using the following phrases”, including “low hanging fruit”, “it's up to you”, “use your best judgement”, “kill two birds with one stone”, and the like. Alternately, the AIA may make suggestions that target the receiver's language, geographic location, culture, and the like, such as suggesting idioms that the receiver is familiar with based on prior usage, geographic indicators, and the like. In an embodiment, the user may accept one of the suggestions by having the AIA insert a selected phrase into an appropriate place in the message, choose from a number of options as to where the selected phrase could be inserted, manually insert the message, and the like, where the interchange between the user and the AIA may be through visual and/or audible communication. In a sixth computer user interface screen view 1900, the AIA provides another feedback to the draft message that includes “support your message with facts”, and to “add facts to strengthen your message”, such as with data, feedback, links to sources, and the like. In a seventh computer user interface screen view 2000, the user, having improved the message through interaction with the AIA, emails the message to John Doc. Through the process of feedback and interactive suggestions, the AIA has thus enabled the user to improve the message.

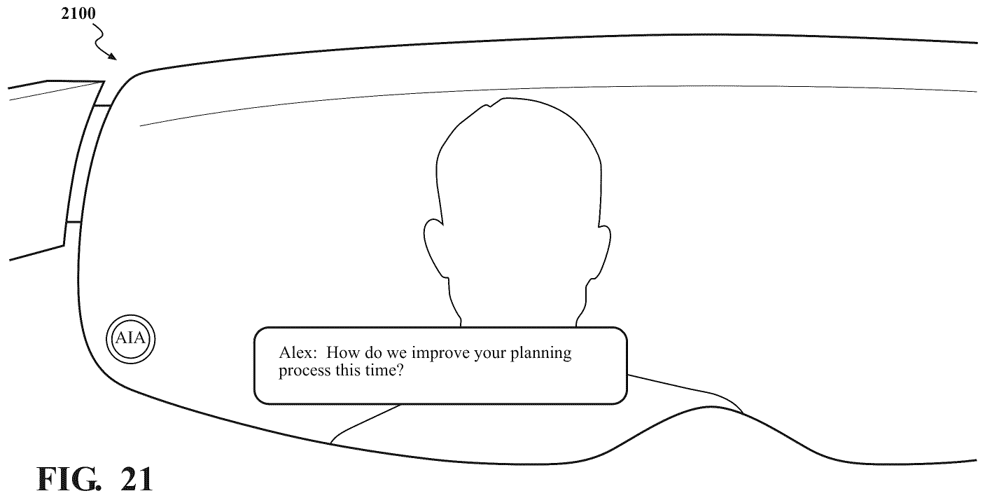

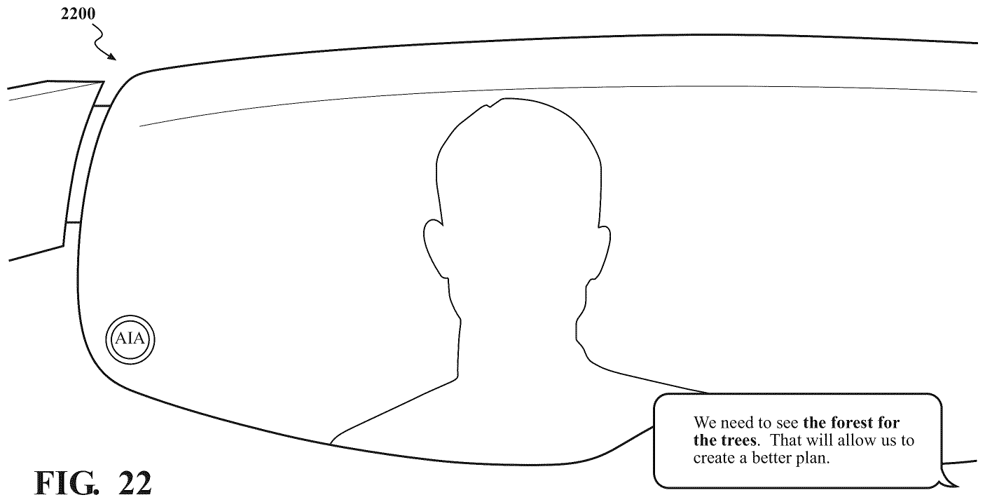

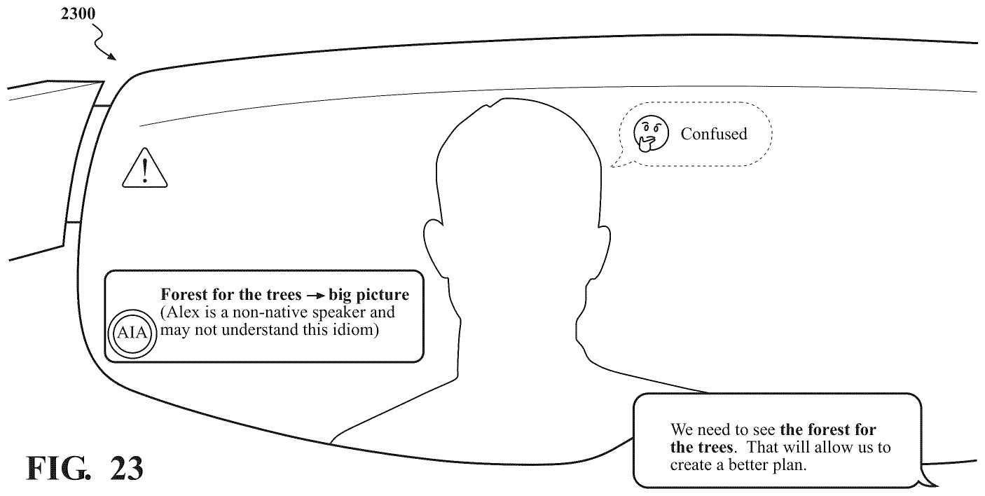

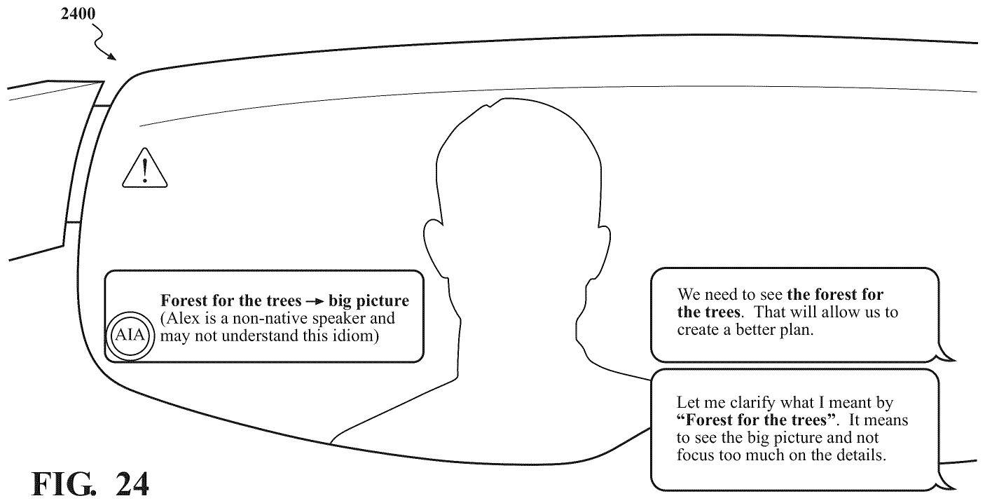

In an embodiment, the AIA may provide feedback and suggestions to the user in an automatic interactive step-wise process such as illustrated through FIG. 21, FIG. 22, FIG. 23, FIG. 24, FIG. 25, FIG. 26, and FIG. 27. Alternately, the user may elect to have the process provided in a more immediate manner, such as where the AIA analyzes the message and provides options all at once for the user to select. Further, the user may be limited by time, and thus enable the AIA to suggest an improved message without options, such as where the AIA utilizes previous interactions with the user to determine what the user is likely to select, or utilizing previous interactions with the user to select a different set of options than has been previously selected (for example, to keep the user's messages diverse), and the like.

FIG. 21, FIG. 22, FIG. 23, FIG. 24, FIG. 25, FIG. 26, and FIG. 27 illustrate a non-limiting example of an interaction of a user in an exchange with a second user (for example, face-to-face with message content and AIA feedback displayed to the user, texting with a remote receiver showing the text dialog along with AIA feedback). Although the depiction is of a textual exchange as viewed on glasses (for example, augmented reality glasses, or any glasses enabled content display facility), the exchange is more generally representative of an exchange that could be implemented an any of a variety of computer platforms, such as on a smart phone, a smart watch, a tablet, a laptop computer, and the like. Further, although the exchange is depicted as a visual presentation of the exchange, the exchange could also have been at least in part verbal, such as where the conversation between the users is verbal (for example, a phone call over a cellular network), but where the AIA feedback is presented in a visual text format for the user to read during the verbal exchange. Further, the entire exchange, including the exchange between users, and the feedback presented from the AIA, are both verbal, such as the AIA providing verbal feedback to the user as the conversation between users takes place.

In a first computer user interface screen view 2100, the user initiates a conversation with another user, saying “Alex: How do we improve our planning process this time”. In a second computer user interface screen view 2200, the user transmits a portion of conversation, “we need to see the forest for the trees. That will allow us to create a better plan.” In a third computer user interface screen view 2300, the AIA provides feedback to the user, ‘Forest for the trees’ is an idiom that Alex might not understand, as he is not a native speaker. In this instance, the AIA, having access to the receiver's communication profile, reminds the user that the receiver is a native speaker, and as such should modify the conversation appropriately. As a result, as shown in a fourth computer user interface screen view 2400, the user follows up with a clarifying statement, “Let me clarify what I meant by ‘Forest for the trees’. It means to see the big picture and not focus too much on the details.” In a fifth computer user interface screen view 2500, the user tells the receiver (by voice) “Hey Alex, I'm heading out to lunch, would you like to join?” In a sixth computer user interface screen view 2600, the AIA presents feedback to the user to “Speak slower please” to alert the user to the mismatch between the speed of the user's speech and the ability of the receiver to comprehend. In this instance, the AIA may have been monitoring the speed of the user's speech because the AIA had access to the receiver's communication profile that identified the receiver was a non-native speaker, and where the AIA then flagged speed of user speech for monitoring. Alternatively, the AIA may have determined the receiver to be a non-native speaker by monitoring the speech of the receiver. As a result of the AIA monitoring the user's speed of speech, in a seventh computer user interface screen view 2700, the user restates the passage more slowly as “If you could join for lunch, we could go to Stone or Osha. What do you think?” Throughout the conversation, the AIA, through interactive feedback, enabled the user to make real-time adjustments to the conversation to accommodate the receiver being a non-native speaker, such as where the non-native speaker may be unfamiliar with idioms of the non-native language, limited to a speed of conversation in their non-native language, and the like.

In an embodiment, the AIA may suggest a message template and/or modality based on a given goal and context. For instance, the AIA may compose a message asking whether ‘x’ will show up for dinner and deliver the message through an appropriate communication channel (for example, email, text message, and the like). In an embodiment, a communication channel may be selected based on the communication profile of the receiver, such as including data pertaining to preferences and behavior. For instance, the system may select a communication channel that the receiver uses most often or is most likely to respond to, such as based on a statistical analysis of observed behavior. In an embodiment, a message may be modified based on feedback from the AIA to the user, and then transformed or adjusted in format as necessary to accommodate the selected communication channel. Multiple formatted versions of the message may be created for multiple communication channels, such as when a user wants to broadcast a message to multiple receivers on multiple communication channels.

In an embodiment, the AIA may apply a style ‘filter’ based on a desired impact and audience. For example, a humor filter may be applied when composing a text on a smart phone to make a friend laugh, or a formality filter may be applied to improve the effectiveness of an email applying for a job. The AIA may also adjust the style or tone of a message, such as adjusting the tone of an emotionally charged message, so it is less likely to offend the receiver. For example, the AIA may help the user rewrite a message using a non-violent communication framework to alleviate conflict. The AIA may also suggest a fact or a clarifying point to a message based on world knowledge (for example, current news, historical context, and the like), shared context of the sender-receiver pair (for example, conversation history), and the like. The AIA may render the message differently and/or deliver it through different filters, styles, clarifying points, and communication channels, to different receivers (for example, sending a dinner invitation to N people in a personalized form, or rendering several versions of a news article for a number of different audiences), depending upon the goals associated with the different receivers.

In an embodiment, the AIA may provide multiple modes and levels of feedback, such as through making predictions relative to receiver reaction, message impact, and success, given the content (for example, message draft), targets (for example, goals/desired impact, audience/receiver, style/format restrictions, and the like), and context (user's communication profiles, relationship, current states/emotions, prior communication history, the environment, world knowledge, and the like) of the message. In an embodiment, the AIA may provide for a default set of messaging goals with regard to providing feedback, such as that a message should be accurate (for example, error-free), not ambiguous (for example, clear), not harmful or offensive, doesn't cause or escalate conflict, minimizes the risk of misunderstanding, and the like. Explicit goals, such as to inform, persuade, entertain, and the like, may be selected by the user.

In an embodiment, the AIA may be able to identify parts of a message that can be improved, generate alternatives, rank them, and suggest those that maximize achieving the desired outcome. For instance, the message may be determined to be too informal, and the AIA may identify plausible corrections with varying levels of formality, rank them all based on how formal they are, and present the rankings to the user for selection. In an embodiment, the AIA may provide personal communication analytics and coaching, such as including quantification and tracking of information consumption, communication patterns, and health-productivity-relationship effects, and provide advice a as a global means of providing feedback to the user.

In an embodiment, the AIA may be implemented through a number of natural language processing and machine learning methods, such as support vector machines (SVM), random forest, boosting machines, ensemble methods, matrix factorization, deep learning (for example, seq2seq models, bi-LSTMS, CNNs, RNNs, and the like), generative adversarial networks, pointer networks, unsupervised learning approaches, reinforcement learning, and the like. The AIA may use collected, acquired, or artificially created training data for training the corresponding learning algorithms. In certain an embodiment, the AIA may collect, generate or annotate training data for training the corresponding learning algorithms. These methods will cover aspects of the AIA such as a general model of language effectiveness, genre-domain model, group model (for example, groups of individuals), individual model (for example, a single targeted individual), pipelined-ensemble model structure, predictive impact modeling, language correctness model (for example, to check and correct rewrites), meaning consistency model (for example, to ensure re-writes do not alter meaning), individual-authentic style models (for example, to personalize generated language), world knowledge model, and the like. The AIA may utilize multi-layer neural networks (for example, for transferring a writing style from informal to formal using neural techniques). In an embodiment, models may be updated or retrained automatically or manually, where training data may utilize a corpus of original messages tagged with contextual information as meta-data (for example, domain and message type, message goals, user identifier, target audience or receiver identifier, modality, communication channel, triggered outcomes, and the like, such as actions and emotions), a corpus of conversations and related reactions of participants, a parallel corpus of original and revised/enhanced messages, communication history of users, feedback from users, such as the applied and rejected suggestions, survey results, and the like.

In an embodiment, the AIA may provide for automatic writing correction, which may be utilized by the AIA in providing improved communications between individuals such as described herein. For instance, in an embodiment the AIA may optionally utilize a cloud-sourced plurality of human editors in a managed human augmented automatic system, where the AIA may automatically send at least a portion of a message to the cloud-sourced plurality of human editors, such as when the AIA encounters a writing element that exceeds a perception threshold during automatic processing (for example, a threshold over which the AIA cannot acceptably understand the meaning of a passage). The AIA may manage the cloud-sourced plurality of human editors, or interface with a management system that manages the cloud-sourced plurality of human editors. For example, the AIA may evaluate a user text and encounter three portions of the user text that may benefit from enhancement with respect to the capabilities of the AIA, as described herein. However, the first portion is evaluated and determined to exceed a perception threshold, at which point the AIA distributes the first portion amongst the cloud-sourced plurality of human editors for determination of a writing enhancement. Once the AIA receives a response, the AIA may then incorporate the response, together with automatic modifications due to the second and third portions, into feedback to the user.

The AIA may provide a service to users where a combination of automatic and human interaction improves the user's communications as described herein. This human augmented AIA service may utilize a cloud-sourced plurality of human editors, a team of dedicated writing specialists familiar with the user's writing style and target audience, and the like, to provide the user with rapid response communication refinement that leverages the automatic capabilities of the AIA and the deep experience of a human writing expert. The human augmented AIA service may provide a range of combined automatic-human augmented writing enhancement, such as ranging from an augmented enhancement that relies entirely on the automated capabilities of the AIA as described herein, to a blended automation and human augmentation, to the use of a human writing expert reacting in real-time without utilizing the automatic capabilities of the AIA. In an embodiment, the AIA may manage the use of human writing experts based on user and/or receiver preferences and past behavior. For instance, when a user is composing a written communication they may indicate a preference for an extent of human personalization vs. automation, such as depending on the topic and goal of the communication, based on lead time, based on personal preferences, and the like. In an embodiment, the AIA may determine this through the user's communication profile and behavior, or as directed by the user.

In an example use-case of the human augmented AIA service, suppose the user begins composing an email to a customer and is using the AIA to work through refinements, as described herein. But then the user is interrupted and doesn't return to the drafting until the end of the business day. When the user returns to the email drafting the AIA detects that the user is behaving in a manner that indicates that the email drafting is now more urgent (for example, through a voice tone, use of language, change in editing technique, and the like), and the AIA moderates the process by incorporating a human writing expert into the process. For instance, a human writing expert could act as a monitor to the automated AIA interchange with the user and interject as needed, the human editor could interject themselves more fully into the interchange such as interacting directly with the user but utilizing the automated AIA capabilities as a tool, the AIA and/or human editor could sense a high-level of urgency from the user and have the human writing expert take over the recommendations process to expedite the process, and the like.

In another example use-case of the human augmented AIA service, suppose the user wants to utilize all the capabilities of both the automated AIA (as described herein) and the deep experience of a team of human writing experts (for example, that are assigned to work with the user). In this instance, the user benefits from all the historical, global, and predictive capacity of the AIA, plus the interaction with a human writing expert. Based on user preferences, a custom human augmented AIA service may be developed and maintained, such as to the extent the user wants the automatic AIA system or human editor to dominate in the interaction. For instance, the user may prefer the automatic AIA process as the default, where the AIA system only accesses a human writing expert when a perception threshold is exceeded (for example, a level of understanding for a particular passage or writing issue, a level of confidence in a refinement choice), or the user may prefer a human editor lead the process. In an embodiment, when a human editor is involved in a message refinement process, the human editor may utilize the AIA as a tool, acting as ‘a user’ as described herein. That is, a user may prefer a human writing expert to interfacing with, but where the human writing expert utilizes the AIA as described herein. In this user-editor-AIA configuration, the human writing expert may act as a user-proxy between the user and the AIA.

The AIA, through access to user communication profiles, goals, context, world knowledge, modality, and the like, may be able to affect modifications to a user's communications, either directly or indirectly, to increase the user's effectiveness in communications with a receiver, and thus provide a valuable facility to the user in communications amongst a diverse population of receivers and audiences.

The programmed methods and/or instructions described herein may be deployed in part or in whole through a machine that executes computer software, program codes, and/or instructions on a processor or processors. “Processor” used herein is synonymous with the plural “processors” and the two terms may be used interchangeably unless context clearly indicates otherwise. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, a microprocessor or any variant such as a co-processor (math co-processor, graphic co-processor, or communication co-processor) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions, and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In an embodiment, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, Internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, Internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, LTE, EVDO, mesh, or other network types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or another communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (for example USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams, or any other logical component may be implemented on a machine capable of executing program instructions. Thus, while the foregoing drawings and descriptions set forth functional aspects of the disclosed systems, no arrangement of software for implementing these functional aspects should be inferred from these descriptions unless explicitly stated or otherwise clear from the context. Similarly, it may be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It may further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

Certain aspects of an embodiment can be implemented using the techniques described in U.S. Pat. No. 9,002,700, the entire contents of which are hereby incorporated by reference for all purposes as if fully set forth herein.

### 2.2 Distributed Computer System Example

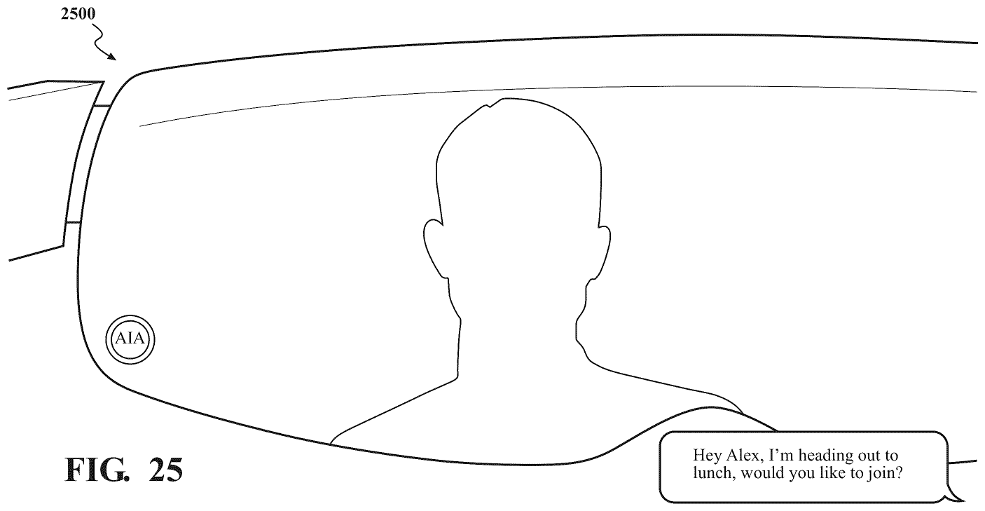

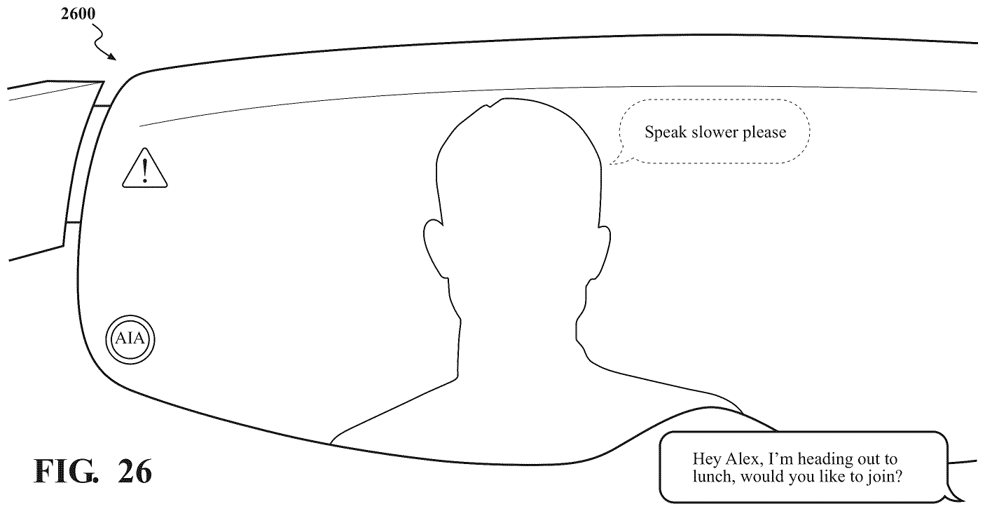

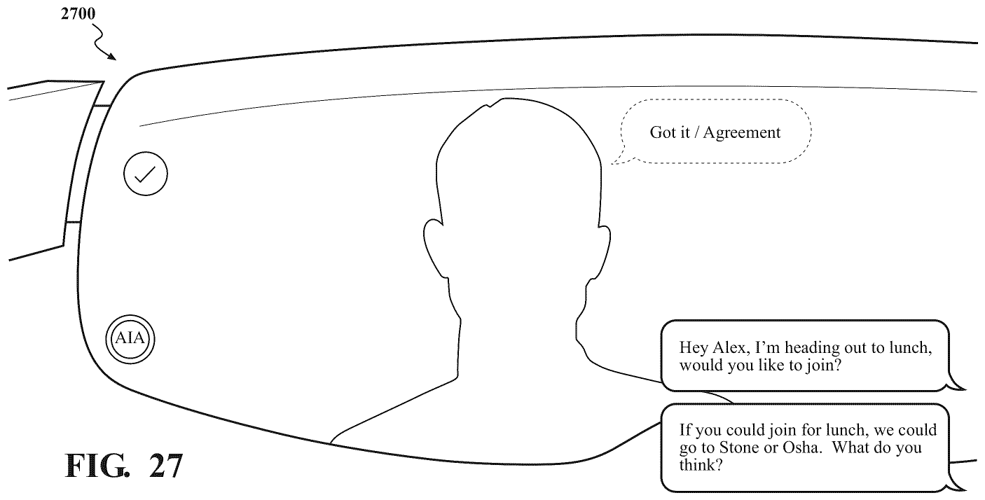

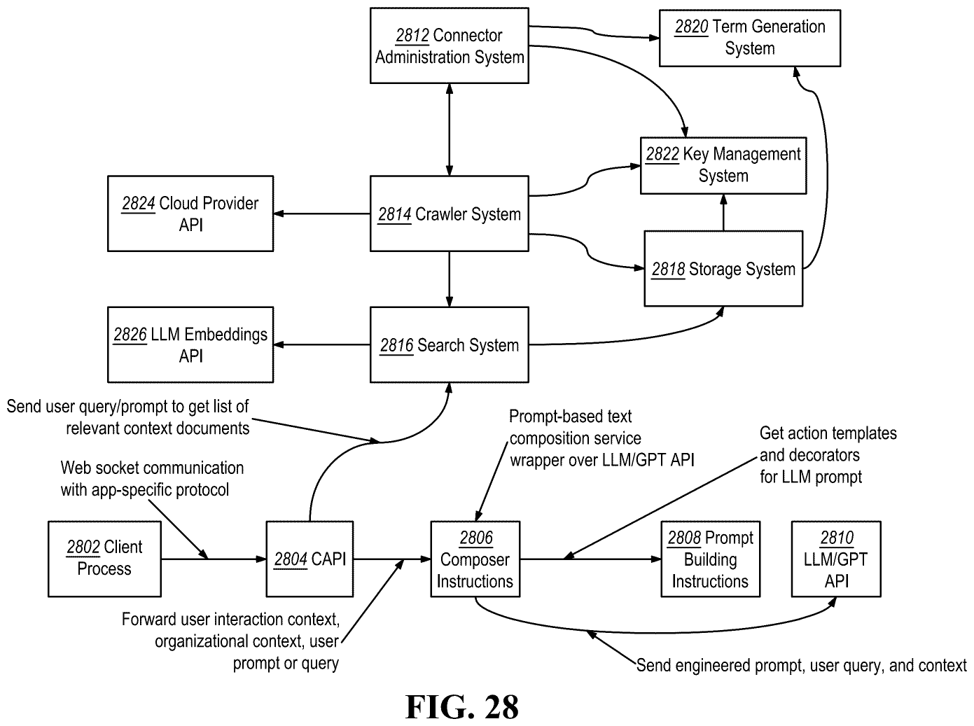

FIG. 28 illustrates a distributed computer system showing the context of use and principal functional elements with which one embodiment could be implemented. In an embodiment, the computer system comprises components implemented partially by hardware at one or more computing devices, such as one or more hardware processors executing stored program instructions stored in one or more memories for performing the functions described herein. In other words, all functions described herein are intended to indicate operations performed using programming in a special or general-purpose computer in various embodiments. FIG. 28 illustrates only one of many possible arrangements of components configured to execute the programming described herein. Other arrangements may include fewer or different components, and the division of work between the components may vary depending on the arrangement.

FIG. 28, and the other drawing figures and all of the description and claims in this disclosure, are intended to present, disclose and claim a technical system and technical methods in which specially programmed computers, using a special-purpose distributed computer system design, execute functions that have not been available before to provide a practical application of computing technology to the problem of large-scale document crawling, indexing, embedding, storage, and use in automatic prompt-based natural language text composition. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

To the extent that any drawing figure illustrates a data flow, the drawing figure is intended as an illustration of the functional level at which skilled persons, in the art to which this disclosure pertains, communicate with one another to describe and implement a computer-implemented method, as described further herein and/or algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

In the example of FIG. 28, a client process 2802 is communicatively coupled to a common application programming interface or CAPI 2804. In one embodiment, the client process 2802 comprises a text processing application that is locally installed on a client computer such as a laptop computer, desktop computer, workstation, tablet computer, smartphone, or network computer. In other embodiments, the client process 2802 comprises any of a browser extension; an extension or plug-in to an application program such as a word processor, email client program, text editor, HTML editor, web page editor, or website authoring system; or an operating system service or system application. A commercial example of client process 2802 is GRAMMARLY GO from Grammarly, Inc. The client process 2802 can use web socket communication with an application-specific protocol to access and call the CAPI 2804.

The CAPI 2804 is programmatically coupled to composer instructions 2806, which implements a prompt-based text composition service and can use a wrapper over a public API of an LLM, such as a GPT-type LLM. For example, the OPENAI API to CHATGPT can be used. The CAPI 2804 is programmed to programmatically call a method, function, or other program facility of the composer instructions 2806 and forward a user interaction context, organizational context, and user prompt or user query. The user interaction context and organizational context can be digitally stored as part of a profile of a user of the client process 2802, or obtained by reading files, tables, or other digital data storage of a storage system 2818.

The composer instructions 2806 can be programmed to programmatically call prompt building instructions 2808 to retrieve data that the composer instructions can use to assist in composing an engineered prompt to the LLM. For example, composer instructions 2806 can retrieve or read action templates and decorators for the LLM prompt. The composer instructions 2806 are further programmed to call the LLM/GPT API 2810 and send an engineered prompt, user query, and context.

In response to receiving a response from the LLM, the composer instructions 2806 are programmed to format, filter, and/or return the response to the CAPI 2804, which can further format or filter the response and transmit a final response to the client process 2802.

The preceding description presumes that the search system has previously crawled and indexed a large corpus of documents and accessed definitions or other resources relating to terms in the documents, to form the capability to generate the list of documents that are relevant to the context of the user prompt or user query. In an embodiment, the following functional elements execute to create a searchable index of documents that could be relevant to the user prompt or user query. A connector administration system 2812 is communicatively coupled to a crawler system 2814, a term generation system, and a key management system 2822. With these programmatic connections, the connector administration system 2812 can retrieve from the key management system 2822, one or more keys to encrypt or decrypt credentials, and can list available connection configurations.

The crawler system 2814 is configured to programmatically call or access a cloud provider API 2824, the key management system 2822, the search system 2816, and the storage system 2818. The search system 2816 is configured to programmatically call or access the storage system 2818 and an LLM embeddings API 2826; the search system also receives calls from the CAPI 2804, as previously described. The next section describes these components in further detail.

### 2.3 Example System Components

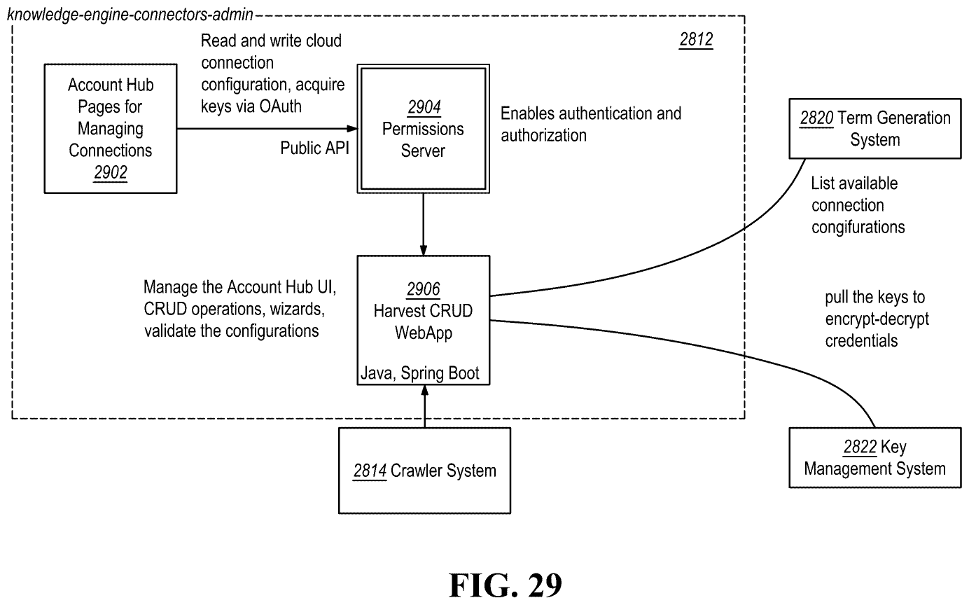

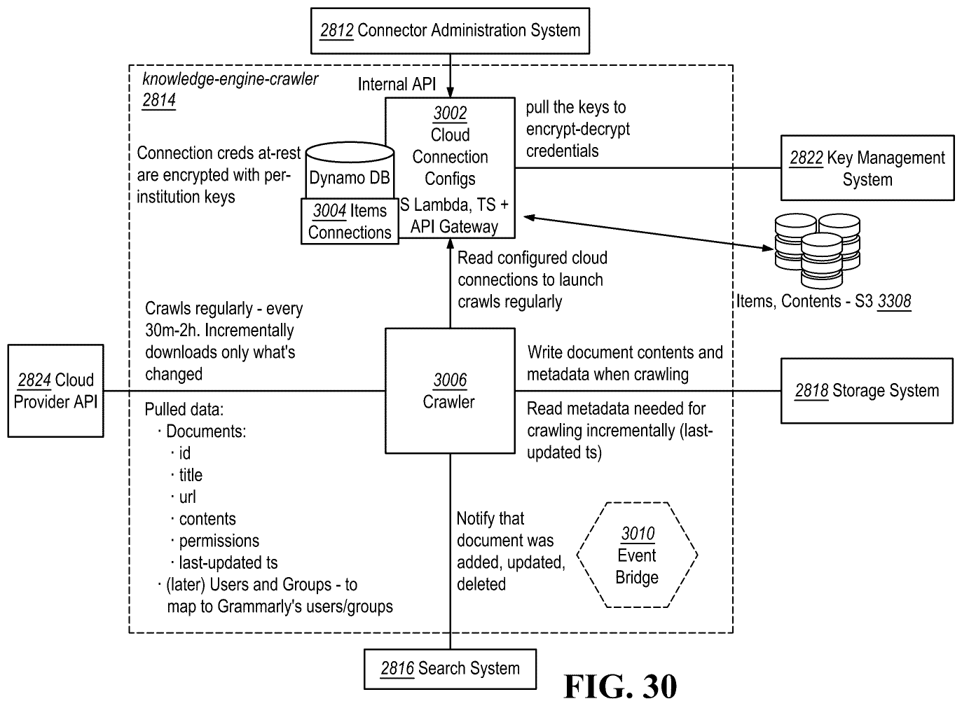

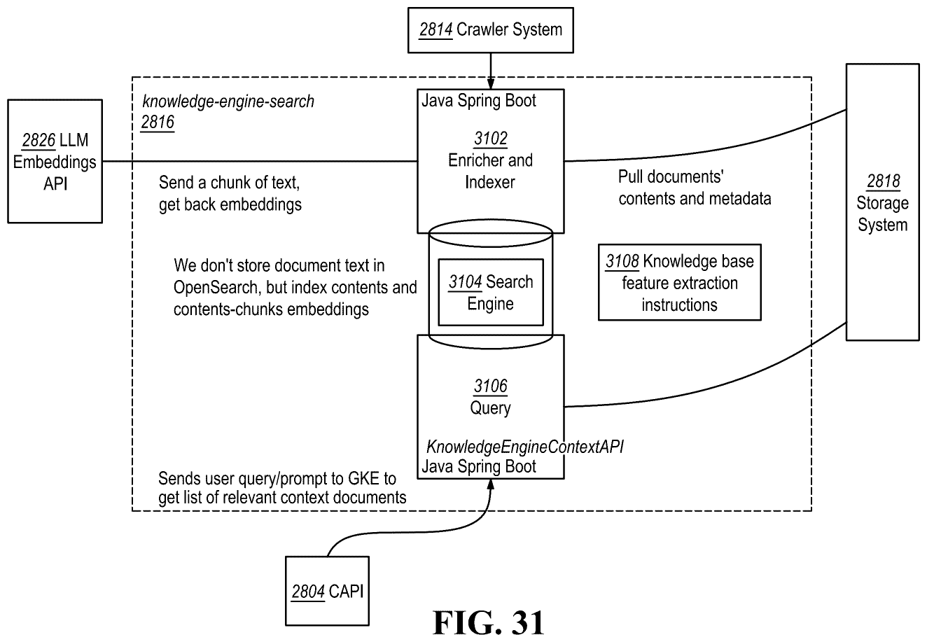

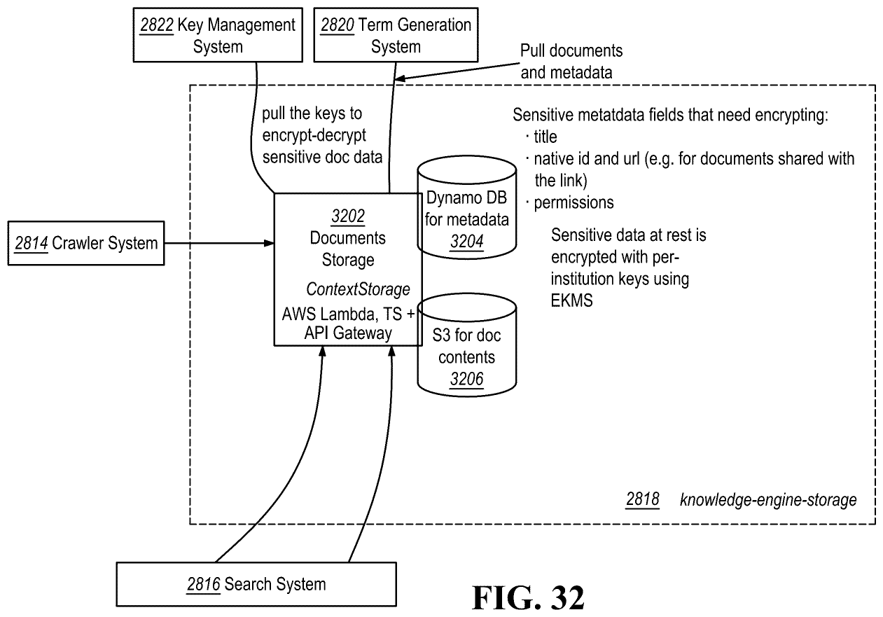

FIG. 29 illustrates an example of structural architecture and data flow for the connector administration system of FIG. 28. FIG. 30 illustrates an example of structural architecture and data flow for the crawler system of FIG. 28. FIG. 31 illustrates an example of structural architecture and data flow for the search system of FIG. 28. FIG. 32 illustrates an example of structural architecture and data flow for the storage system of FIG. 28. Referring first to FIG. 2, in an embodiment, the connector administration system 2812 generates and manages input for a set of digitally stored account hub pages 2902, which are configured or programmed to manage connections. A “connection,” in this context, refers to a programmatic link between the system of FIG. 28 and an external application program or system, such as a document management system, issue tracking system, or cloud storage system. Examples of such systems include CONFLUENCE, JIRA, GOOGLE DRIVE, BOX, MICROSOFT ONEDRIVE, IMANAGE, and so forth. The account hub pages 2902 are programmed to receive input from an administrative user to name a connection, specify the external service that the connection accesses, acquire keys via OAuth or other protocols to enable secure access to the secure service, and read and write connection data.

In an embodiment, the connector administration system 2812 further comprises a permissions server 2904, which the account hub pages 2902 can access via API calls. The permissions server 2904 is programmed to enable the authentication and authorization of users. For example, permissions server 2904 maintains data storage with data representing enterprises, users, administrators, and other roles and can determine, for a specified logged-in user, which data or documents that user is entitled to access or use in the other parts of the system. In an embodiment, the connector administration system 2812 further comprises a harvester CRUD web application 2906, which can be based on SPRING BOOT, to manage a user interface for the account hub pages 2902 and execute CRUD operations and/or wizards as well as validate configurations of connections. The harvester CRUD web application 2906 can access the key management system 2822 programmatically to pull keys to encrypt or decrypt credentials and can interact with the term generation system 2820.

Referring now to FIG. 30, in an embodiment, the crawler system 2814 comprises a cloud connection configuration service 3002, a database 3004 of items and connections, a crawler 3006, and cloud storage 3008 for items and contents. In an embodiment, the cloud connection configuration service 3002 implements programmatic functions to access records in the database 3004 of items and connections, and to respond to calls from the crawler 3006 to read the connections to enable performing document reading or crawling operations regularly or periodically. Thus, the database 3004 is configured to digitally store data specifying items and connections that the crawler 3006 should crawl, based on prior user interaction with the connector administrator system 2812 to define the connections. The cloud connection configuration service 3002 is programmed to access the key management system 2822 to obtain keys to encrypt or decrypt credentials to enable the crawler 3006 to crawl documents that are stored using a specified connection. The cloud connection configuration service 3002 is programmed to persistently store items and connections in cloud storage 3008; for example, AMAZON S3 buckets can be used for longer-term storage.

The crawler 3006 is programmed to read the configured cloud connections to launch crawls of documents or other resources regularly. The crawler 3006 is programmed to access external cloud-based resources, as represented in connections, by calling the cloud provider API 2824 associated with the resources. Crawls typically occur approximately every 30 minutes to two hours, but other intervals can be used in other embodiments. When the crawler 3006 accesses a resource specified in a connection, the crawler 3006 is programmed to read or retrieve substantive data and metadata for items of the resources. For documents, the crawler 3006 can be programmed to read an identifier, title, URL, contents, permissions, and a timestamp indicating a date-time of the last update to the file that has been read. For users and groups, the crawler 3006 can be programmed to read user account details. While obtaining data from crawling, the crawler 3006 is programmed to write document contents and metadata to flat files and/or relational tables in the storage system 2818. The crawler 3006 is programmed to read the storage system to obtain metadata needed to support incremental crawling; for example, the timestamp values can be compared to the current time from a system clock to determine whether a file or other resource should be read and ingested into the storage system 2818, or whether the file or other resource has not changed and therefore can be skipped.

In one embodiment, the crawler system 2814 further comprises a programmatic connection to an event bridge 3010, such as a publish-subscribe service, event bus, or messaging bus. The crawler 3006 can be programmed to call the event bridge 3010 to announce or publish a notification that a particular document was added, updated, or deleted, as crawling operations occur.

Referring now to FIG. 31, in an embodiment, the search system 2816 comprises an enricher-indexer 3102, search engine 3104, and query processor 3106. In an embodiment, the enricher-indexer 3102 comprises a set of stored program instructions that are programmed to retrieve the contents and metadata for documents from the storage system 2818, to call the LLM embeddings API 2826 to send a chunk of text and retrieve machine learning model embeddings in response, and to update a digitally stored index of document contents and contents-chunks embeddings in the search engine 3104. In an embodiment, the search engine 3104 is implemented using open-source software such as OPENSEARCH; in this embodiment, the substantive contents of document text are not stored in the OPENSEARCH system, but instead, an index for the contents and contents-chunks embeddings are stored. To support indexing, the enricher-indexer 3102 can be programmed to call knowledge base feature extraction instructions 3108.

In an embodiment, the query processor 3106 is programmed to receive a query from the CAPI 2804, extract terms for searching against the index that the search engine 3104 manages and call the search engine with terms for searching. The query processor 3106 also is programmed to create and store a list of responsive items from the search engine 3104 and provide the list in a response message to the CAPI 2804.

Referring now to FIG. 32, in an embodiment, the storage system 2818 comprises a document storage unit 3202, a first database system 3204 for metadata, and a second database system 3206 for document contents. In an embodiment, the document storage unit 3202 is programmed to receive documents from the crawler system 2814 and store the documents in a cloud-based large-scale storage system. For example, storage like AWS LAMBDA could be used. In one embodiment, document storage unit 3202 is programmed to store metadata in the first database system 3204 and to store document contents in the second database system 3206. The two database systems can be selected and managed based on tradeoffs between access speed and scale of storage. For example, DYNAMO DB can be used for metadata as the first storage system 3204 and AMAZON S3 could be used for document contents as the second storage system 3206. Sensitive metadata fields such as document title, native identifier and URL, and permissions can be encrypted using strong encryption such as AES-256. Sensitive documents can be encrypted with per-institution keys using the key management system 2822; in this manner, FIG. 32 can implement a multi-tenant system in which the users of one enterprise customer of the system cannot read, update, create, or delete the data of a different enterprise.

### 2.4 Methods of Generating a Prompt for a Response by A Large Language Model

Various aspects of the disclosure describe computer-implemented methods that can be used to obtain results of a prompt or a query from a client device to a large language model (LLM). For generality, the prompt of a query from the client device is referred to here as request data. Furthermore, the input for an LLM is generally referred to herein as a prompt, while the context data related to such a prompt is referred to as prompt-associated context.

The request-related data may further incorporate request-related context. This context can enhance the relevance and accuracy of the response generated by the LLM in response to the request data. Request-related context includes various types of information that can accompany the primary request.

Specifically, it can include data from an email thread, such as the subject, body, and metadata from email conversations related to the user's query. This email data provides valuable insights and details that the LLM can use to understand the background and specifics of the query.

Additionally, the request-related context can include session information for the device (for example, client device) from which the request to the LLM originates. This session information might include data about the current session, previous interactions (for example, previous requests from that client device or requests associated with a particular user account), response preferences (for example, receiving responses in a specific format or style), and ongoing tasks associated with a particular user account (for example, projects currently being managed from the user account).

Furthermore, request-related context may include any suitable text data that is part of the request data. Request-related data may include both the query itself and additional text. For example, the request data could include a query such as “What are the latest updates on Project Alpha?” along with a brief summary of recent project milestones. This additional text provides valuable context that enhances the relevance and accuracy of the response generated by the system.

It should be noted that queries within the request-related data can vary in complexity and may include multiple statements, multiple questions, as well as conditional statements and questions. These conditionals can be evaluated based on a response from an LLM. For example, the following prompt illustrates how conditionals can be used within request data: “Please describe the animals living on Flores and Rinca islands. If these animals include lizards, please provide details on the types of lizards found there and whether they pose any danger to tourists.”

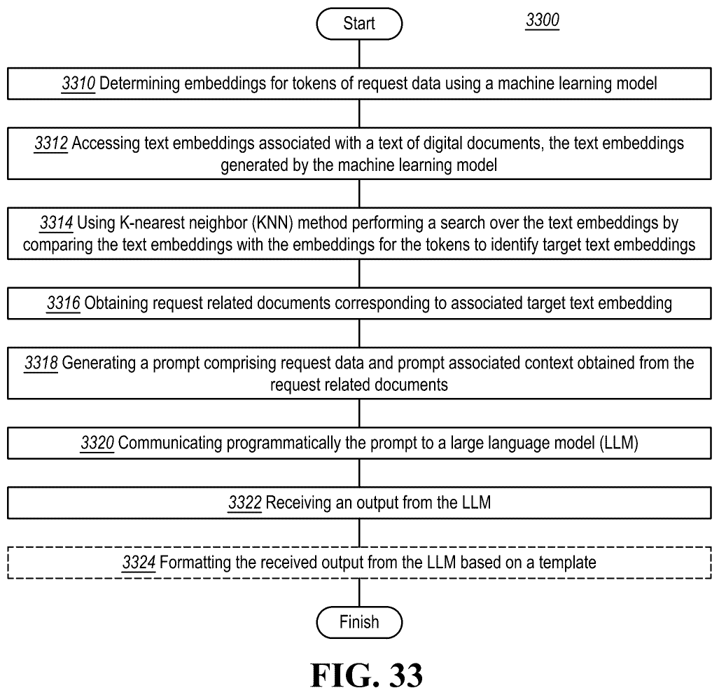

An illustrative computer-implemented method 3300 for generating a response based on a request is shown in FIG. 33. Method 3300 can be executed using any suitable computer system. For example, it may be performed by a computer system that utilizes a CAPI such as CAPI 2804 and includes various components as illustrated by system in FIG. 28. This computer system may incorporate a search system for retrieving documents or other digital content from various data storage systems. Additionally, it may include different subsystems and modules configured to execute the steps of method 3300.

In various cases, the computer system is designed to interact with external computer devices, resources, applications, and virtual systems, such as collaborative software tools (for example, Confluence) or Google Drive, or any other suitable system. It is equipped with one or more application programming interfaces (APIs) for interacting with these external computing resources. For instance, the computer system may be configured to interact with databases and data stores to retrieve documents. When such systems include indexing for documents and text embeddings, the computer system is designed to access this indexing or embedding data via a suitable interface.

In various cases, an administrative interface of the computer system may be configured to provide functionality to set up connections with such external systems, ensuring that the computer system is well integrated with external resources. For example, when integrating with Google Drive, the administrative interface can personalize the computer system for the organization using it. The connection between the computer system and Google Drive (or any other suitable external system) may use the organizational context from public Google Docs documents for information that can be used for drafting documents within the organization. To set up the integration, the administrative interface provides the capability to log in to the Google Cloud Platform, navigate to the Google Cloud Console, and generate a service key in JSON format. This key is used to authorize the integration and grant domain-wide delegation of authority.

The administrative interface ensures that the service key has the necessary Open Authorization (OAuth) scopes required for the application. It also provides functionality to configure the integration within the computer system account by providing the service key and other required authentication information. Once the integration is successfully set up, the computer system can generate more relevant outputs for the team by leveraging the organizational context from Google Docs.

In some cases, the data store can be integrated into the computer system, allowing it to update files, perform searches, and update indexing and text embeddings associated with these files. The data store may include a knowledge-sharing system configured to store various terms associated with an organization, project, group, or business. This system maintains a database of definitions, explanations, and documents corresponding to specific terms used by the organization. For example, an organization involved in “Project Alpha” may store related definitions, explanations, and documents in the knowledge-sharing system, making “Project Alpha” a knowledge-shared term. Data from the knowledge-sharing system can be accessed via the computer system using any suitable API.

Method 3300 includes, at step 3310, determining embeddings for tokens of request data using a machine learning model (MML). In one illustrative embodiment, tokens are first generated from the request data before the embedding is determined. The generation of tokens involve a series of preprocessing steps to transform the raw text of the request data into a format that can be used by machine learning models. This process begins with text normalization, where the text is converted to lowercase, punctuation and special characters are removed, and contractions are expanded to ensure uniformity and reduce variability. Following normalization, the text undergoes tokenization, which splits it into smaller units called tokens. Depending on the method used, these tokens can be words, subwords, or (in some cases) individual characters.

Once tokenized, each token can be mapped to an integer index using a pre-defined vocabulary, which is a collection of all unique tokens the model understands. This mapping process assigns a unique integer to each token, converting the text into a sequence of numerical indices.

The process of determining embeddings involves transforming these indices (or tokens) into numerical vectors using embeddings, which are dense vector representations of tokens in a continuous vector space. Each token index is mapped to a corresponding embedding vector. For instance, the sentence “The quick brown fox jumps over the lazy dog” would be normalized, tokenized into [“the”, “quick”, “brown”, “fox”, “jumps”, “over”, “the”, “lazy”, “dog”], mapped to integer indices, and finally converted into embedding vectors for further use.

The embedding process involves converting text into numerical representations called embeddings. These embeddings capture the semantic meaning and relationships between words, allowing machine learning models (MLMs) to process and understand text more effectively.

To generate embeddings, the tokens are mapped to numerical vectors through various embedding techniques. One common approach is Word2Vec, which uses a shallow neural network to learn word associations from large text corpora. Word2Vec includes two models: Continuous Bag of Words (CBOW) and Skip-gram. CBOW predicts the target word from its context, while Skip-gram predicts the context using a given word. Both methods are effective in capturing the semantic and syntactic relationships between words.

Another method that can be used is GloVe (Global Vectors for Word Representation), which leverages global word co-occurrence statistics from a corpus to learn embeddings. Unlike Word2Vec, which focuses on local context windows, GloVe captures global statistical information, producing embeddings that reflect the overall word relationships in the corpus.

Furthermore, FastText, developed by Facebook, can be used for embedding. It extends the functionality of Word2Vec by considering subword information, making it particularly effective for morphologically rich languages. It represents words as a combination of character n-grams, allowing it to generate embeddings for rare and out-of-vocabulary words.

Additionally, or alternatively, transformer-based models like BERT (Bidirectional Encoder Representations from Transformers) include advanced embedding techniques by incorporating context from both directions (left and right) of a word, leading to more nuanced and context-aware embeddings. Transformers use self-attention mechanisms to weigh the importance of different words in a sequence, providing a deeper understanding of context.

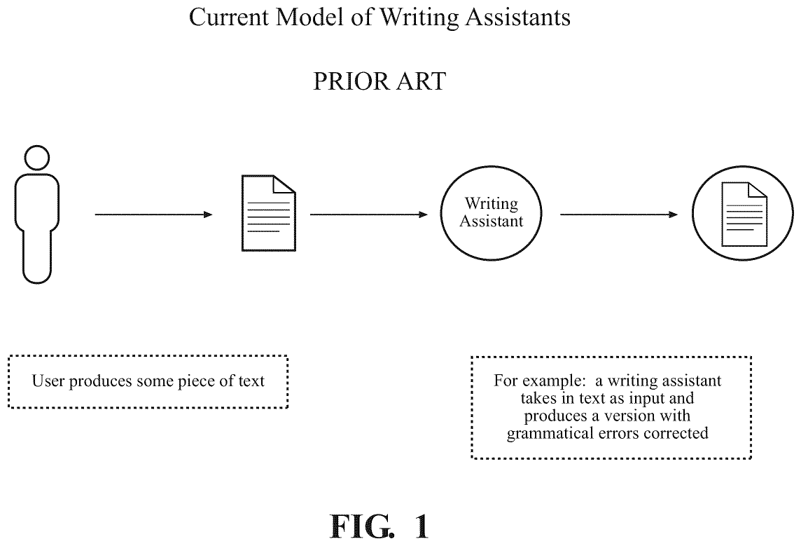

Further, at step 3312, method 3300 includes accessing text embeddings associated with texts of various digital documents. Accessing such text embeddings may be performed after the documents have been suitably organized by a suitable data store system that may be associated with a search system and a crawler system, as described above in relation to FIG. 1.

In various cases, the documents are searched using a search system associated with the computer system that performs steps of method 3300. The search system is configured to perform searches over multiple documents given a prompt by following a process involving indexing, text embedding, and querying. Initially, each document undergoes text processing, which includes tokenization (breaking the text into smaller units like words or phrases) and normalization (standardizing the tokens by converting to lowercase, removing punctuation, and handling synonyms and stopwords). An inverted index is created, mapping tokens to their locations within the documents, which facilitates quick retrieval of search terms across the indexed documents. Additionally, metadata such as the document title, author, publication date, and user-related information (for example, the user who created or last modified the document) is stored to enhance search relevance and filtering.

Text embedding involves converting text into numerical vectors that capture the semantic meaning and relationships between words or phrases using machine learning models like Word2Vec, GloVe, FastText, or BERT. Each document is converted into embeddings at various levels of granularity, such as word, sentence, paragraph, or document level.

When request data is received, the computer system processes it by tokenizing and normalizing it, as previously described. If embeddings for the tokens are used, the system converts the request data into an embedding vector using the same embedding model applied to the documents.

At step 3314, method 3300 includes using the K-nearest neighbor (KNN) method to perform a search over the text embeddings by comparing the text embeddings with the embeddings for the tokens to identify target text embeddings. The KNN method identifies the closest embeddings in the vector space, indicating the most similar texts related to the tokens of the request data. This step finds relevant documents based on the semantic similarity between the prompt and the document contents. The target text embeddings are used to determine which documents will then be retrieved, herein referred to as request-related documents.

Using the KNN method, the similarity between the embeddings for the tokens and the text embeddings for the documents can be determined using measures like cosine similarity. Cosine similarity measures the cosine of the angle between two vectors, indicating how similar they are, with a value closer to 1 meaning greater similarity. The search system can also take into account additional document characteristics, such as the document's date, the associated user, and other relevant metadata. These factors help refine the search results to ensure they are relevant to the user's request.

At step 3316, method 3300 includes obtaining request-related documents corresponding to the associated target text embeddings. The request-related documents are retrieved and can be ranked based on relevance, determined by factors such as term frequency-inverse document frequency (TF-IDF), embedding similarity scores, and the additional metadata and context. This ranking process may prioritize more recent documents, documents created or modified by specific users, or documents with higher relevance scores based on their content and metadata.

In some cases, tables of contents of documents can be searched, and tables of contents can be indexed. Further, for more simplistic searches, only document titles can be searched, depending on the requirements of the search. Additionally, a regular keyword-based search may be performed first to identify a subset of documents, and a search based on embeddings can be used to further refine the search.

A keyword-based search is a search technique where the search engine looks for documents containing specific keywords provided in the search query. This method involves matching the exact words or phrases in the query with the text in the documents. It is straightforward and efficient for finding documents that contain specific terms, but it may not always capture the context or semantic meaning of the query, especially if the exact keywords are not present in the document.

In some scenarios, the search can be used to produce specific sections from within the documents that are relevant to the request data, providing more precise and useful results. To perform a search for specific sections, the search engine first indexes the documents by dividing them into smaller sections, such as paragraphs or sentences, and creating embeddings for each section. When a query is received, the search engine compares the query embeddings with the embeddings of these sections using methods like cosine similarity or K-nearest neighbor (KNN). This process identifies the sections with the highest semantic similarity to the query. The search engine then retrieves and ranks these sections based on their relevance. This approach ensures that even if the entire document is not relevant, the most relevant parts are still obtained based on the request data.

At step 3318, method 3300 includes generating a prompt comprising request data and prompt-associated context obtained from the request-related documents. The prompt can be generated in a few ways.

One approach involves concatenating entire documents of high ranking, above a certain threshold, to the request data. This means that the most relevant documents identified during the search process are appended to the original request. These documents are selected based on their relevance scores, which are calculated using factors such as term frequency-inverse document frequency (TF-IDF), embedding similarity scores, and additional metadata like the document's date and the associated user. The threshold ensures that only the most pertinent documents are included, enhancing the quality and relevance of the prompt.

Another approach involves including specific sections from the relevant documents that are highly related to the request data. These sections are chosen based on their individual relevance scores, which are also ranked above another threshold. This method focuses on extracting and appending only the most relevant parts of the documents, rather than the entire documents, making the prompt more concise and targeted. The relevance of these sections is determined using measures such as cosine similarity or the K-nearest neighbor (KNN) method, which compare the embeddings of the sections with those of the request data to ensure semantic alignment. These sections may also be concatenated with the request data.

Additionally, request-related context, such as an email chain, session information, historical request data, and similar elements, can also be incorporated into the prompt as part of the prompt-associated context. This includes the subject, body, and metadata from email conversations related to the user's query.

If the request data is associated with a query in the form of a template with placeholders, generating the prompt can include filling up the template with the prompt-associated context. This can be achieved, for example, by using a suitable large language model (LLM) to identify which placeholder needs to be replaced with which context from the prompt-associated context. This process might involve using embeddings for placeholders and comparing these embeddings with those associated with different text sections of the prompt-associated context.

By incorporating entire documents, specific sections, and request-related context like email chains that meet high relevance thresholds, the generated prompt ensures that the context provided is both comprehensive and highly relevant. For example, the prompt template may include:

Using related documents and information for “Project Alpha” fill out the template
below:
Title: [Project Alpha Title Placeholder]
Introduction: [Introduction Placeholder]
Summary of Document Processing Workflows: [Document Processing Placeholder]
Effectiveness Analysis: [Effectiveness Analysis Placeholder];
Please describe how the document processing workflow for Project Beta is different
from the document processing workflow for Project Alpha and describe the expected
effectiveness for Project Beta.

Consequently, when generating the prompt, the placeholders in the above template can be populated using a first suitable LLM with associated information based on the prompt-associated context. Subsequently the prompt can be used as an input to another second LLM to generate a response to query “Please describe how the document processing workflow for Project Beta is different from the document processing workflow for Project Alpha and describe the expected effectiveness for Project Beta.” In some cases, it might be advantageous to indicate which actions should be performed by the first LLM and which actions should be performed by the second LLM. For example, the prompt template may be constructed as follows:

```
  Using second LLM:{
    Using first LLM:
      {Using related documents and information for “Project Alpha” fill out the
      template below:
      Title: [Project Alpha Title Placeholder]
      Introduction: [Introduction Placeholder]
      Summary of Document Processing Workflows: [Document Processing
      Placeholder]
      Effectiveness Analysis: [Effectiveness Analysis Placeholder];}
Please describe how the document processing workflow for Project Beta is different from
the document processing workflow for Project Alpha and describe the expected
effectiveness for Project Beta.}
```

The request data can include any suitable prompts, can include templates as described above. Further, the request data may also include decorators comprising elements or structures added to the prompt to enhance, modify, or contextualize the prompt. For example, a decorator may be an adjective describing a tone or a style of a text. For instance, a decorator may include “present a response as a business proposal,” “present a response using a casual tone,” “present the response for high school students,” “provide a response using bullet points,” “present the response emphasizing the historical context,” “provide examples within the response,” “emphasis practical application when providing the response,” “present the response from the environmental perspective,” and the like.

At step 3320, method 3300 includes programmatically communicating the prompt to an LLM. The LLM can be any suitable model, like ChatGPT. In some cases, the LLM may be a sequential transformer model, which uses a series of transformer layers to process input text. Hierarchical transformer models can also be used. Furthermore, bidirectional contextual models can be used. These models can enhance the capability of LLMs by processing text in both forward and backward directions. Further attention-based encoder-decoder models can be used. Such LLMs include an encoder that processes the input text and a decoder that generates the output text. The encoder uses attention mechanisms to capture important features from the input, while the decoder constructs the output word by word. In some cases, sparse transformer models, which use sparse attention mechanisms to focus on the most relevant parts of the input text, rather than attending to every word equally can be used. Additionally, a mixture of experts' models can be used. These models employ a combination of specialized sub-models, each focusing on different aspects of language understanding and generation.

At step 3322, method 3300 includes receiving an output from the LLM in response to the provided prompt.

In some cases, method 3300 includes an optional step 3324 of formatting the output from the LLM based on a template. This formatting involves organizing the information received from the LLM into placeholder fields of the template, displaying the information in an appropriate style, and presenting it through a graphical user interface that allows for further interaction through suitable actions.

In various cases, when parsing request data into tokens, tokens corresponding to one or more knowledge-shared terms may be identified. This identification can be performed by comparing the tokens with a list of knowledge-shared terms available to the computer system executing steps of method 3300. Once the knowledge-shared terms are identified within the request data, method 3300 may optionally include retrieving from data storage at least one document corresponding to the knowledge-shared term. For example, when the term “Project Alpha” is identified within the request data, data related to “Project Alpha” are retrieved. Such data may include explanations regarding what Project Alpha is, users associated with Project Alpha, milestones for Project Alpha, and other relevant information.

In various cases, additional steps may be employed to enhance the results obtained from the LLM. For example, after the initial prompt is generated, an action can be performed based on the information available in the prompt. Upon receiving this action, the computer system can generate a new context and merge it with the existing prompt-associated context to create a new prompt. This new prompt includes both the original request data and the newly generated context. This process allows the system to dynamically adapt and refine the prompt, ensuring that the generated responses are more accurate and relevant to the user's needs.

In one implementation, the action may involve summarizing a text within the prompt-associated context. For example, if the prompt-associated context contains a detailed report, the action could be to summarize this report, thereby generating a more concise and focused context that is then merged with the original prompt to form the new prompt. This summarization helps distill essential information, making it easier for the system to generate precise and useful responses. Additionally, or alternatively, the action may include requesting examples for a set of features described in the initial prompt.

In some variations of method 3300, a report may be generated based on the prompt-associated context. This report consolidates and organizes the information retrieved in response to the request data, presenting it in a structured and comprehensive manner. In some cases, the report may be displayed within a graphical user interface that allows for interaction, such as clicking on different terms within the report, selecting options for various terms, or clicking on knowledge-shared terms. Once the report is generated, the system can receive an action triggered by the user in response to the content of the report. This user action serves as new input that prompts the system to retrieve additional request-related documents. By responding to user interactions with the generated report, the system can dynamically adjust and expand the scope of the information it provides, ensuring that the user receives the most relevant and up-to-date data.

For instance, the user action might involve clicking on a link presented within the generated report. This link could be associated with a specific section of the report, such as a reference to a related document or a highlighted term that the user wishes to explore further. When the user clicks on this link, the system interprets this action as an indication of the user's interest in additional information related to the clicked link. Consequently, the system retrieves new documents that are pertinent to the user's query, refining the search results based on this interaction. This capability allows for an interactive and iterative process, thereby continuously improving the prompt for the LLM. Using this approach, the user's input directly influences the subsequent retrieval and presentation of information.

In some variations of method 3300, an interface for receiving actions related to one or more terms within the request data can be provided, such as a graphical user interface, as described above. This interface allows users to interact with specific terms, giving them the ability to influence how the search is conducted. For example, the user may choose to exclude certain terms from the search process. When an action is received via the interface indicating that the search over the text embeddings related to these terms should not be performed, the computer system adjusts its search strategy accordingly.

The interface typically comprises a graphical user interface (GUI), which can facilitate intuitive and efficient interaction. For instance, the action might include clicking on one or more terms within the interface. By clicking on these terms, the user can signal that they do not want the search to include the text embeddings of those specific terms.

Furthermore, the interface can be designed to display both a list of request-related documents and/or the output from the LLM. This dual display setup provides a comprehensive view of the information retrieved and generated by the system. Users can easily see which documents are associated with their request and review the responses generated by the LLM. In some cases, an action can be performed to remove some of the documents from the list of documents and resubmit the prompt without those documents to obtain a new output. Additionally, if the list of documents is determined to be incomplete, a user may facilitate the computer system to search for additional content (for example, by clicking on a term or a group of terms for which additional information needs to be collected) and provide it as part of the prompt. Subsequently, the prompt can be used again with the LLM to obtain the output. Prior to obtaining the output, the list of documents may be presented to the user. If the list of documents is deemed unsatisfactory, no prompt will be provided to the LLM.

Another variation of method 3300 involves using multiple LLMs. In this approach, a second LLM, different from the first LLM used for generating outputs based on the prompt, is employed to rewrite text data from the prompt-associated context based on a specific decorator. A decorator, in this context, refers to elements or structures that modify or enhance the prompt, such as altering the tone or style of the text. The new context is generated by incorporating the output from the second LLM, which has rewritten the text according to the specified decorator. The second LLM may be used multiple times until the appropriate prompt is generated. Once the final prompt is prepared, it is provided to the first LLM to produce the desired output.

In some cases, the second LLM may retrieve additional context and append it to the prompt-associated context. This expanded context can then be used to generate the prompt as described above. It should be noted that the second LLM can be used in conjunction with actions performed based on the information available in the prompt, ensuring that the prompt is continuously refined and optimized before being processed by the first LLM. This multi-LLM approach allows for sophisticated text processing and customization, leveraging the strengths of different models to achieve the desired output.

In some variations of method 3300, text embeddings may be generated from the tables of contents of digital documents. This involves creating numerical representations of the content within these tables, capturing the semantic relationships and meanings of the words and phrases. Additionally, method 3300 may include parsing request data into tokens and performing a keyword-based search to identify relevant digital documents. This initial keyword search helps narrow down the document pool by matching specific terms in the request data with terms in the documents. Subsequently, in some cases, the resulting document pool can be further refined using an embedding approach, as discussed herein.

In various cases, knowledge-shared terms often include abbreviations or other non-dictionary words that do not have standard semantic definitions like regular words. These terms require a specialized approach to ensure their meanings are accurately captured within the system. In one variation of method 3300, a process for determining embeddings for a token of request data that corresponds to a knowledge-shared term involves accessing embeddings for tokens that are associated with at least one document related to the knowledge-sharing term. For example, if the knowledge-shared term is “Project Alpha,” the system would access embeddings for tokens found in documents related to “Project Alpha.” These embeddings represent the semantic meaning of the tokens within the context of those documents.

Once these embeddings are accessed, the next step is to determine an aggregated embedding for the accessed embeddings. This aggregation can be done by various methods, but one approach is to average the accessed embeddings. Averaging involves calculating the mean value of the embeddings for each dimension, resulting in a single aggregated embedding that encapsulates the overall semantic meaning derived from all the accessed embeddings. This aggregated embedding then serves as a comprehensive representation of the knowledge-shared term within the context of the request data.

In some variations of method 3300, an additional step involves determining a measure of relevance for each document from the request-related documents in relation to the request data. This measure of relevance helps the computer system rate documents based on their pertinence to the user's query. Once this measure is determined, the system prevents the generation of prompt-associated context for any document whose relevance measure falls below a specified target threshold. This ensures that only the most relevant documents contribute to the context used for generating responses, thereby enhancing the accuracy and usefulness of the output.

To elaborate, the measure of relevance for a document can be determined using the K-nearest neighbors (KNN) method. Specifically, the relevance is calculated based on the distance between two vectors: the first vector represents the embeddings for the tokens in the request data, and the second vector represents the text embeddings for that document. Embeddings are numerical representations of text that capture the semantic meanings and relationships between words or phrases. By calculating the KNN distance between these vectors, the system can quantify how closely related the document is to the request data. A smaller distance indicates a higher relevance, and documents that do not meet the target relevance threshold are excluded from contributing to the prompt-associated context. This selective inclusion based on relevance ensures that the generated prompts are both contextually rich and highly pertinent to the user's needs.

In various cases, a variation of method 3300 may include receiving a template prompt that contains at least one placeholder. A template prompt is a predefined structure or format designed to be partially filled in with specific information. These placeholders act as markers within the template, indicating where pieces of data should be inserted. Upon receiving the template prompt, the system replaces the placeholder with either the request data or the prompt-associated context.

Furthermore, the template prompt can contain multiple placeholders, each designated to be filled with different types of information. In one implementation, at least one placeholder is replaced with a query associated with the request data, while another placeholder is replaced with the prompt-associated context. For instance, a template might include placeholders for specific user queries, relevant document excerpts, or additional contextual information. The computer system can be configured to dynamically fill these placeholders based on the request data and the context it has gathered, ensuring that the constructed prompt is detailed and relevant.

### 2.5 Example of a Workflow and Interaction of System Components for Prompt Generation

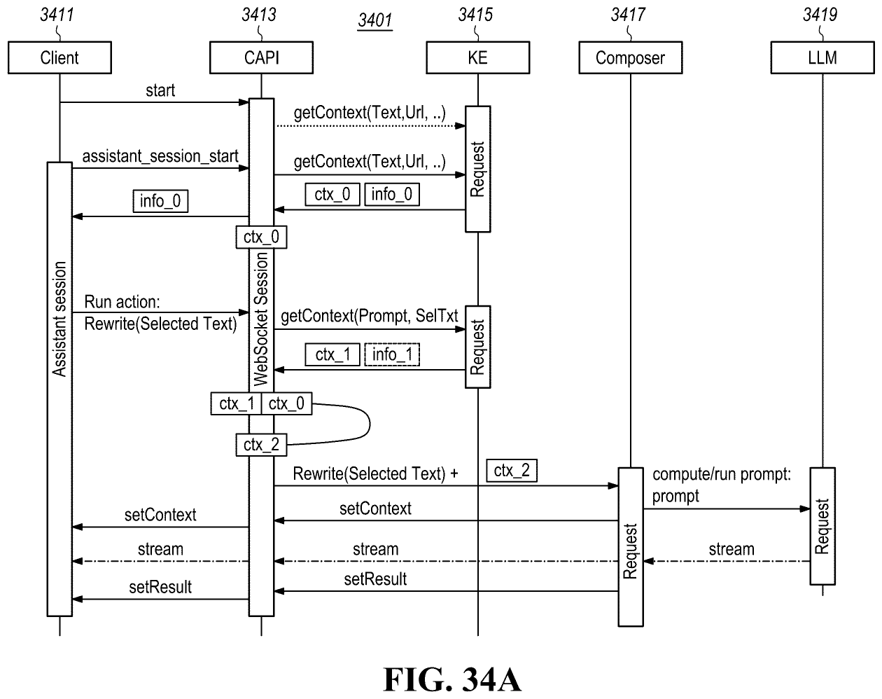

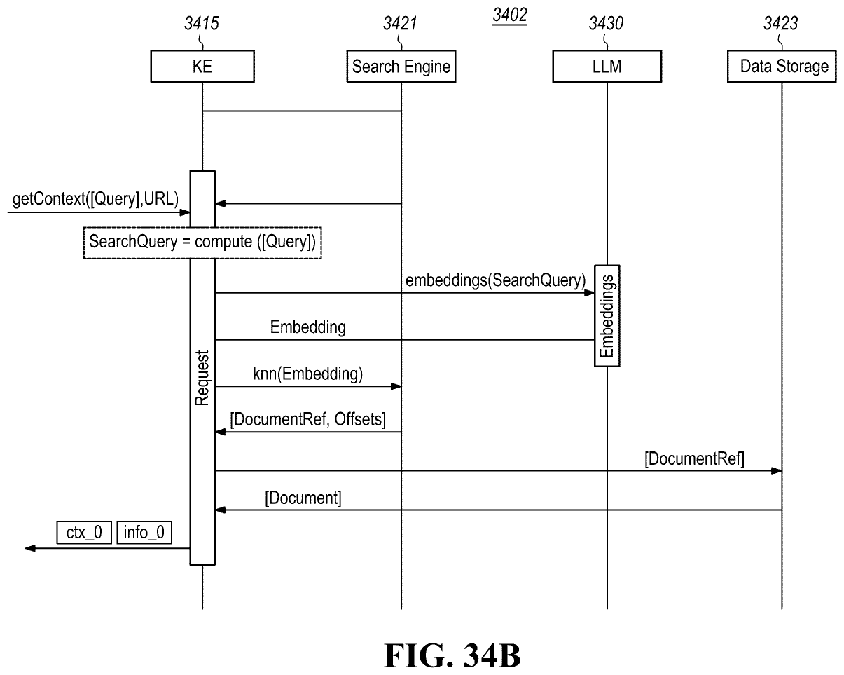

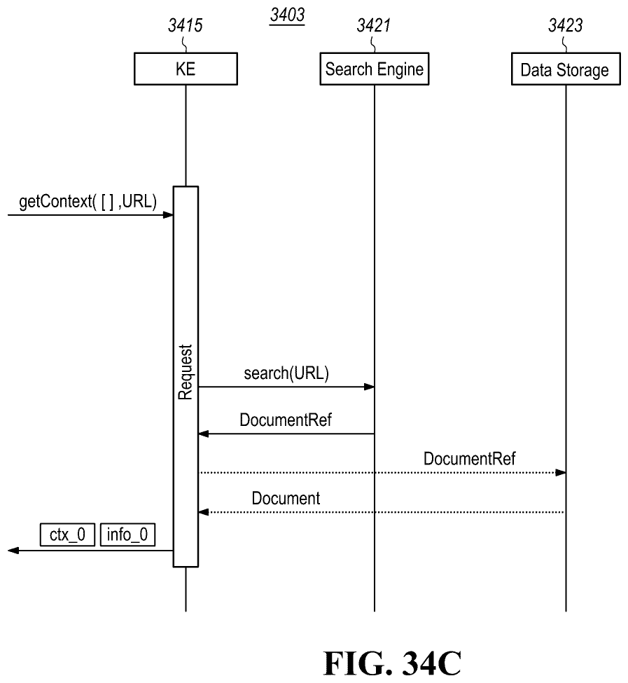

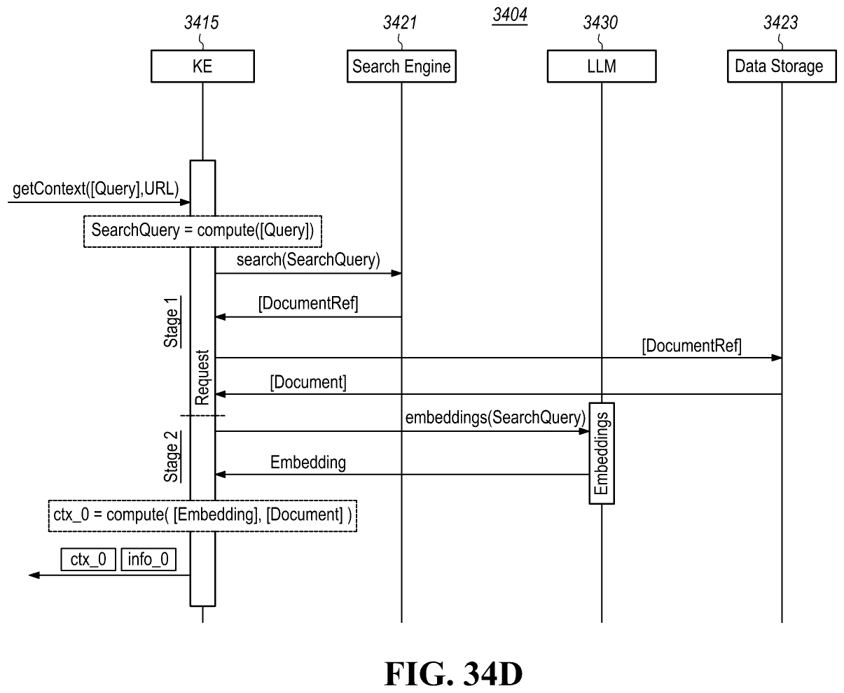

The following description outlines the detailed workflow and interaction processes that facilitate data communication between various system components. This workflow is used to generate a prompt for a Large Language Model (LLM) to obtain a response. These processes are illustrated through FIGS. 34A-34D, highlighting the roles of key components such as the client device (Client 3411), Common Application Programming Interface (CAPI 3413), Knowledge Engine (KE 3415), Composer 3417, Large Language Model (LLM 3419), OpenSearch 3421, and S3 storage 3423, as shown in FIGS. 34A-34D.

FIG. 34A shows a workflow process 3401. Process 3401 begins with Client 3411 initiating a session and sending a request containing request data to CAPI 3413. CAPI 3413 retrieves context information related to the request from KE 3415, which manages and stores contextual data. This context information, referred to as ctx_0 and accompanied by info_0, is then utilized to perform specific actions. The information info_0 can be used for actions such as rewriting a selected text or retrieving additional context or related information from various sources. The ctx_0 is stored for further use when generating a final prompt for the LLM. Based on the specific actions (for example, rewriting selected text, where a portion of text containing request data is selected to be rewritten), additional context such as ctx_1 and associated information info_1 can be retrieved. Multiple iterations of retrieving content may be performed in response to multiple actions. For example, FIG. 34A shows that ctx_0 and ctx_1 can be retrieved due to various actions and combined into ctx_2. Subsequently, ctx_2 and the request data are communicated to Composer 3417, which organizes the received data into a prompt. This prompt is then provided to LLM 3419, and the results from LLM 3419 are delivered back to Client 3411.

Please note that in FIG. 34A, context ctx_0, and ctx_1 are fetched in advance from KE 3415. Fetching the context prior to submitting the request helps avoid delays during the actual session, as the required context is already available. Additionally, the context can be revised, updated, deleted, or otherwise edited before generating the prompt for LLM 3419.

FIG. 34B illustrates the search and retrieval process 3402 involving KE 3415, OpenSearch 3421, LLM 3419, and S3 3423 storage. The process begins with request initialization, in which KE 3415 receives a request. The request can include a query and potentially a URL, which are encapsulated in the getContext function call. The getContext function is designed to retrieve the context. Next, KE 3415 determines the actual search query that needs to be executed from the incoming request via the function call SearchQuery=compute ([Query]). This computation involves analyzing the query and transforming it into a format suitable for the search, such as including only keywords and tokens, while omitting some of the original query words.

In the next step, KE 3415 submits the search query to calculate embeddings using LLM 3419. Note that LLM 3419, as shown in FIG. 34A, might differ from another LLM used in this process. The step of calculating embeddings is crucial for effectively comparing the query against the stored document embeddings. As depicted in FIG. 34B, the embeddings are then returned to KE 3415.

Subsequently, the embeddings generated by LLM 3419 for the search query are sent to OpenSearch 3421. OpenSearch 3421 performs a K-nearest neighbors (KNN) approximation to search over pre-calculated embeddings. These embeddings are derived from chunks of the documents and their prefixes, typically the first 8,000 characters. This method ensures a quick and efficient search by focusing on the most informative parts of the documents. In various embodiments, the KNN search identifies the top two chunks from the document embeddings that are most like the query embeddings. These chunks are retrieved from storage S3 3423, which stores the document data. The retrieved chunks are returned to KE 3415 as ctx_0. This context (ctx_0) is computed using the original document context and the chunk offsets retrieved from OpenSearch. This ensures that the context is accurately aligned with the search query.

The context ctx_0, along with any additional information (info_0), is then used to respond to the initial request. This context provides the relevant document sections that match the user's query, ensuring useful context for the prompt for LLM 3419, as shown in FIG. 34A.

FIG. 34C illustrates a process 3403 for retrieving info_0 using KE 3415, OpenSearch 3421, and S3 3423. The process begins with KE 3415 initiating a getContext function call with a URL as an argument. This function call is designed to fetch context-related information based on the provided URL. First, KE 3415 sends a search request to OpenSearch 3421 using the URL. OpenSearch 3421 then searches its index for the URL. If the corresponding document is indexed, OpenSearch 3421 retrieves a reference to the document (DocumentRef). This reference can be used to locate the document either within the OpenSearch index itself or in S3 3423 storage.

In one example approach, the document can be retrieved from S3 3423. For instance, after OpenSearch 3421 returns the document reference, KE 3415 makes a request to S3 3423 to retrieve the actual document. This involves an additional step of fetching the document from S3 storage.

Another approach involves storing all required meta information about the document within the OpenSearch index itself. In this case, once OpenSearch 3421 returns the related information info_0, there is no need to make an additional request to S3 3423. The retrieved context ctx_0 and additional information info_0 are then used for generating the prompt.

FIG. 34D illustrates a two-stage search process 3404 designed to enhance the identification and retrieval of relevant document sections for generating a final prompt. Process 3404 involves two distinct stages: search (Stage 1) and selection (Stage 2).

In the first stage (Stage 1), a computer system implementing process 3404 (for example, the computer system that includes KE 3415, OpenSearch 3421, LLM 3430, and S3 3423) performs an initial search to generate a list of candidate documents that are potentially relevant to the query. This search can be based on term search, title search, or other keyword-based methods to quickly identify documents that match the query criteria. The goal of this stage is to filter down the vast pool of documents to a manageable subset of candidates that are likely to contain relevant information.

The second stage (Stage 2) involves a more refined search within the selected candidate documents to identify the most relevant parts of the documents. This is where semantic search techniques are employed to focus on the specific sections or chunks of text that are most pertinent to the query. Semantic search uses embeddings and other machine learning models to understand the context and meaning of the text, enabling a more accurate selection of relevant content.

In FIG. 34D, during Stage 1, process 3404 includes KE 3415 receiving the request with a query and potentially a URL. The getContext function is called, which includes computing the actual search query (SearchQuery=compute ([Query])). Then, KE 3415 sends the search query to OpenSearch 3421, which performs the initial search and returns a list of document references (DocumentRef). These document references are used to retrieve the actual documents from storage, such as S3 3423. This step completes Stage 1.

In Stage 2, process 3404 includes KE 3415 processing the retrieved documents and computing embeddings using an LLM 3430. The embeddings are compared to identify the most relevant parts of the documents. The final context (ctx_0) and additional information (info_0) are computed, encapsulating the selected relevant text for generating the prompt.

By separating the search process into two stages, the system gains flexibility, efficiency, and control over the final selection of text. The initial stage filters the document pool, while the second stage focuses on extracting the most relevant sections. This approach allows for more precise and efficient retrieval of information, ensuring that the final prompt generated for the LLM is highly relevant and contextually appropriate. Additionally, Stage 2 could be implemented locally without requiring network calls, using heuristics or a simple model to summarize and extract relevant content from the documents.

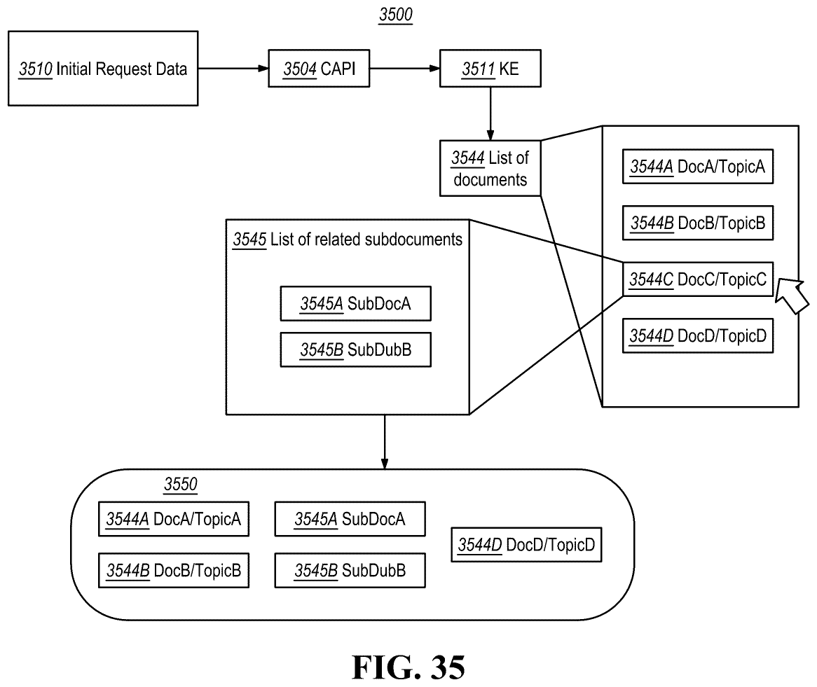

FIG. 35 illustrates a process 3500 for generating a prompt for a large language model (LLM), where request data is supplemented by contextual information. Process 3500 begins by sending initial request data 3510 to CAPI 3504. CAPI 3504 processes this initial request and communicates the request data 3510 to KE 3511 to retrieve relevant context and documents related to the request. In one example embodiment, a user may be provided with an interface, and when the user opens an existing document in that interface, CAPI 3504 sends a request to KE 3511 to retrieve and maintain the most relevant information related to the document in the session. Retrieving context using KE 3511 may be performed using any suitable approach, such as Jaccard Similarity or other suitable methods.

KE 3511 responds to the request from CAPI 3504 by providing a list of documents 3544, which includes various documents or topics such as DocA or TopicA 3544A, DocB or TopicB 3544B, DocC or TopicC 3544C, and DocD or TopicD 3544D. These documents are considered relevant to the initial request and serve as the first layer of context. The context that CAPI receives includes not only relevant snippets but also elements that can be displayed in the insights segment of the computer system and variables used in system actions. For example, instead of a generic action like “Summarize it,” a more specific prompt like “Summarize this marketing document . . . ” might be more compelling and optimized for a particular use case.

In various cases, a user can perform an action, such as clicking on a particular element in the list of documents 3544 (for example, clicking on DocC/TopicC 3544C), which generates a more refined list of related subdocuments 3545 in response to such action. This list includes subdocuments like SubDocA 3545A and SubDocB 3545B, which are more specifically related to the initial request and the topics of the primary documents. When a user clicks the system button, the system displays the context and contextualized actions. When a user clicks on a document, topic, or question listed within a list of documents (or within a text corresponding to a particular document), the system retrieves additional information from the knowledge engine relevant to the action the user is trying to perform. If no extra information is available, the previous state can be reused.

The new context might include information pertinent to the given action, such as a specific question. This information is sent to the composer in a separate variable and injected into the prompt, ensuring that the response is tailored to the user's immediate needs and context.

Finally, these documents and subdocuments are consolidated into a comprehensive prompt-associated context 3550, which includes elements from both the primary list of documents 3544 and the refined list of related subdocuments 3545. For example, prompt-associated context 3550 may include DocA/TopicA 3544A, DocB/TopicB 3544B, SubDocA 3545A, SubDocB 3545B, and DocD/TopicD 3544D. This context is then used to generate a final, highly relevant prompt for further processing by the system.

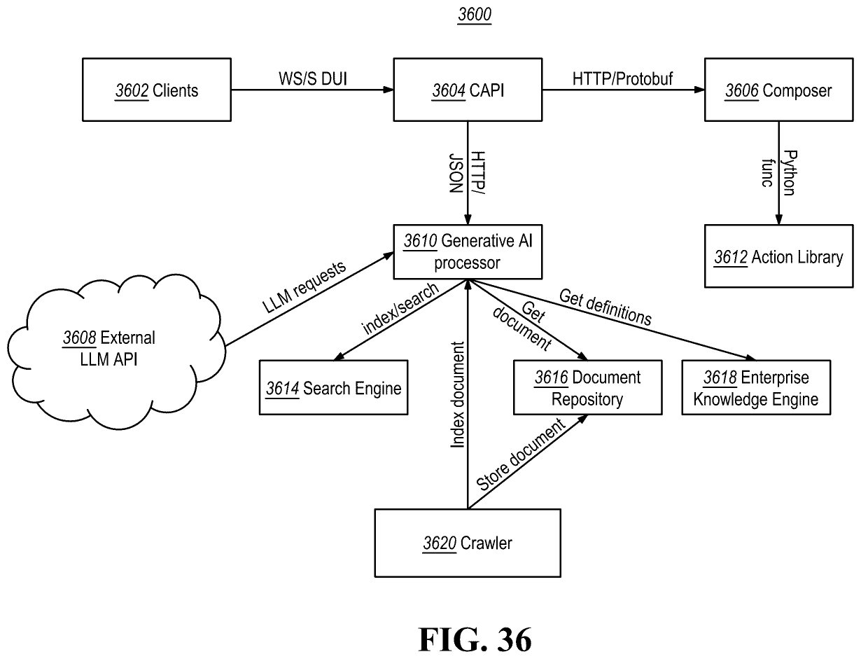

FIG. 36 illustrates a system 3600 designed to handle document processing and context generation for prompts. The system includes several components and their interactions, which facilitate the retrieval, indexing, and utilization of document data to generate contextually rich prompts for an LLM (Large Language Model).

The system includes Clients 3602, which can be any external user interface or application that sends requests to system 3600. These requests are directed to CAPI 3604, which serves as the central API gateway for handling client requests. CAPI 3604 processes the incoming requests and interacts with various components within the system.

One of the key interactions is with Serengeti 3610, which acts as the central orchestration engine. Serengeti 3610 handles the coordination of various tasks and communicates with different system modules to fulfill the request. It sends LLM requests to MS Azure OpenAI API 3608 for generating embeddings and performing other machine learning tasks. Serengeti 3610 also interacts with OpenSearch 3614 for indexing and searching documents, and with the Document system 3616 for retrieving and storing document data. The interaction between CAPI 3604 and Serengeti 3610 is facilitated via HTTP/JSON, ensuring efficient data exchange and communication.

A Knowledge Hub 3618 is a component that provides definitions and other knowledge-based information to enhance the context generated for the prompts. Serengeti 3610 retrieves necessary definitions from the Knowledge Hub 3618 to incorporate into the final context.

For document retrieval and indexing, the system uses Crawlers/Lambdas 3620. These components are responsible for crawling web pages, documents, and other sources to gather relevant data, which is then indexed and stored in the Document system 3616. The indexed documents are made searchable by OpenSearch 3614.

The system also includes Composer 3606, which is responsible for creating the final prompts. Composer 3606 works in conjunction with SimbaLang 3612, a library or service that provides additional functions and tools required for prompt generation. Composer 3606 receives processed context from Serengeti 3610 and uses it to format and structure the final prompt that will be sent to the LLM.

In summary, FIG. 36 depicts a system architecture where Clients 3602 interacts with CAPI 3604, which orchestrates various components like Serengeti 3610, OpenSearch 3614, Document system 3616, Knowledge Hub 3618, and Crawlers/Lambdas 3620, to retrieve, process, and index data. Composer 3606, with the help of SimbaLang 3612, generates the final prompts using the enriched context obtained from these components.

In various embodiments, the documents are indexed to improve search through various documents. During the indexing process, several operations can be performed to ensure that documents are well-prepared for efficient search and retrieval. Initially, normalization is conducted locally, which involves standardizing the text within the document by converting all characters to lowercase, removing punctuation, and handling special characters. This ensures consistency in the text, making it easier to process and compare. Following this, the document is split into smaller, more manageable chunks, typically ranging from 1,000 to 2,000 characters each. This chunking helps in detailed analysis and improves the efficiency of the search engine by focusing on smaller segments of the document.

Next, embeddings are computed for each chunk using a Large Language Model (LLM). These embeddings are numerical representations of text that capture the semantic meaning, aiding in understanding the context and meaning of the text. Similarly, embeddings are also computed for the document's title to associate the overall theme or topic of the document with its detailed content. Additionally, the LLM generates a concise summary of the document, often used for quick previews, thereby providing users with a snapshot of the document's content.

Furthermore, the LLM generates several key insights from the document. These insights include potential questions the document addresses, the main topics discussed, significant keywords, the target readership, any associated projects, and the type of the document (for example, report, article, memo). This detailed metadata enriches the document, making it more useful for search and retrieval.

The processed and indexed document is then stored in S3 data storage in JSON format, ensuring it is structured and easily retrievable for subsequent operations. Additionally, the data is added to OpenSearch, where embeddings for chunks and titles enhance semantic search capabilities. A traditional lexical index based on the actual words in the document is also created, facilitating keyword-based searches. All insights generated by the LLM are indexed as well, providing rich metadata that further enhances the search experience.

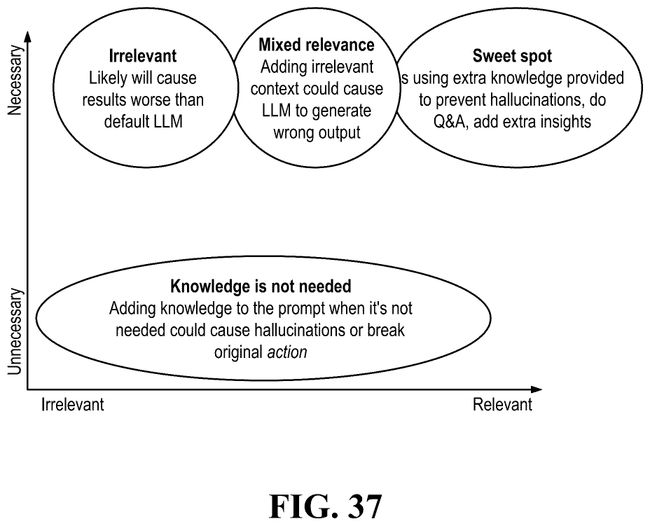

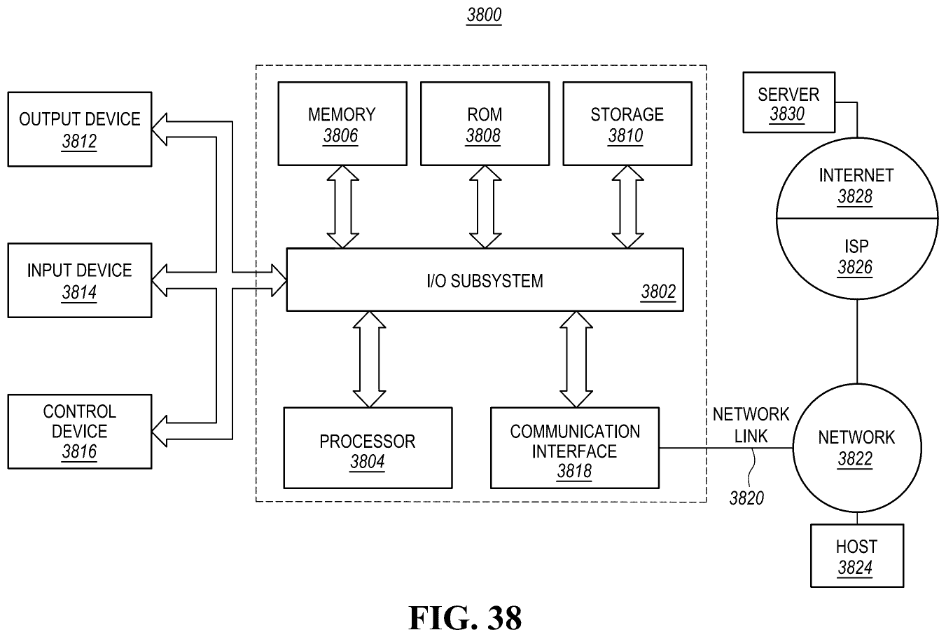

FIG. 37 presents a conceptual framework for understanding the relevance and necessity of knowledge added to prompts in a knowledge engine retrieval system. This framework helps to evaluate how different types of knowledge impact the output generated by an LLM. The x-axis of FIG. 37 represents the relevance of the added knowledge, ranging from irrelevant on the left to relevant on the right. The y-axis represents the necessity of the added knowledge, ranging from unnecessary at the bottom to necessary at the top. In the upper left corner, the region labeled “Irrelevant,” indicates that adding irrelevant knowledge (for example, irrelevant context) to a prompt is likely to produce results worse than what would have produced without such context. This aligns with the concern that irrelevant information can distort the generated text, making it less accurate or useful. The center region of FIG. 37, labeled “Mixed relevance,” highlights the potential negative impacts of including both relevant and irrelevant knowledge. This mixed relevance can confuse the LLM, leading to incorrect or suboptimal outputs. FIG. 37 suggests that when some snippets of added knowledge are relevant and others are not, the generated content may be adversely affected. It proposes testing the hypothesis that a model could differentiate applicable knowledge from irrelevant content. If mixed relevance has a significant negative impact, thresholding might be necessary to filter out irrelevant information. In the upper right corner, a region labeled “Sweet spot,” identifies the ideal scenario where added knowledge is relevant and necessary. In this case, extra knowledge can prevent hallucinations, support question answering, and add valuable insights to the generated text. This is the optimal condition for enhancing the LLM's performance with additional context. The region in the lower part of FIG. 37, labeled “Knowledge is not needed,” shows that adding unnecessary knowledge to the prompt can cause hallucinations or disrupt the intended action. For example, if the action is to rewrite a text to sound friendlier, adding knowledge about an unrelated term like “photosynthesis” could confuse the LLM and degrade the quality of the output. Thus, FIG. 37 shows the importance of carefully evaluating the relevance and necessity of knowledge (for example, context) added to prompts. This evaluation can help optimize the use of additional context, improving the accuracy and usefulness of the generated text. Establishing well-defined metrics and testing hypotheses about the impacts of mixed relevance and irrelevant knowledge are useful steps in refining the knowledge engine retrieval system. By doing so, the system can implement strategies, such as thresholding, to ensure that only the most relevant and necessary information is included in the prompts.

### 3. Implementation Example—Hardware Overview

According to one embodiment, the techniques described herein are implemented by at least one computing device. The techniques may be implemented in whole or in part using a combination of at least one server computer and/or other computing devices coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. To accomplish the described techniques, such computing devices may combine custom hard-wired logic, ASICs, or FPGAs with custom programming. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

FIG. 33 is a block diagram that illustrates an example computer system with which an embodiment may be implemented. In the example of FIG. 33, a computer system 3800 and instructions for implementing the disclosed technologies in hardware, software, or a combination of hardware and software, are represented schematically, for example, as boxes and circles, at the same level of detail that is commonly used by persons of ordinary skill in the art to which this disclosure pertains for communicating about computer architecture and computer systems implementations.

Computer system 3800 includes an input/output (I/O) subsystem 3802, which may include a bus and/or other communication mechanism(s) for communicating information and/or instructions between the components of the computer system 3800 over electronic signal paths. The I/O subsystem 3802 may include an I/O controller, a memory controller, and at least one I/O port. The electronic signal paths are represented schematically in the drawings, such as lines, unidirectional arrows, or bidirectional arrows.

At least one hardware processor 3804 is coupled to I/O subsystem 3802 for processing information and instructions. Hardware processor 3804 may include, for example, a general-purpose microprocessor or microcontroller and/or a special-purpose microprocessor such as an embedded system or a graphics processing unit (GPU), or a digital signal processor or ARM processor. Processor 3804 may comprise an integrated arithmetic logic unit (ALU) or be coupled to a separate ALU.

Computer system 3800 includes one or more units of memory 3806, such as a main memory, coupled to I/O subsystem 3802 for electronically digitally storing data and instructions to be executed by processor 3804. Memory 3806 may include volatile memory such as various forms of random-access memory (RAM) or other dynamic storage device. Memory 3806 also may be used for storing temporary variables or other intermediate information during the execution of instructions to be executed by processor 3804. Such instructions, when stored in non-transitory computer-readable storage media accessible to processor 3804, can render computer system 3800 into a special-purpose machine customized to perform the operations specified in the instructions.

Computer system 3800 includes non-volatile memory such as read-only memory (ROM) 3808 or other static storage devices coupled to I/O subsystem 3802 for storing information and instructions for processor 3804. The ROM 3808 may include various forms of programmable ROM (PROM), such as erasable PROM (EPROM) or electrically erasable PROM (EEPROM). A unit of persistent storage 3810 may include various forms of non-volatile RAM (NVRAM), such as FLASH memory, solid-state storage, magnetic disk, or optical disks such as CD-ROM or DVD-ROM and may be coupled to I/O subsystem 3802 for storing information and instructions. Storage 3810 is an example of a non-transitory computer-readable medium that may be used to store instructions and data which, when executed by the processor 3804, cause performing computer-implemented methods to execute the techniques herein.

The instructions in memory 3806, ROM 3808, or storage 3810 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation, application, and data storage layer, such as a relational database system using a structured query language (SQL) or no SQL, an object store, a graph database, a flat file system, or other data storage.

Computer system 3800 may be coupled via I/O subsystem 3802 to at least one output device 3812. In one embodiment, output device 3812 is a digital computer display. Examples of a display that may be used in various embodiments include a touchscreen display, a light-emitting diode (LED) display, a liquid crystal display (LCD), or an e-paper display. Computer system 3800 may include other type(s) of output devices 3812, alternatively or in addition to a display device. Examples of other output devices 3812 include printers, ticket printers, plotters, projectors, sound cards or video cards, speakers, buzzers or piezoelectric devices or other audible devices, lamps or LED or LCD indicators, haptic devices, actuators or servos.

At least one input device 3814 is coupled to I/O subsystem 3802 for communicating signals, data, command selections, or gestures to processor 3804. Examples of input devices 3814 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 3816, which may perform cursor control or other automated control functions such as navigation in a graphical interface on a display screen, alternatively or in addition to input functions. The control device 3816 may be a touchpad, a mouse, a trackball, or cursor direction keys for communicating direction information and command selections to processor 3804 and for controlling cursor movement on an output device 3812, such as a display. The input device may have at least two degrees of freedom in two axes, a first axis (for example, x) and a second axis (for example, y), that allows the device to specify positions in a plane. Another type of input device is a wired, wireless, or optical control device such as a joystick, wand, console, steering wheel, pedal, gearshift mechanism, or other control device. An input device 3814 may include a combination of multiple input devices, such as a video camera and a depth sensor.

In another embodiment, computer system 3800 may comprise an Internet of Things (IoT) device in which one or more of the output device 3812, input device 3814, and control device 3816 are omitted. Or, in such an embodiment, the input device 3814 may comprise one or more cameras, motion detectors, thermometers, microphones, seismic detectors, other sensors or detectors, measurement devices or encoders, and the output device 3812 may comprise a special-purpose display such as a single-line LED or LCD display, one or more indicators, a display panel, a meter, a valve, a solenoid, an actuator or a servo.

When computer system 3800 is a mobile computing device, input device 3814 may comprise a global positioning system (GPS) receiver coupled to a GPS module that is capable of triangulating to a plurality of GPS satellites, determining and generating geo-location or position data such as latitude-longitude values for a geophysical location of the computer system 3800. Output device 3812 may include hardware, software, firmware, and interfaces for generating position reporting packets, notifications, pulse or heartbeat signals, or other recurring data transmissions that specify a position of the computer system 3800, alone or in combination with other application-specific data, directed toward host computer 3824 or server computer 3830.

Computer system 3800 may implement the techniques described herein using customized hard-wired logic, at least one ASIC or FPGA, firmware, and/or program instructions or logic which, when loaded and used or executed in combination with the computer system, causes or programs the computer system to operate as a special-purpose machine. According to one embodiment, the techniques herein are performed by computer system 3800 in response to processor 3804 executing at least one sequence of at least one instruction contained in main memory 3806. Such instructions may be read into main memory 3806 from another storage medium, such as storage 3810. Execution of the sequences of instructions contained in main memory 3806 causes processor 3804 to perform the process steps described herein. In alternative embodiments, hard-wired circuitry may be used in place of or in combination with software instructions.

The term “storage media,” as used herein, refers to any non-transitory media that store data and/or instructions that cause a machine to operate in a specific fashion. Such storage media may comprise non-volatile media and/or volatile media. Non-volatile media includes, for example, optical or magnetic disks, such as storage 3810. Volatile media includes dynamic memory, such as memory 3806. Common forms of storage media include, for example, a hard disk, solid state drive, flash drive, magnetic data storage medium, any optical or physical data storage medium, memory chip, or the like.

Storage media is distinct but may be used with transmission media. Transmission media participates in transferring information between storage media. For example, transmission media includes coaxial cables, copper wire and fiber optics, and wires comprising a bus of I/O subsystem 3802. Transmission media can also be acoustic or light waves generated during radio-wave and infrared data communications.

Various forms of media may carry at least one sequence of at least one instruction to processor 3804 for execution. For example, the instructions may initially be carried on a remote computer's magnetic disk or solid-state drive. The remote computer can load the instructions into its dynamic memory and send them over a communication link such as a fiber optic, coaxial cable, or telephone line using a modem. A modem or router local to computer system 3800 can receive the data on the communication link and convert the data to a format that can be read by computer system 3800. For instance, a receiver such as a radio frequency antenna or an infrared detector can receive the data carried in a wireless or optical signal and appropriate circuitry can provide the data to I/O subsystem 3802 such as place the data on a bus. I/O subsystem 3802 carries the data to memory 3806, from which processor 3804 retrieves and executes the instructions. The instructions received by memory 3806 may optionally be stored on storage 3810 either before or after execution by processor 3804.

Computer system 3800 also includes a communication interface 3818 coupled to a bus or I/O subsystem 3802. Communication interface 3818 provides a two-way data communication coupling to a network link(s) 3820 directly or indirectly connected to at least one communication network, such as a network 3822 or a public or private cloud on the Internet. For example, communication interface 3818 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line. Network 3822 broadly represents a local area network (LAN), wide-area network (WAN), campus network, internetwork, or any combination thereof. Communication interface 3818 may comprise a LAN card to provide a data communication connection to a compatible LAN, a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 3818 sends and receives electrical, electromagnetic, or optical signals over signal paths that carry digital data streams representing various types of information.

Network link 3820 typically provides electrical, electromagnetic, or optical data communication directly or through at least one network to other data devices, using, for example, satellite, cellular, Wi-Fi, or BLUETOOTH technology. For example, network link 3820 may connect through network 3822 to a host computer 3824.

Furthermore, network link 3820 may connect through network 3822 or to other computing devices via internetworking devices and/or computers operated by an Internet Service Provider (ISP) 3826. ISP 3826 provides data communication services through a worldwide packet data communication network called Internet 3828. A server computer 3830 may be coupled to Internet 3828. Server computer 3830 broadly represents any computer, data center, virtual machine, or virtual computing instance with or without a hypervisor, or computer executing a containerized program system such as DOCKER or KUBERNETES. Server computer 3830 may represent an electronic digital service that is implemented using more than one computer or instance and that is accessed and used by transmitting web services requests, uniform resource locator (URL) strings with parameters in HTTP payloads, API calls, app services calls, or other service calls. Computer system 3800 and server computer 3830 may form elements of a distributed computing system that includes other computers, a processing cluster, a server farm, or other organizations of computers that cooperate to perform tasks or execute applications or services. Server computer 3830 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server computer 3830 may comprise a web application server that hosts a presentation layer, application layer, and data storage layer, such as a relational database system using a structured query language (SQL) or no SQL, an object store, a graph database, a flat file system or other data storage.

Computer system 3800 can send messages and receive data and instructions, including program code, through the network(s), network link 3820, and communication interface 3818. In the Internet example, server computer 3830 might transmit a requested code for an application program through Internet 3828, ISP 3826, local network 3822, and communication interface 3818. The received code may be executed by processor 3804 as it is received and/or stored in storage 3810 or other non-volatile storage for later execution.

The execution of instructions, as described in this section, may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 3804. While each processor 3804 or core of the processor executes a single task at a time, computer system 3800 may be programmed to implement multitasking to allow each processor to switch between tasks that are being executed without having to wait for each task to finish. In an embodiment, switches may be performed when tasks perform input/output operations when a task indicates that it can be switched or on hardware interrupts. Time-sharing may be implemented to allow fast response for interactive user applications by rapidly performing context switches to provide the appearance of concurrent execution of multiple processes. In an embodiment, for security and reliability, an operating system may prevent direct communication between independent processes, providing strictly mediated and controlled inter-process communication functionality.

### 4. Appendix

Table 1 below outlines various use cases for generating or rewriting text within documents using predefined actions and strategies. The table consists of three columns: “Use-case,” “Notes,” and “Query.” The “Use-case” column describes different scenarios in which text generation or rewriting is applied. The “Notes” column provides additional information or constraints for each use case. The “Query” column specifies the format or content of the query string associated with each use case.

TABLE 1
Query to string mappings
Table 1. Query to string mappings Use Case

| | Notes | Query |
|---|---|---|
| Generating new text within | | action arg (answer) |
| an empty document using | | |
| existing action | | |
| Generating new text using | | thread |
| quick reply action with | | |
| suggested reply strategy | | |
| Generating new text using | | thread + prompt |
| quick reply action with | | |
| custom reply strategy | | |
| Generating new text within | | action arg (answer) |
| an existing document using | | |
| existing action | | |
| Generating new text within | | selected_text |
| an existing document with a | | |
| selection using existing | | |
| action | | |
| Generating new text within | | prompt |
| an empty document using a | | |
| custom prompt | | |
| Generating new text within | | prompt |
| an existing document using | | |
| a custom prompt | | |
| Generating new text within | | prompt + |
| an existing document with a | | selected_text |
| selection using a custom | | |
| Rewriting a selected text | | selected_text |
| using existing action | | |
| Rewriting a document | cannot do that | n/a |
| without selection using | | |
| existing action | | |
| Rewriting a document | cannot do that | n/a |
| without selection using a | | |
| quick rewrite | | |
| Rewriting a selected text | | action arg (answer) |
| using a custom prompt | | |
| Rewriting a document | The whole document's | thread |
| without selection using a | context is pulled | |
| custom prompt | separately | |
| Follow-up rewrite using | | thread + prompt |
| a custom prompt | | |
| Follow-up rewrite using | | action arg (answer) |
| an existing action | | |
| Opening user interface | Happens on lightbulb | selected_text |
| without selection | click (might be slow) | |
| Opening user interface | Happens on lightbulb | prompt |
| with selection | click if part of a | |
| | text is selected | |

Table 2 below provides a detailed structure of two Java classes: GetContextRequest and QueryObject. Each class is described with its fields, their nullability status, and corresponding variable names.

TABLE 2
Java classes

| | | |
|---|---|---|
| List<CapiTreatmentGroup> | NonNull | treatments |
| UserData | NonNull | userData |
| Boolean | Nullable | dataControlsEnabled |
| List<QueryObject> | NonNull | queries |
| QuerySessionInfo | NonNull | sessionInfo |

QueryObject.java:

| | | |
|---|---|---|
| String | NonNull | query |
| String | Nullable | title |
| Map<String, List<String>> | Nullable | emailRecipients |
| QueryType | NonNull | queryType |

Table 3 provides a detailed structure of two Java classes: GetContextResponse and ContextObject. Each class is described with its fields, their nullability status, and corresponding variable names.

TABLE 3
Java classes
GetContextResponse.java:

| | | |
|---|---|---|
| List<ContextObject> | NonNull | context |
| List<Question> | Nullable | questions |
| Map<String, String> | Nullable | extraContext |
| DocumentInsights | Nullable | documentInsights |

ContextObject.java:

| | | |
|---|---|---|
| String | NonNull | id |
| String | NonNull | title |
| String | NonNull | contextText |
| ContextSource | NonNull | source |
| String | NonNull | sourceIconUrl |
| Double | Nullable | score |

### 5. Extensions and Alternatives

The disclosure has presented a complete enterprise-class, large-scale document processing, and query processing system that can efficiently access, ingest, and use a large corpus of enterprise-specific documents or other networked resources, to enable supplementing a user prompt or query with rich, enterprise-specific context based on the enterprise's documents, to product an engineered prompt to transmit to a public LLM. With the disclosed system, a user prompt or query will yield a response from the public LLM that is far more useful and correct because the LLM has been given context data that only the enterprise can access. The disclosed system provides accurate, end-to-end means of composing text for word processing documents, emails, web pages, and other target audiences or applications in which the response text from an LLM is informed by the enterprise's large corpus of existing and newly created documents. In this manner, the disclosed system and processes provide practical solutions to large-scale document crawling, indexing, embedding, storage, and use in automatic prompt-based natural language text composition.

In the foregoing specification, embodiments of the invention have been described with reference to numerous specific details that may vary from implementation to implementation. Accordingly, the specification and drawings are to be regarded in an illustrative rather than a restrictive sense. The sole and exclusive indicator of the scope of the invention, and what is intended by the applicants to be the scope of the invention, is the literal and equivalent scope of the set of claims issued from this application, in the specific form in which such claims issue, including any subsequent correction.

What is claimed is:

1. A method of electronic communication assistance comprising:
receiving a partial electronic communication at an artificial intelligence assistant computing facility from a first electronic identifier associated with a first user, the partial electronic communication comprising a communication content associated with the first electronic identifier associated with the first user and a second electronic identifier associated with a second user;
extracting a communication context from the partial electronic communication;
encoding the partial electronic communication for processing, creating an encoded partial electronic communication;
retrieving from a communication profile database a first communication profile for the first user using the first electronic identifier associated with the first user, wherein the first communication profile comprises a first user communication attribute;
retrieving from the communication profile database a second communication profile for the second user using the second electronic identifier associated with the second user, wherein the second communication profile comprises a second user communication attribute;
processing the encoded partial electronic communication with a processor to generate a compositional change for the communication content of the partial electronic communication using at least one of the communication context, the first user communication attribute, or the second user communication attribute to generate the compositional change; and
generating a changed electronic communication from the partial electronic communication and the compositional change.

2. The method of claim 1 further comprising transmitting the changed electronic communication to the first electronic identifier associated with the first user, and/or transmitting the changed electronic communication to the second electronic identifier associated with the second user.

3. The method of claim 1, wherein the compositional change is derived from representations of previous content and context from a plurality of user profiles stored in the communication profile database, which are like at least one of the first communication profile or the second communication profile.

4. The method of claim 1, wherein the processor is trained on large-scale data mixed with prior communication and effective communications from a plurality of user profiles.

5. The method of claim 1, wherein the processor performs operations based on instructions corresponding to a machine learning model for creating the compositional change.

6. The method of claim 1, wherein the compositional change is an auto-generated textual completion; the auto-generated textual completion being a phrasal completion, and wherein the processor is configured to generate the compositional change by optimizing generated language as determined by the processor from the second user communication attribute.

7. The method of claim 1, wherein the processor is configured to generate the compositional change by replicating a communication style of the first user as determined by the processor from the first user communication attribute.

8. The method of claim 1, wherein the partial electronic communication includes a communication goal, and the processor is configured to generate the compositional change by optimizing for impact and effectiveness of generated language with respect to the communication goal.

9. The method of claim 8, wherein the processor is configured to generate the compositional change further using a communication template selected from a plurality of communication templates comprising at least one of prepared text or placeholder locations for defining structural elements for user completion.

10. The method of claim 9, wherein the processor is configured to select the communication template using a machine learning model to find a most effective communication template based at least in part on the communication content.

11. The method of claim 10, wherein the plurality of communication templates includes at least one automatically generated template generated by the processor.

12. The method of claim 10, wherein the processor is configured to select the communication template by using the machine learning model to score the plurality of communication templates based at least in part on the communication content, first user communication attribute, second user communication attribute, or communication context.

13. A method of electronic communication assistance comprises:
intercepting an electronic communication from further transmission at an artificial intelligence assistant computing facility, wherein the electronic communication was transmitted from a first electronic identifier associated with a first user to second electronic identifier associated with a second user, the electronic communication comprising a communication content and comprising or associated with the first electronic identifier associated with the first user;
extracting a communication context from the electronic communication;
encoding the electronic communication for processing creating an encoded electronic communication;
retrieving from a communication profile database a first communication profile for the first user using the first electronic identifier, wherein the first communication profile comprises a first user communication attribute;
retrieving from the communication profile database a second communication profile for the second user using the second electronic identifier, wherein the second communication profile comprises a second user communication attribute;
processing the encoded electronic communication with a processor to generate a compositional change for the communication content of the electronic communication using at least one of the communication context, the first user communication attribute, or the second user communication attribute to generate the compositional change; and
generating a changed electronic communication from the electronic communication and the compositional change, wherein the changed electronic communication comprises annotations to indicate the compositional change to the electronic communication.

14. The method of claim 13, wherein the compositional change is derived from representations of previous content and context from a plurality of user profiles stored in the communication profile database, which are like at least one of the first communication profile or the second communication profile.

15. The method of claim 13, wherein the electronic communication includes a communication goal, and the processor is configured to generate the compositional change by optimizing for impact and effectiveness of generated language with respect to the communication goal.

16. The method of claim 15, wherein the processor is configured to generate the compositional change further using a communication template selected from a plurality of communication templates comprising at least one of prepared text or placeholder locations for defining structural elements for user completion.

17. A server computer comprising a processor and a computer-readable storage device that stores instructions that, when executed by the processor, cause the processor to perform operations comprising:
receiving a partial electronic communication at an artificial intelligence assistant computing facility from an electronic identifier associated with a user, the partial electronic communication comprising a communication content and comprising or associated with the electronic identifier;
retrieving a communication profile, wherein the communication profile comprises a user communication attribute;
processing the partial electronic communication with a processor to generate a compositional change for the communication content of the partial electronic communication using the user communication attribute to generate the compositional change; and
generating a changed electronic communication from the partial electronic communication and the compositional change.

18. The server computer of claim 17, wherein the processor is configured to generate the compositional change further using a communication template selected from a plurality of communication templates comprising at least one of prepared text or placeholder locations for defining structural elements for user completion.

19. The server computer of claim 18, wherein the plurality of communication templates may include at least one automatically generated template generated by the processor.

20. The server computer of claim 19, wherein the processor is configured to select the communication template by using a machine learning model to score the plurality of communication templates based at least in part on the communication content, communication context, first user communication attribute, or second user communication attribute.
